(19) United States
(12) Patent Application Publication
(10) Pub. No.: US 2014/0335490 A1
(43) Pub. Date: Nov. 13, 2014

(54) BEHAVIOR TRACKING AND MODIFICATION SYSTEM

(71) Applicant: Access Business Group International LLC, Ada, MI (US)

(72) Inventors: David W. Baarman, Fennville, MI (US); Matthew K. Runyon, East Grand Rapids, MI (US); Thomas Jay Leppien, Grand Haven, MI (US); Cody D. Dean, Grand Rapids, MI (US); Benjamin C. Moes, Wyoming, MI (US); Neil W. Kuyvenhoven, Ada, MI (US); Patrick M. Burrell, Allendale, MI (US); Timothy D.B. Wolfe, Norton Shores, MI (US); Warren E. Guthrie, West Olive, MI (US); Dave Moelker, Holland, MI (US); Ryan Johnson, Grand Haven, MI (US); Merdad Veiseh, Spring Lake, MI (US)

(21) Appl. No.: 14/362,531

(22) PCT Filed: Dec. 7, 2012
(86) PCT No.: PCT/US12/68503

§ 371 Date: Jun. 3, 2014

Related U.S. Application Data
(60) Provisional application No. 61/567,962, filed on Dec. 7, 2011.

(51) Int. Cl. G09B 19/00; G06F 3/01

(52) U.S. Cl. CPC G09B 19/00; G06F 3/017
USPC 434/236; 345/156

(57) ABSTRACT

A behavior modification system includes a network of components that interact to collect various data and provide user feedback. The network may include a personal device, an Internet-enabled storage device and a hub capable of receiving communications from the personal device and communicating to the storage device. The personal device may include bio-impedance measurement circuitry, an accelerometer and a processor for determining energy expenditure based on data from the accelerometer(s). The system may include a smart hub capable of routing communications between various components within the system. The hub may include different transceivers for different communication protocols. The system may incorporate a low-power RF wake-up system. The system may include bio-impedance measurement circuitry that is reconfigurable to function as an alternative type of sensor. In other aspects, the present invention provides a method for measuring bio-resonance and a method for determining caloric intake from body composition and caloric expenditure.

### BACKGROUND OF THE INVENTION

The present invention relates to automated systems and methods for understanding and assisting in human behavior, and more particularly to automated systems and methods for collecting a variety of user-related data and providing feedback to the user.

In the past, many have attempted to collect and gather information to aid users in understanding health, behavior and various conditions. These systems have been limited in scope and capabilities, as they have not, among other things, adequately addressed the need to change the behavior of the users. Many systems have been designed to monitor user data and report on specific details. As a result, these types of systems have met with only limited commercial success.

### I. Energy Expenditure

The most typical form of behavior that consumers seek to understand and control is that of health or weight. Health monitoring devices typically seek to measure caloric expenditure, so that a user may determine an appropriate diet based on typical caloric burn rates. Energy expenditure is typically measured by devices that utilize accelerometers to measure activity levels, then use calculations based of personal biological information such as height, weight, etc. These devices can approximate energy expenditure given these inputs, however, they are unable to determine caloric intake. To do this, a user must manually enter the food they have eaten into a database through a computer, smartphone, or other computing device connected to the internet. However, these entries may be prone to errors if a user forgets a meal or snack, if caloric content for a food is misrepresented, if a user cannot remember portion size, if a user purposefully omits information, or any other type of human error.

### II. Bio-Impedance Spectroscopy

Currently known devices that measure activity levels cannot determine body composition on their own. Typically, they require a separate device that measures body composition and uploads that information to the Internet. Perhaps the standard method of measuring body composition is through Bio-impedance Spectroscopy.

Bio-impedance Spectroscopy refers to the complex impedance measurement between two points on the human body measured over a frequency range, typically from 3 kHz to 1 MHz. FIG. 2 shows the flow of current through the body during bio-impedance spectroscopy measurements. FIG. 3 shows the flow of current around and through the cells of the body during bio-impedance spectroscopy measurements. FIG. 4 shows the equivalent circuit model used to calculate intracellular and extracellular water. In one embodiment, the measured resistance and reactance of the parallel circuits is used in conjunction with the Hanai model to determine fat free mass. The current run through the body during a bio-impedance spectroscopy reading is typically in the range of 200 uA to 800 uA. Traditionally, there have been two characteristics of the data resulting from this frequency sweep that are extracted and used to determine a person's extracellular water volume and intracellular water volume. The first characteristic is referred to as “R₀”, which is the impedance extrapolated to 0 kHz (or direct current). The second characteristic is referred to as “R_{inf}”, which is the impedance extrapolated to infinite frequency. Zero and infinite frequency, in this scenario, are defined as the frequencies where the reactance is 0. These two characteristics are passed into the Hanai model which outputs the water volume. The Hanai model has been developed by researchers over the past few decades. Using the Hanai model, the fat mass (“FM”) and fat-free mass (“FFM”) can be calculated for an individual.

These models suffer from a number of shortcomings. For example, they fail to take into consideration daily changes in hydration levels, stress levels, electrolyte levels, and body positioning. These factors can vary the measured FFM and FM by significant amounts, which present inaccurate data to the user.

### III. Mood/Emotional Analysis

One typical form of mood or emotional recording and analysis that is done today uses manual inputs wherein a user can tag a picture, article, event, or other online content with a response indicative of the user's mood. Additionally, devices may prompt users to answers surveys that are periodically presented to them by a web page, application on a smartphone, or even by devices that can be carried by a user to allow a user to input a mood or emotional state at various times. However, these devices fail to provide any mechanism for understanding the context of this data. In addition, these devices do not track the activities, physiological state, location, or other pertinent information along with the mood or emotion of the user. This means that the stimuli for a mood or emotion cannot be identified.

### IV. Feedback

Some of the most typical forms of feedback sent by behavior modification systems are automatic messages sent to a user via a typically communication method such as email, text message, or a reminder alarm on a personal computer or cell phone. This automatic feedback is often configured directly by the user to alert the user at certain times. Additionally, data may be presented to a user from time to time such as how much sleep they have gotten, how many calories they have consumed, how much time they have spent with another person, group, or pet, or how much time they have spent performing certain activities. In doing so, these systems seek to modify a user's behavior by presenting pertinent information to the user in hopes that their actions may change. However, these prompts typically do not provide suggested changes in behavior that may result in a positive trend towards a user's goal.

Currently, most behavior tracking and modification devices use a substantial amount of user control to track and modify both desired and non-desired behaviors. For example, users may be required to set their own alarms and notifications, input their own data, and manually transfer information between devices to consolidate data. With complicated user-control systems, most behavior modification devices and systems require too much thought and too much effort by the user. Because of this, users are very conscious of the behaviors they are trying to modify. The more aware a user becomes of how behaviors are being tracked and recorded, the more likely they are to try and get around notifications and essentially try to cheat the data, even when they may be the only ones looking at the data.

### SUMMARY OF THE INVENTION

In one aspect, the present invention provides a unique behavior modification system. The system generally includes a network of components that interact to collect various data and provide user feedback. In one embodiment, the network includes a personal device that is worn or carried by a user, an Internet-connected storage device and a hub that is capable of receiving communications from the personal device and communicating that data to the storage device. The personal device may be configured to uniquely identify the user and to collect data relating to the activity and body composition of the user. In one embodiment, the personal device includes one or more accelerometers for collecting data relating to physical activity and bio-impedance measurement circuitry for collecting data relating to body composition. In one embodiment, the Internet-connected storage device is coupled with one or more processors capable of interpreting data received from the personal device and providing feedback to the user.

In one embodiment, the behavior modification system is implemented in a network of components capable of collecting data, storing data, processing data, communicating data, receiving user input and providing user feedback. These various function may be implemented individually in single components or in combination in more complex components. The system may include essentially any components capable of collecting relevant data, such as data relating to the user and the user's activities or to environmental factors that might impact the user or otherwise be of use to the system. For example, data collecting components may include stand-alone sensors that function primarily to obtain and communicate data to other components. They may also include more complex devices that combine sensors with other types of system components, such as data storage and data processing components. In addition to sensors, the system may include input devices for entering data into the system. For example, a system component may include a touch screen, a keyboard or a mouse, or it may include one or more buttons, switches and other input devices. As another example, a three-axis accelerometer (and potentially other motion or orientation sensors) may be provided to receive input through user gestures. The system may include one or more storage units, such as local or network-based data storage units. Local storage units may include storage within a particular component, such as flash memory or other onboard storage in a sensor or a more complicated device. Network-based storage units may include a local hard drive or an Internet-connected hard drive (e.g. cloud storage) that receives and stores data from one or more system components. The system may include processors at various levels. For example, some components may include integrated processors for processing data and/or providing user feedback. The system may also include one or more centralized processors capable of collecting and analyzing data from one or more other components. The system may include algorithms capable of evaluating data alone and/or in combination to identify activities and events relevant to health and well-being. User feedback may be provided through visual means, such as lights, indicators and displays, or other types of output devices, such as tactile and audible devices.

In another aspect, the present invention provides a personal device for use in connection with a behavior modification system. In one embodiment, the personal device is a device that is capable of being worn by a user. For example, the personal device may be a wrist-band, a bracelet or an anklet. As another example, it may be device that can be carried in a user's pocket or clipped on the user's belt. In one embodiment, the personal device includes bio-impedance measurement circuitry, at least one accelerometer and a processor for determining energy expenditure based on data from the accelerometer(s). In one embodiment, the bio-impedance measurement circuitry may include an interior sensor configured to engage the user's skin beneath the device and an exposed sensor that can be placed in contact with the user's skin at a location remote from the interior sensor. For example, if the personal device is a wristband, one sensor may be located on the inside of the wristband to engage the user's wrist on one arm and the other sensor may be exposed on the outside of the wristband so that it can be placed in contact with the skin on the user's other wrist to provide an arm-to-arm bio-impedance measurement. In one embodiment, the personal device includes a three-axis accelerometer for collecting acceleration data relating to the physical activities of the user. The three-axis accelerometer may be supplemented or replace by other motion and orientation sensors. The personal device may include data storage for storing collected accelerometer data, such as onboard flash memory. In one embodiment, the processor is configured to determine the user's activity by analyzing data collected from the three-axis accelerometer. In one embodiment, the personal device includes a unique identifier capable of uniquely identifying the personal device to the behavior modification system. The unique identifier may be included with communications transmitted by the personal device.

In another aspect, the behavior modification system includes a unique hub that is capable of routing communications between various components within the system. In one embodiment, the hub includes a plurality of different transceiver that allows the hub to receive communication from components that operate using different communication protocols. For example, the hub may include WiFi, Bluetooth, Near Field Communications, ZigBee and/or other communications transceivers. To permit communications between devices of different protocols, the hub is configured to translate communications from one protocol to another. The hub may also be configured to implement a low-power behavior modification network. In this embodiment, the hub may include an RF transmitter capable of transmitting an RF signal capable of waking other network devices from standby mode. In one embodiment, the transceiver includes a router and protocol controller capable of receiving communications/data from another network component; convert the communication/data to the proper format for the target network component and sending the communication/data to the appropriate transceiver for transmission to the target network component.

In another aspect, the present invention provides a method for measuring bio-resonance. In one embodiment, the method includes the steps of measuring bio-impedance, measuring a factor capable of normalizing bio-impedance and normalizing bio-impedance using the normalization factor. In one embodiment, the method includes two normalizing factors—namely, hydration and user body orientation (e.g. sitting, standing or supine). In this embodiment, the method may include the steps of determining a user's hydration level, for example, using a hydration sensor, and normalizing the bio-impedance measurement to compensate for the determined hydration level. In this embodiment, the method may include the steps of determining the user's orientation, for example, using a three-axis accelerometer located at the hip of the user (and optionally or alternatively a magnetometer and/or other position or orientation sensors), and normalizing the bio-impedance measurement to compensate for the determined body orientation. In one embodiment, the method includes the steps of normalization for both hydration and body orientation, but the type and number of normalization factors may vary from application to application, and potentially from user to user.

In another aspect, the present invention provides a system and method for determining caloric intake. In one embodiment, the method includes the general steps of measuring an initial body composition of a user at a first time, measuring a subsequent body composition of the user at a second time, determining caloric expenditure during the period of time between the first time and the second time, and determining caloric intake as a function of the change in body composition and the caloric expenditure. In one embodiment, the step of determining caloric intake includes determining a number of calories corresponding to the change in body composition between the initial measurement and the subsequent measurement. In one embodiment, the behavior modification includes a personal device capable of inferring a user's caloric intake. In one embodiment, the personal device includes one or more sensors for measuring body composition, one or more sensors for measuring a user's physical activity and a processor configure to determine caloric intake as a function of the change in measured body composition and the measured user's physical activity. In one embodiment, the body composition sensor includes a bio-impedance sensor. In one embodiment, the physical activity sensor includes a three-axis accelerometer.

In another aspect, the present invention includes a network of components that are capable of entering standby mode to reduce power consumption and being woken from standby mode using an RF signal. In one embodiment, the system includes one or more components that are capable of entering a standby mode when inactive, as well as an RF receiver capable of receiving an RF wake-up signal even when in the standby mode. In one embodiment, the RF wake-up signal receiver circuitry is separate from any standby circuitry that may be incorporated into the communication circuitry. This allows the RF wake-up signal to be used to place the circuitry in an even lower power-consumption state than might be possible with just the conventional standby circuitry that is incorporated into some communication microcontrollers. In such embodiments, the RF wake-up signal receiver circuitry may provide an input to enable the communication circuitry. For example, the RF wake-up signal receiver circuitry may provide a high input to the enable input on a communication microcontroller. In one embodiment, the RF wake-up signal receiver circuitry includes an RF antenna and circuitry for determining when the wake-up signal has been received by the RF antenna. In one embodiment, the circuitry generally includes a filter, a peak-detector, an amplifier and a comparator. In this embodiment, the filter is configured to filter the output of the RF antenna and provide it to the peak detector. The peak detector may provide an output representative of the peaks in the filter signal. The output of the peak detector may be passed to the amplifier where it is amplified and output to the comparator. The comparator compares the amplified signal to a reference to determine whether an RF signal of sufficient strength has been received by the RF antenna. If so, the comparator output a wake-up signal, such as a high output. In one embodiment, the RF wake-up signal receiver circuitry may be combined with RF wake-up signal transmitter circuitry to provide an RF wake-up signal transceiver. In such embodiment, the circuitry may include RF wake-up signal receiver circuitry and RF wake-up signal transmitter circuitry that are alternately capable of being coupled to the RF antenna. In one embodiment, the RF wake-up signal transceiver includes an RF switch that can be selectively operated to connect the RF wake-up signal transmitter to the RF antenna to transmit an RF wake-up signal or to connect the RF wake-up signal transmitter to the RF antenna to receive an RF wake-up signal.

In another aspect, the present invention includes a personal device having bio-impedance circuitry that is reconfigurable to function as an alternative type of sensor. For example, in one embodiment, the bio-impedance circuitry may be reconfigurable to function as heart rate sensing circuitry. In this embodiment, the bio-impedance circuitry may include an excitation subcircuit for applying an electrical signal across a pair of sensors and a gain and phase detector subcircuit for extracting bio-impedance feedback across a second pair of sensors. In this embodiment, the bio-impedance circuitry may be configured to allow the excitation subcircuit to be disabled and a pair of the bio-impedance sensors may be used to provide a signal indicative of the electrical impulse of the user's heart to the circuit. The heart rate sensing circuitry may include a bypass subcircuit that allows the signal indicative of the heart rate to be fed directly to an analog-to-digital converter without passing through the gain and phase detection circuitry for the bio-impedance circuitry. As another example, the bio-impedance circuitry may be reconfigurable to function as circuitry for sensing skin salinity. In this embodiment, the bio-impedance circuitry may include an excitation subcircuit for applying an electrical signal across a pair of sensors and a gain and phase detector subcircuit for extracting bio-impedance feedback across a second pair of sensors. In this embodiment, the bio-impedance circuitry may include a bypass switch configured to create an electrical circuit between a single pair of adjacent sensors, whereby the electrical signal passes between the sensors through the user's skin, and a current sensor for sensing the current in the electrical circuit. In use, the magnitude of the current in the electrical circuit will be representative of the user's skin salinity. The salinity sensing circuitry may include a bypass subcircuit that allows the output of the current sensor to be fed directly to an analog-to-digital converter without passing through the gain and phase detection circuitry for the bio-impedance circuitry.

In one embodiment, the present disclosure relates to using a device or devices with an array of sensors and communication methods between devices and networks to track motions, locations, sense other nearby devices, and track various biometric data about a user. These devices work together to understand a user's body composition, activity levels, moods, habits, behaviors, and eventually a lifestyle. Specifically, the measured change in body composition over time when compared to energy expenditure over the same amount of time will allow the device(s) to determine caloric intake. Once these behaviors and lifestyles are identified, a central program can begin prompting the user through the same network of devices to begin changing their behaviors to meet target goals. Goals such as physical health, target levels of stress, time management, and relationship building/maintaining are first measured using empirical measurements, then analyzed either within the sensor devices or in a remote data collection machine or both, then prioritized based on correlation to the desired outcome, and finally an influence is injected to the users lifestyle. These influences may be warnings or reminders, displaying of data or results, or automatic changes to the device(s) within the network.

In one aspect, the present invention can utilize this data in conjunction with various components to systematically enhance or modify behavior in a wide variety of ways. This system combines the ability to monitor, interface, network, control and store data as well as analyze and recognize behaviors to further enhance this systems capability to assist a user in reaching personal goals.

The present disclosure seeks to overcome these and other disadvantages by providing an automated way to track and modify behaviors with very little human interaction and input.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows a schematic diagram of a prior art system for wirelessly charging devices.

FIG. 2 shows the flow of current through the body during bio-impedance spectroscopy measurements.

FIG. 3 shows the flow of current around and through the cells of the body during bio-impedance spectroscopy measurements.

FIG. 4 shows the equivalent circuit model used to calculate intracellular and extracellular water, wherein the measured resistance and reactance of the parallel circuits is used to determine the conductivity of the fluids.

FIG. 5 shows one embodiment of a personal device in accordance with the present invention.

FIG. 6 shows one embodiment of a personal device than can be clipped to an article of clothing.

FIG. 7 shows one embodiment of a personal device that can be worn around the wrist or ankle.

FIGS. 8A-B show a portion of a schematic of one embodiment of a personal device.

FIGS. 9A-B show a portion of a schematic of one embodiment of a personal device.

FIGS. 10A-B show a portion of a schematic of one embodiment of a personal device.

FIGS. 11A-C show a portion of a schematic of one embodiment of a personal device.

FIGS. 12A-B show a portion of a schematic of one embodiment of a personal device.

FIG. 13 is a representative view of one embodiment of a personal device in accordance with the present invention.

FIG. 14 shows the measurements and cycle of a typical person's gait in accordance with one embodiment of the present invention.

FIGS. 15A-B show a portion of a schematic for one embodiment of the present invention, including, for example, a base controller, temperature sensors, 3-axis accelerometer, microphone, speaker, Bluetooth RF layer, RF control for a wake-up mode, micro-controller, supervisor circuitry, and non-volatile memory.

FIG. 16 shows a portion of one embodiment of a RF wake up circuit.

FIG. 17 shows a portion of a schematic for one embodiment of the present invention, including, for example, a Qi wireless power controller along with a Li-Ion charger and system voltage regulator.

FIG. 18 shows a schematic of a bio-impedance spectroscopy measurement circuit in accordance with one embodiment of the present invention.

FIG. 19 shows a schematic of a bio-impedance spectroscopy measurement circuit in accordance with one embodiment of the present invention.

FIG. 20 shows a schematic of a bio-impedance spectroscopy measurement circuit in accordance with one embodiment of the present invention.

FIG. 21 shows some specific gestures that can be identified with a sensor in accordance with one embodiment of the present invention.

FIG. 22 is a list of gestures that can be identified with a sensor in accordance with one embodiment of the present invention.

FIG. 23 shows positions a user can be categorized into in accordance with one embodiment of the present invention.

FIG. 24 shows a method for determining position and activity (or SMA) in accordance with one embodiment of the present invention.

FIG. 25 shows a method for determining sample rate in accordance with one embodiment of the present invention.

FIG. 26 shows a correlation between SMA and speed.

FIG. 27 shows the varying correlations between SMA and speed for a number of users.

FIG. 28 shows a relationship between predictors and correlation factors (m and b) for a speed calculation.

FIG. 29 shows the correlation factors and the formula for calculating speed from SMA.

FIG. 30 shows a method for determining a user's speed in accordance with one embodiment of the present invention.

FIG. 31 shows the predicted vs. actual speed measurement for a number of users.

FIG. 32 shows one embodiment of a protective ultrasonically sealed enclosure that allows exposure of sensor elements while sealing core electronics in accordance with one embodiment of the present invention.

FIG. 33 shows a representative diagram of a personal device using wireless power to read health stickers.

FIG. 34 shows a personal device in one embodiment communicating wirelessly with several remote sensors or components located on the user that are either attached, carried, or worn by the user.

FIG. 35 shows one embodiment of a conformal skin sensor being wirelessly powered by personal device.

FIG. 36 shows a wireless power system in accordance with one embodiment of the present invention.

FIG. 37 shows a wireless power system in accordance with one embodiment of the present invention.

FIG. 38 shows one embodiment of the present invention including a wireless power system.

FIG. 39 shows the variation of bio-impedance over a period of time for a subject.

FIG. 40 shows the variation in bio-impedance measurements for a first subject dependent on the subject's body orientation.

FIG. 41 shows the variation in bio-impedance measurements for a second subject dependent on the subject's body orientation.

FIG. 42 shows the location of the accelerometer and the gravitational vectors measured in one embodiment to determine whether the user is sitting, standing, or supine.

FIG. 43 shows a Cole Plot of resistance vs. reactance as measured by the bio-impedance circuit.

FIG. 44 shows an analysis done on a subject during a weight loss study using averaged Bio-impedance Spectroscopy measurements.

FIG. 45 shows several potential bio-impedance curves with similar intercepts.

FIG. 46 shows a calculation of the ratio of max reactance to the difference in R₀ and R_{inf}.

FIG. 47 shows a calculation of the ratio of high frequency portion of a bio-impedance curve to the low frequency portion of a bio-impedance curve.

FIG. 48 shows the ratio of the high frequency tail of the bio-impedance curve to the total width of the bio-impedance curve.

FIG. 49 shows a bio-impedance curve illustrating the effect of hydration level on bio-impedance.

FIG. 50 shows a variation in bio-impedance for two different users over a period of time after fluid intake.

FIG. 51 shows one embodiment of a sequence for determining when to take a bio-impedance of bio-resonance measurement

FIG. 52 shows an example of a behavior modification component that can be utilized to interact with users.

FIG. 53 shows a schematic diagram for a 4-wire bio-impedance measurement circuit capable of being used in conjunction with one embodiment of the present invention, such as the personal device shown in the illustrated embodiment of FIG. 7.

FIG. 54 shows a block diagram of bio-impedance measurement circuitry reconfigurable to take a heart rate measurement.

FIG. 55 shows a block diagram of bio-impedance measurement circuitry reconfigurable to measure local resistance of the skin.

FIG. 56 shows one example of a behavior modification system with a feedback and pattern learning cycle for behavior modification.

FIG. 57 shows one embodiment of a representative input screen for a software application to collect data.

FIG. 58 shows one embodiment of a representative input screen for a software application to predict a user's genotype.

FIG. 59 shows another embodiment of a representative input screen for a software application to predict a user's genotype.

FIG. 60 shows an example log entry of an event of the behavior modification system.

FIG. 61 shows a representative analysis log for mood and behavior.

FIG. 62 shows a representative analysis log for that may analyze data over a period of time.

FIG. 63 shows one embodiment of a method for recording an event packet.

FIG. 64 shows a representative daily health log

FIG. 65 shows a representative diagram of a proximity wake up system for brand to brand interactions.

FIG. 66 shows an example system for data collection and pattern recognition.

FIG. 67 shows a collection of data that can be actively monitored or measured by the system such as sleep schedules, interactions with other people, actions such as washing hands, and variations in diet.

FIG. 68 shows a representative floor plan for use in connection with a behavior modification system.

FIG. 69 shows a table for zone configuration in one behavior modification system.

FIG. 70 shows an example survey for use with one embodiment of a behavior modification system

FIG. 71 shows a graph of behavior occurrences over a period of one week.

FIG. 72 show a pivot graph of behavior occurrences at certain times for one day of the week.

FIG. 73 shows a pivot graph of behavior occurrences at a certain time over a one week period.

FIG. 74 shows a table of information about daily activities of a user.

FIG. 75 shows an example a behavior modification system protocol.

FIG. 76 shows a hub for use in one embodiment of a behavior modification system

FIG. 77 shows an example of a behavior modification hub protocol.

FIG. 78 shows a representative diagram of a hub in operation within a behavior modification system.

FIG. 79 shows a hub connected directly to a personal computer and representative screenshots of a behavior modification system interface.

FIG. 80 shows a representative diagram of a behavior modification system including a hub, a wireless charging pad, and multiple personal devices.

FIG. 81 shows a representative graph of relative path loss of a signal at various frequencies at a given distance.

FIG. 82 shows one embodiment of a range calculator for the range of a proximity wake up signal.

FIG. 83 is a flow chart of a method according to one embodiment of the present invention, showing an example of steps for transferring data between components in a system.

FIG. 84 is a flow chart of a method according to one embodiment of the present invention, showing an example of steps for transferring data between components in a system.

FIG. 85 is a representative view of a drinking dispenser in one embodiment of the present invention.

FIG. 86 is a representative view of a vending machine in one embodiment of the present invention that can communication with components and indicate recommendations.

FIG. 87 is a representative view of a phone in one embodiment of the present invention that can utilize GPS data and provide recommendations based on location.

FIG. 88 is a representative view of a dispenser for supplements or medications that can be used in the behavior modification system.

FIG. 89 is a representative view of one embodiment of the present invention, including a dispenser for liquid.

FIG. 90 is a representative view of one embodiment of the present invention, depicting a cellphone that integrates a near 900 MHz transceiver for low power use or as an adapter to utilize the phone as a bridge to the data storage media.

### DESCRIPTION OF VARIOUS EMBODIMENTS

### I. Overview

A behavior modification system in accordance with one embodiment of the present invention is configured to assist a user in improving health and well-being, as well as other objectives that may be set by the user. In one embodiment, the system collects a variety of data and provides a user with feedback based on the collected data. Feedback may include simple feedback, such as reports on the tracked data, and it may include more complicated feedback, such as guidance or assistance in improving health and well-being based on determinations made from analysis of the collected data. In use, the system may collect a wide variety of data, including user data (e.g. biometric data, physiological data, physical activity), environmental data (e.g. temperature, location, sunlight, barometric pressure, elevation, noise level) and other data that might represent behavior, impact behavior or otherwise be relevant to one or more of the objectives of the system. The types of data collected may vary from application to application; however, a typical system may collect physiological and biometric data for the users, as well as data representative of physical activity, caloric intake, sleep patterns, human interaction, mood and physical location. The data may be collected, tracked, correlated and otherwise processed as desired to provide assistive feedback to the user. The user feedback may provide any of a wide-variety of type is data may be used to track activities and other factors that might relate to health and well-being. In addition these components can interface with building automation equipment, such as HVAC, lighting, and building security systems.

The behavior modification system of one embodiment of the present invention is implemented in the form of a network of components primarily capable of collecting data, storing data, processing data, communicating and providing user feedback. The behavior modification system of the present invention may include one or more devices with sensors or array of sensors and communication methods between devices and networks to track motions, locations, sense other nearby devices, and track various biometric data about a user. These components work together to understand a user's body composition, activity levels, moods, habits, behaviors, and eventually a lifestyle. For example, the measured change in body composition over time when compared to energy expenditure over the same amount of time will allow the components to determine caloric intake. Once these behaviors and lifestyles are identified, a central program can begin prompting the user through the same network of components to begin changing their behaviors to meet target goals. Goals such as physical health, target levels of stress, time management, and relationship building/maintaining are first measured using empirical measurements, then analyzed either within the sensor devices or in a remote data collection machine or both, then prioritized based on correlation to the desired outcome, and finally an influence is injected to the users lifestyle. These influences may be warnings or reminders, displaying of data or results, or automatic changes to the components within the network.

The system may include essentially any components capable of collecting relevant data, such as data relating to the user and the user's activities or to environmental factors that might impact the user or otherwise be of use to the system. For example, data collecting components may include stand-alone sensors that function primarily to obtain and communicate data to other components. They may also include more complex devices that combine sensors with other types of system components, such as data storage and data processing components. In addition to sensors, the system may include input devices for entering data into the system. For example, a system component may include a touch screen, a keyboard or a mouse, or it may include one or more buttons, switches and other input devices. As another example, a three-axis accelerometer (and potentially other motion or orientation sensors) may be provided to receive input through user gestures.

The system may include one or more storage units, such as local or network-enabled data storage units. Local storage units may include storage within a particular component, such as flash memory or other onboard storage in a sensor or a more complicated device. Network-enabled storage units may include a local hard drive or an Internet-enabled hard drive (e.g. cloud storage) that receives and stores data from one or more system components.

The system may include processors at various levels. For example, some components may include integrated processors for processing data and/or providing user feedback. The system may also include one or more centralized processors capable of collecting and analyzing data from one or more other components. The system may include algorithms capable of evaluating data alone and/or in combination to identify activities and events relevant to health and well-being. User feedback may be provided through visual means, such as lights, indicators and displays, or other types of output devices, such as tactile and audible devices

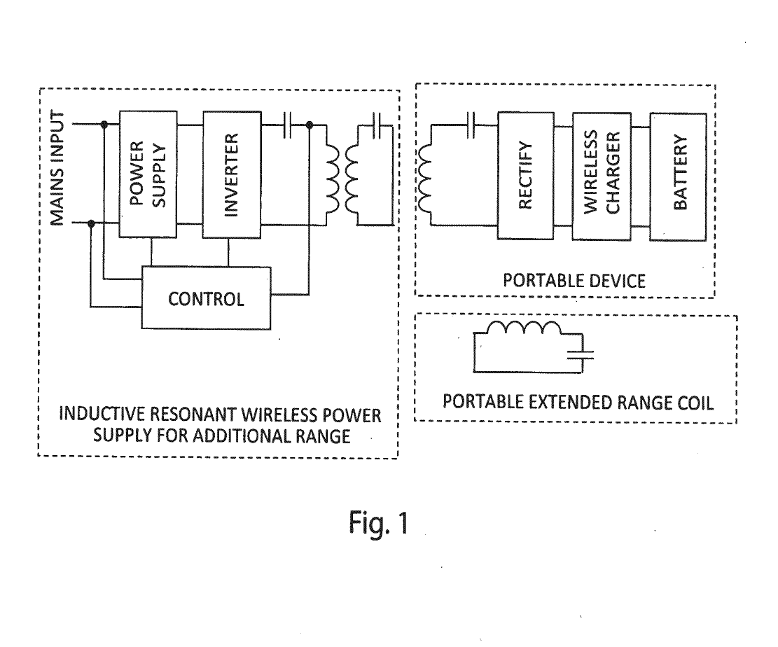

Further, these system components may use a range of recharging methods to maintain power. An inductive wireless charging using a charging base may be used, the components may be plugged into a wired charger, or the components may be able to recharge themselves through power harvesting. FIG. 1 shows a schematic diagram of a prior art system for wirelessly charging devices. It should be noted that wireless power enables a smaller energy storage element as it can be charged more frequently and enables the design of the enclosure to be ruggedized and sealed. This diagram shows both a short and long range wireless power configuration with the utilization of the second coils in the wireless power supply (Tx) and portable device (Rx) we can extend the range of charging. The portable extended range coil may be incorporated into the portable device or it may be a separate component. Power harvesting techniques may include solar charging, transducers that harvest energy from motion (piezoelectric or magnetic), thermoelectric, or RF energy harvesting from ambient RF sources. The components may sync information when plugged into a charger that includes a communication interface, or when placed on an inductive charger that uses a communication interface, or can harvest power and send information once a sufficient amount of energy has been obtained, shutting down once the power in the energy storage element has been depleted. The energy storage element in these components may be a battery, capacitor, or supercapacitor.

As can be seen, this system of this embodiment combines the ability to monitor, interface, network, control and store data as well as analyze and recognize behaviors to further enhance the system's capability to assist a user in reaching the user's personal goals. In use, the present invention may systematically help to guide or modify behavior in any number of a variety of different ways to be described below.

### II. Personal Device

In one embodiment, the behavior modification system generally centers around a personal device that is intended to be carried or worn by a user. The personal device creates a unique association between the user and other components of the system. As discussed in more detail below, the personal device may include any combination of sensors, data storage, communication circuitry, user interface, and processing units. For example, the personal device may be capable of collecting one or more types of data, storing data, processing data, communicating with other network components and providing user feedback. In one embodiment, data may be collected using sensors integrated into the personal device, entered into the personal device by a user or may be received through communication with other network devices. The personal device may be provided with an input device to permit the user to enter data into the personal device. The input device may be essentially any type of human input devices, such as a touch screen, buttons, switches, keyboards and other human interface devices. In embodiments that incorporate a hub, the personal device may also be capable of relaying data to and from other network components. For example, the personal device may be capable of collecting data from various network components, storing that data internally and then communicating that data to the hub when in range. Similar, the personal device may be capable of receiving communications from the hub, storing the communications internally and then transmitting those communications to other network components when in range.

In one embodiment, the personal device includes the ability to collect information about caloric expenditure. For example, the personal device may include an accelerometer for measuring user physical activity. As another example, the personal device may have communication circuitry to receive sensor readings representative of a user's physical activity from other components. As still another example, the personal device may include a user interface for accepting information entered by a user regarding physical activity.

In one embodiment, the personal device includes the ability to collect information about current body composition and changes in body composition at various times. For example, the personal device is capable measuring bio-impedance or bio-resonance (as discussed below), or both. A determination regarding Fat Mass and Fat Free Mass may be based on the body composition information. These measurements may be taken periodically or in response to an event.

The personal device, or a component within the system, may include the ability to utilize both body composition information and caloric expenditure to generate a caloric intake prediction. For example, by comparing energy expenditure to changes in Fat Mass and Fat Free Mass since these tissues are used by the body to store energy. By detecting a reduction or increase in stored energy, the system can determine that the user has expended more or less energy than consumed, respectively.

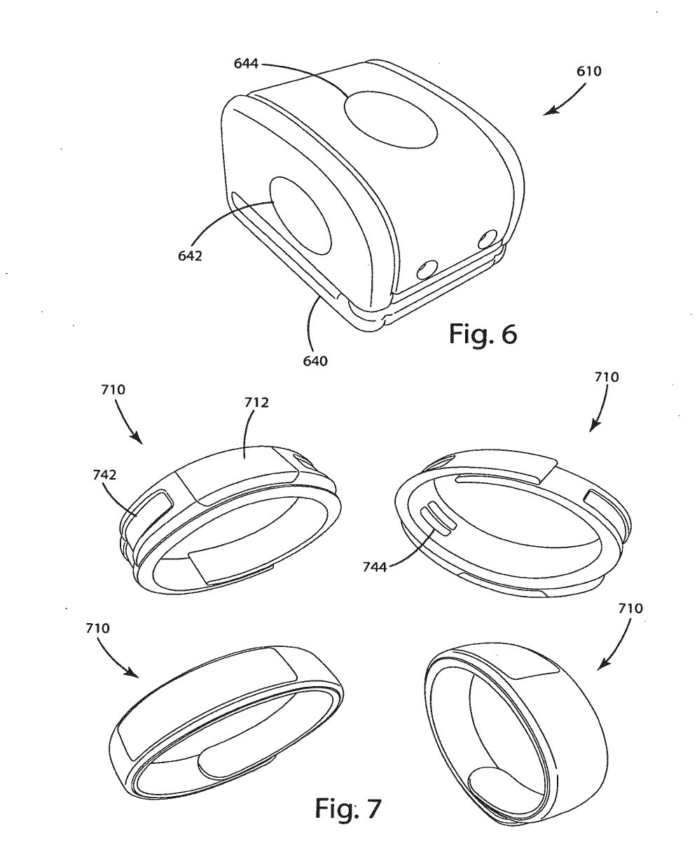

Turning now to the illustrated embodiment of FIG. 5, a personal device in accordance with one or more embodiments of a system of the present invention is shown and generally designated 10. The personal device 510 as mentioned herein may include a variety of components and capabilities, including for example, circuitry configured to receive and transmit data and information within the system and to enable user interaction with the system. The personal device 510 in the illustrated embodiment is capable of being worn or carried by a user 508, and may be in the form of a bracelet as shown in FIG. 7. However, it should be understood that the personal device 510 may take forms other than a bracelet, such as a clip-on device as shown in FIG. 6 or a device capable of being placed within a pocket. The personal device 10 may also be separate from or integrated with other components in the system of the present invention. Further, the personal device (or other devices or components) is described with a variety of features and functions. Unless otherwise expressly noted, those features, functions, or combinations thereof may be incorporated into other network components.

The personal device 510 in the illustrated embodiment of FIG. 5 may include one or more of a 3-axis accelerometer 526, bio-impedance and bio-resonance measurement circuitry 524, temperature sensors 524, microphone and speakers 516, a Bluetooth Low Energy (BTLE) transceiver 522, a 916.5 MHz low power transceiver 520, an antenna 518 or set of antennas, a display 51412, a battery 528, and a wireless power transceiver 532. The personal device 510 is described in connection with all of these components, but in alternative embodiments, the personal device 510 may include some components but not others. For example, in one embodiment, the personal device 510 may not include the accelerometer 526 or may not include the low power transceiver 520. As another example, the personal device 510 may include bio-impedance measurement circuitry without bio-resonance measurement circuitry.

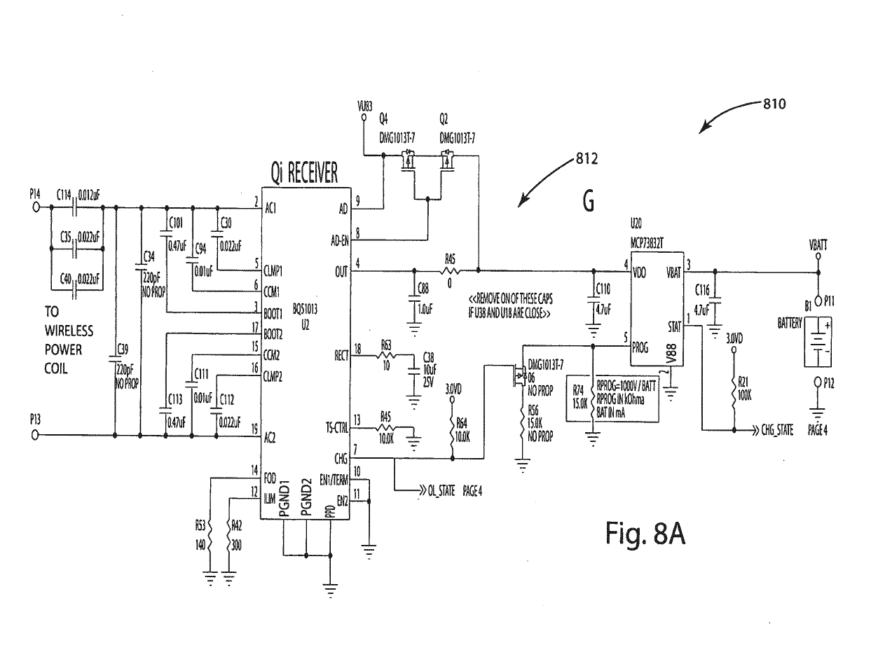

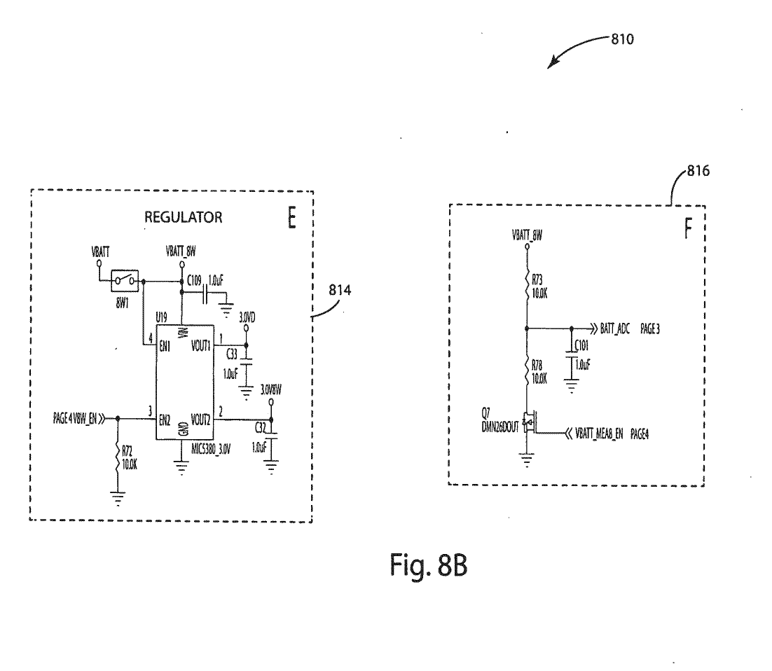

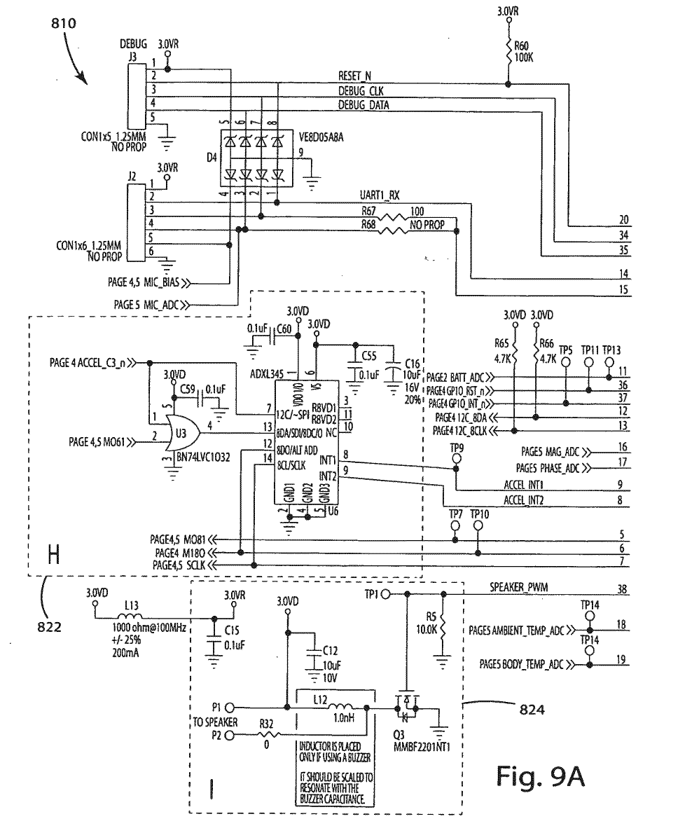

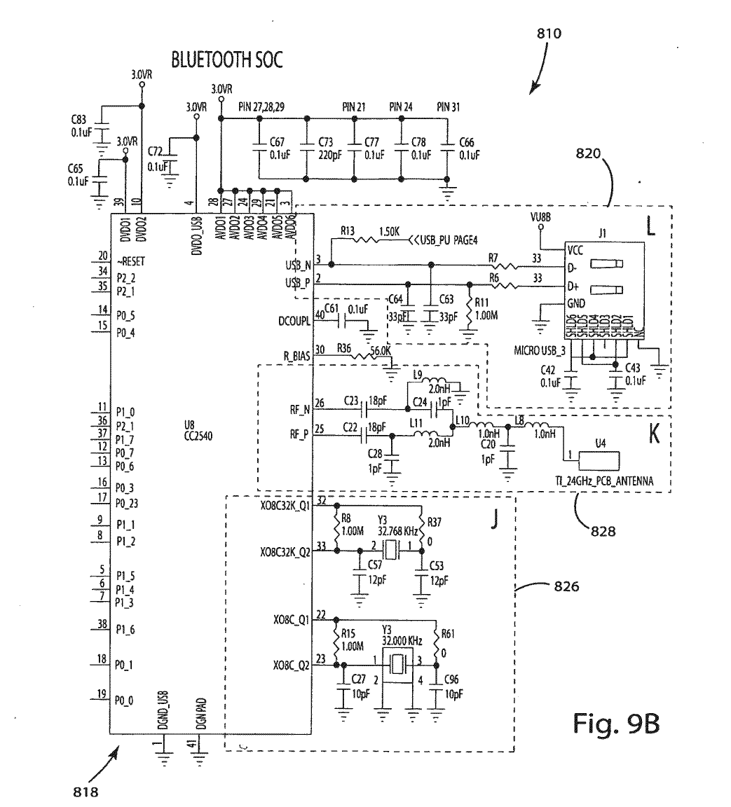

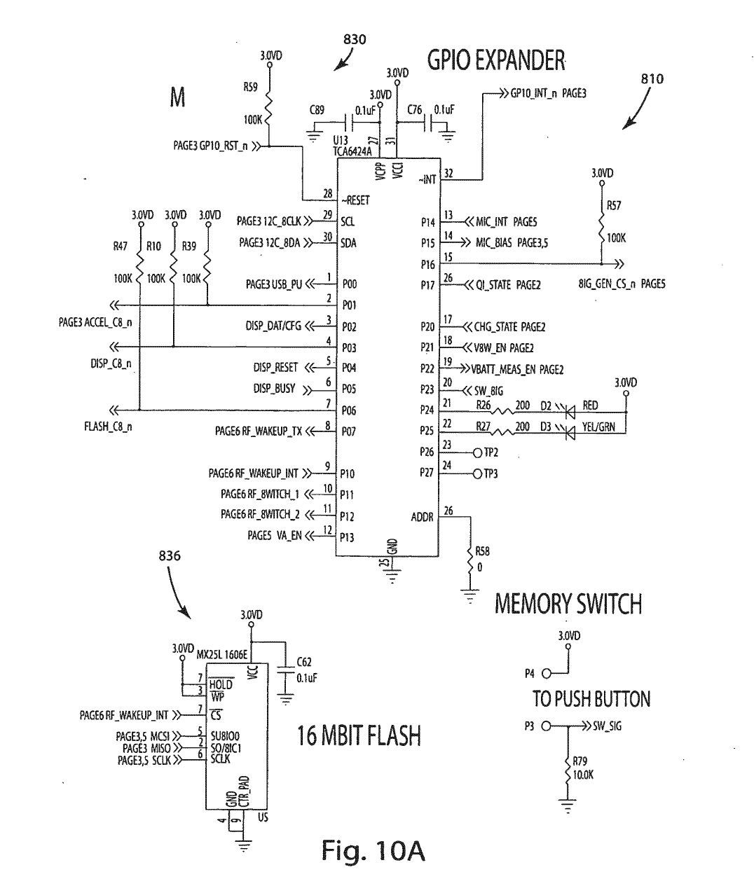

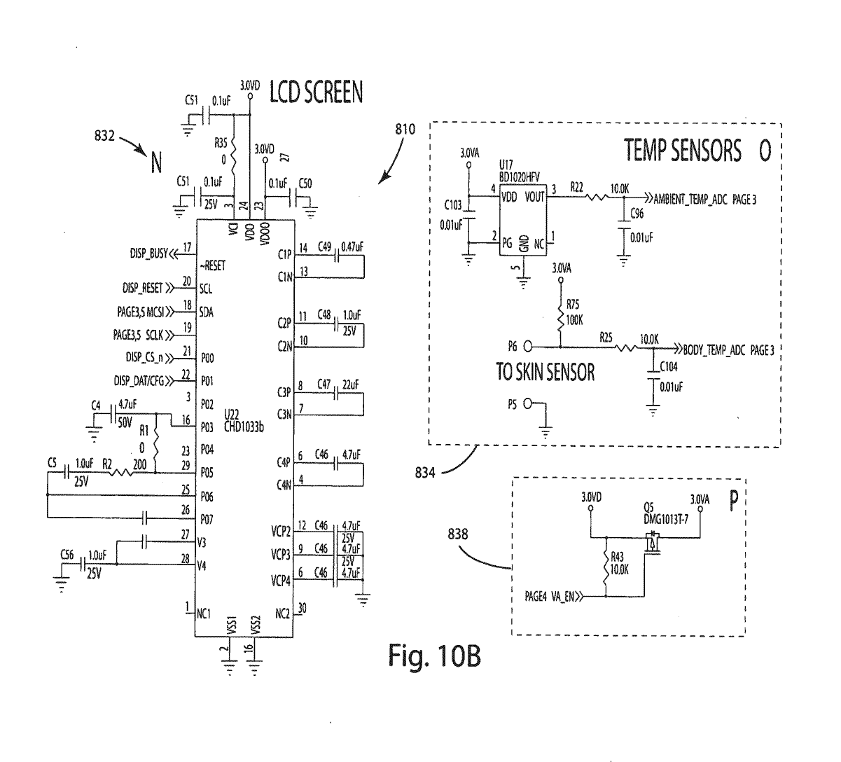

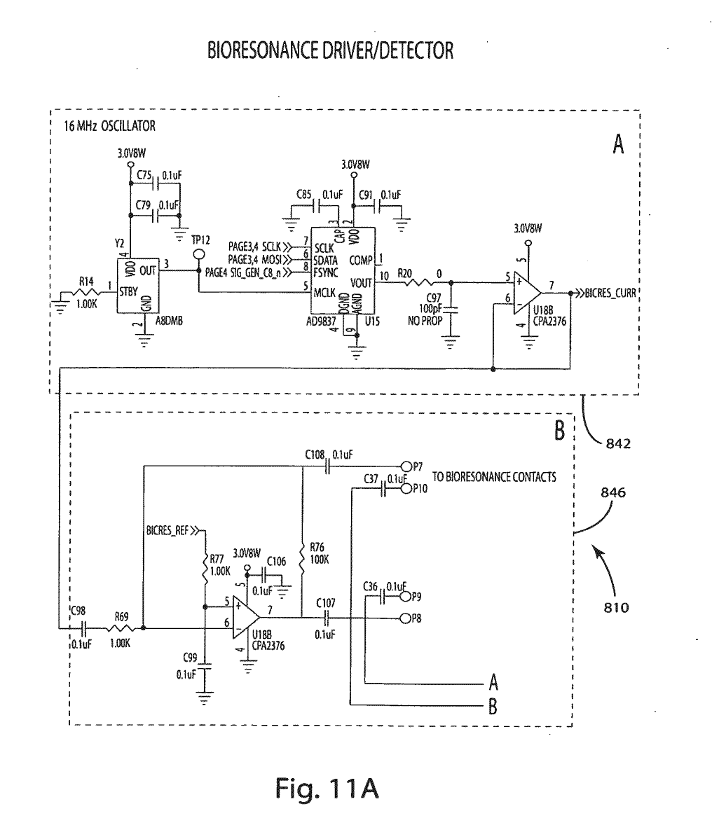

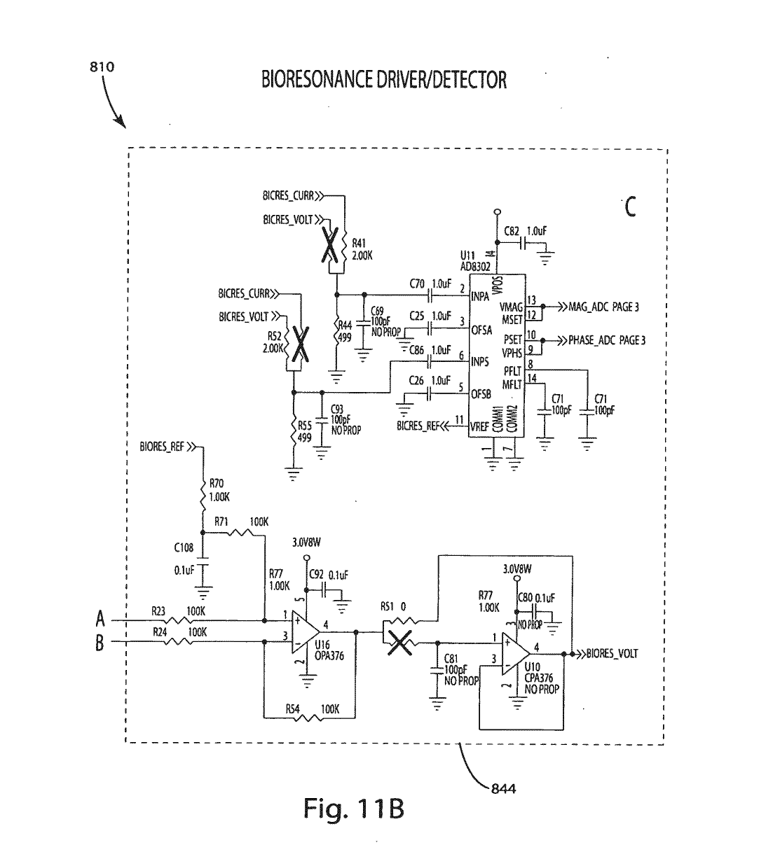

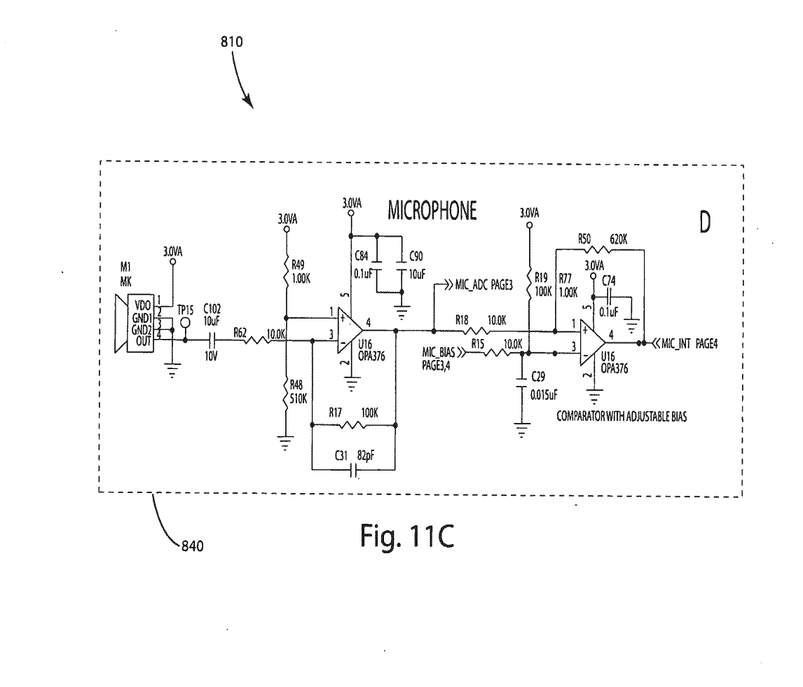

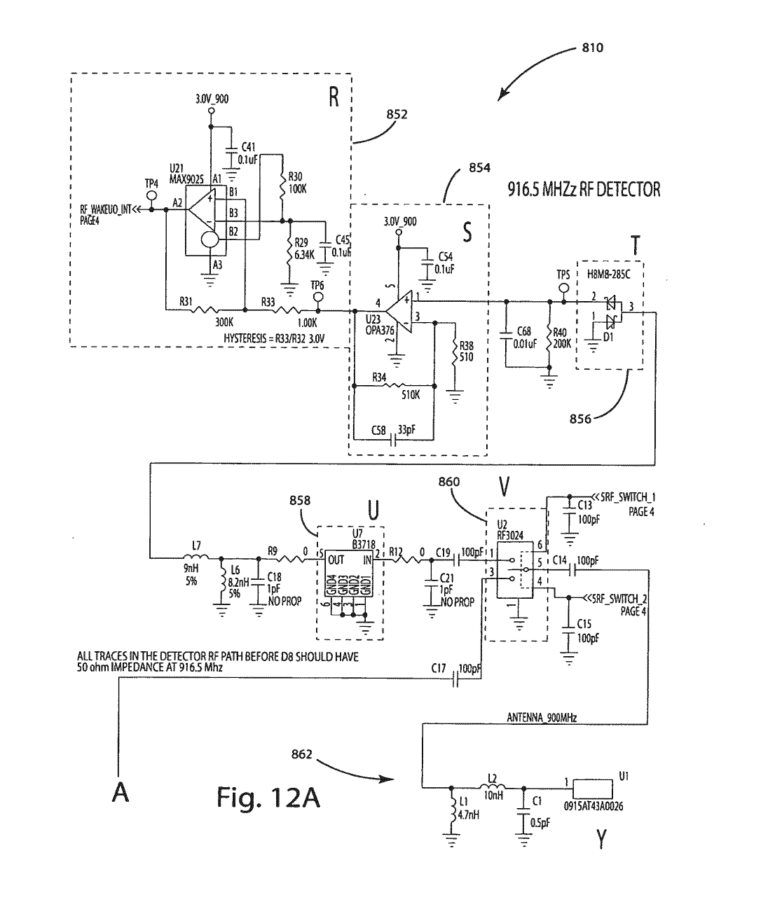

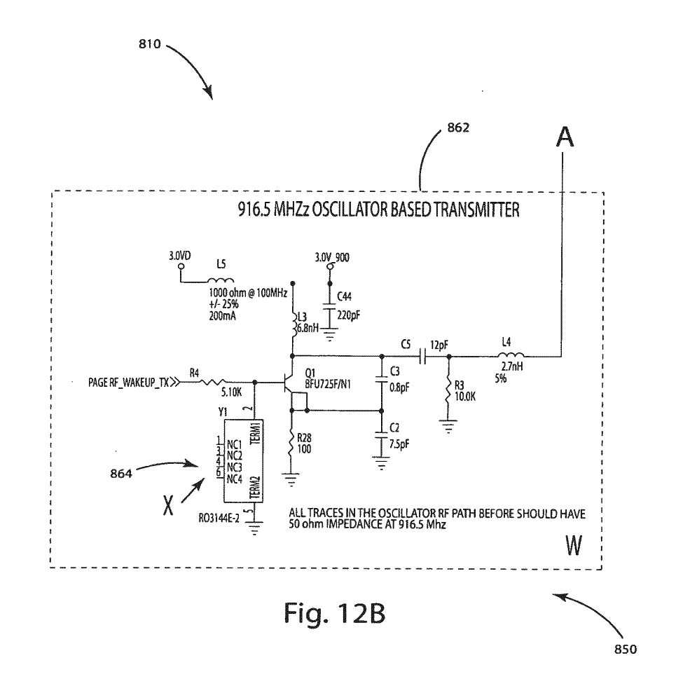

A personal device according to one embodiment is shown in FIGS. 8-12. The personal device 810 in this embodiment may be similar to the other personal devices described herein, but is depicted in the form of an electrical schematic for purposes of disclosure. FIGS. 8A-B show a portion of a schematic for the personal device 810 that includes a wireless power receiver 812, power management circuit 814, and battery measuring circuit 816. FIGS. 9A-B show a portion of a schematic for the personal device that includes a central microcontroller 818, a USB data connection 820, a 3-axis accelerometer 822, a speaker driver 824, and a Bluetooth Low Energy circuit 826, 828. FIGS. 10A-B show a portion of a schematic for the personal device 810 that includes a GPIO port expander 830, LCD screen 832, temperature sensors 834, non-volatile memory 836, and a switched DC power source 838. FIGS. 11A-C show a portion of a schematic for the personal device 810 that includes a microphone 840 and a Bio-impedance and bio-resonance measurement circuit 848, which includes a signal generator 842, constant current drive 846, and measurement circuit 844. FIGS. 12A-B shows a portion of a schematic for the personal device 810 that includes an RF wakeup transceiver 850, including a Colpits oscillator 862, RF switch 860, SAW filter 858, peak detector 856, signal amplifier 854, threshold detector 852, chip antenna 862, and saw oscillator 864.

Returning to FIG. 5, the personal device 510 in one embodiment may include components capable of (1) monitoring or measuring activity levels of the user and (2) obtaining body composition information of the user. In having the capability to do both, the determination to obtain body composition information may be based on the activity level of the user. For instance, if the user is at rest, the personal device 510 may decide to obtain body composition information. Embodiments in which the personal device 510 monitors or measures activity level of the user may include one or more accelerometers, such as the 3-axis accelerometer 526 shown in the illustrated embodiment of FIG. 5.

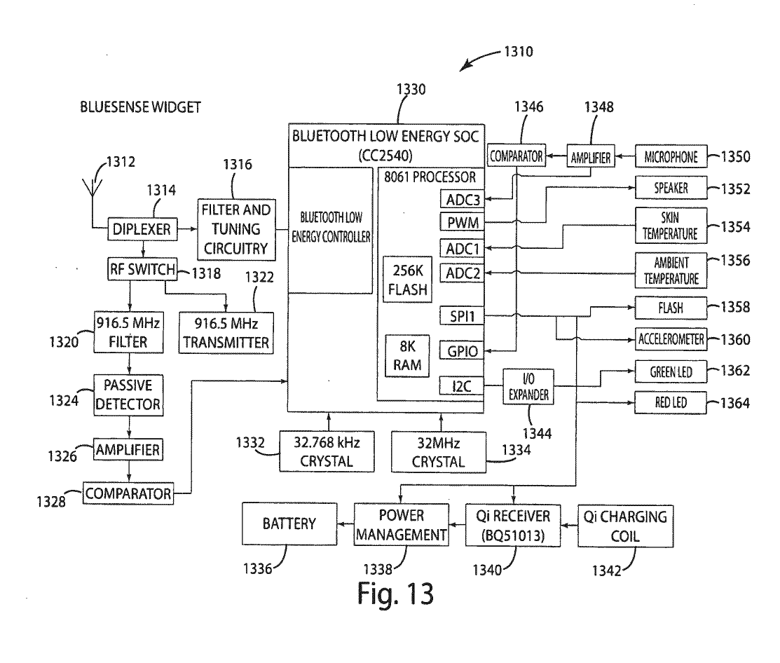

FIG. 13 shows a block diagram of another embodiment of a personal device 1310. The personal device 1310 illustrated in FIG. 13 can be worn or embedded in another device or material, or carried by a user. The configuration of the personal device 1310 may vary from application to application. For example, the number and type of input components, such as sensors, may vary depending on the types of information that are relevant to that application. Personal device 1310 in this embodiment may include one or more of the following: antenna 1312, diplexer 1314, filter and tuning circuitry 1316, RF switch 1318, 916.5 MHz filter 1320, 916.5 MHz transmitter 1322, passive detector 1324, amplifier 1326, comparator 1328, microcontroller 1330, 32.768 kHz oscillator 1332, 32 MHz oscillator 1334, battery 1336, power management circuitry 1338, wireless power receiver 1340, wireless power receiver 1342 (or wireless power transmitter or wireless power transceiver), I/O expander 1344, comparator 1346, amplifier 1348, microphone 1350, speaker 1352, skin temperature sensor 1354, ambient temperature sensor 1356, flash memory 1358, accelerometer 1360, LEDs 1362, 1364. One or more of these elements in this embodiment may be capable of activating or waking other elements in response detecting an event, such as presence of a low power wakeup signal or a gesture.

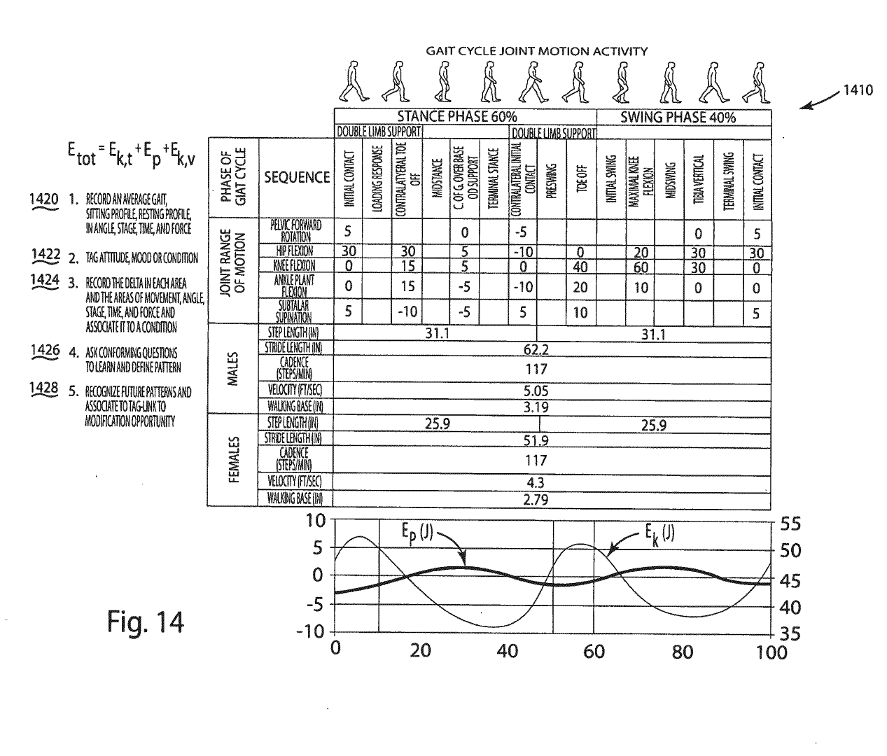

User's activities can be monitored to determine and recommend behavior modification opportunities. FIG. 14 illustrates one example of such a monitored activity by monitoring the cycle of a typical person's gait. It also shows the energy in a gait cycle. In one embodiment, a combination of tags and monitoring a user's gait may assist in identifying behavior modification opportunities. For example, the system may compare a user's gait cycle to an average gait cycle; differences from the norm or delta of a user's gait can assist in identifying behavior modification opportunities. With tags, the system can define behavior patterns. One embodiment of a behavior modification method includes recording average gait, a resting profile, and a sitting profile. Step 1420. In the current embodiment, these profiles are recorded in terms of angle, stage, time, and force. In alternative embodiments, different measurements can be used to record the profiles and additional, fewer, or different profiles can be determined.

The behavior modification method may further include tagging attitude, mood, or user condition in the context of the user's current state. Step 1422. For that state or condition, the method includes recording the difference or delta in each area and the areas of movement, angle, stage, time, and force. Step 1424. The method may also include asking questions to learn and define patterns. Based on the information gathered, the method may recognize a pattern and associate it with a learned tag. The method may include determining a behavior modification opportunity based on the recognized pattern. Step 1428.

The personal device 710 of the illustrated embodiment of FIG. 7, similar to the personal device 510 described with respect of FIG. 5, may include one or more of a display 712, 3-axis accelerometer, surface electrodes 742, 744 for bio-impedance and bio-resonance measurements, BTLE with antenna, a 916.5 MHz low power transceiver with antenna, battery, wireless power transceiver, microphone and speaker, and temperature sensors. In the illustrated embodiment of FIG. 7 a personal device 710 is shown in the form of a bracelet capable of being worn on the wrist or ankle. The personal device 710 includes one or more electrodes 742, 744 used in conjunction with circuitry to measure bio-impedance. In this embodiment, the electrodes 744 are positioned on the inside of the bracelet and the electrodes 742 are positioned on the outer surface of the bracelet. With this arrangement, the electrodes 744 are in near constant contact with the user, allowing the user to obtain a bio-impedance measurement by consciously touching the other electrodes 742. In other words, the arrangement may enable the user to form a complete circuit for measuring bioelectrical signals. For example, the circuit is completed when the user wears the device around the ankle and holds the outside of the device with his or her hand, or around the wrist and holds the outside of the device with his or her alternate hand.

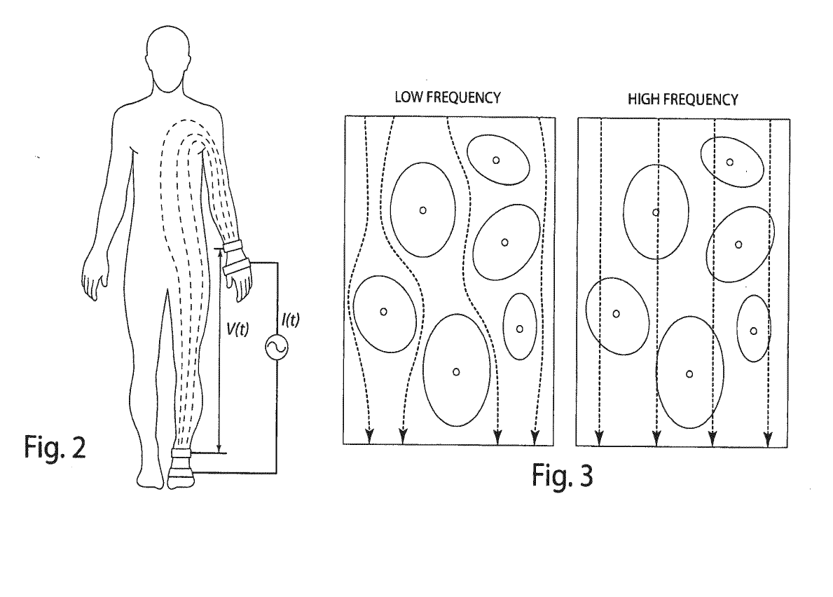

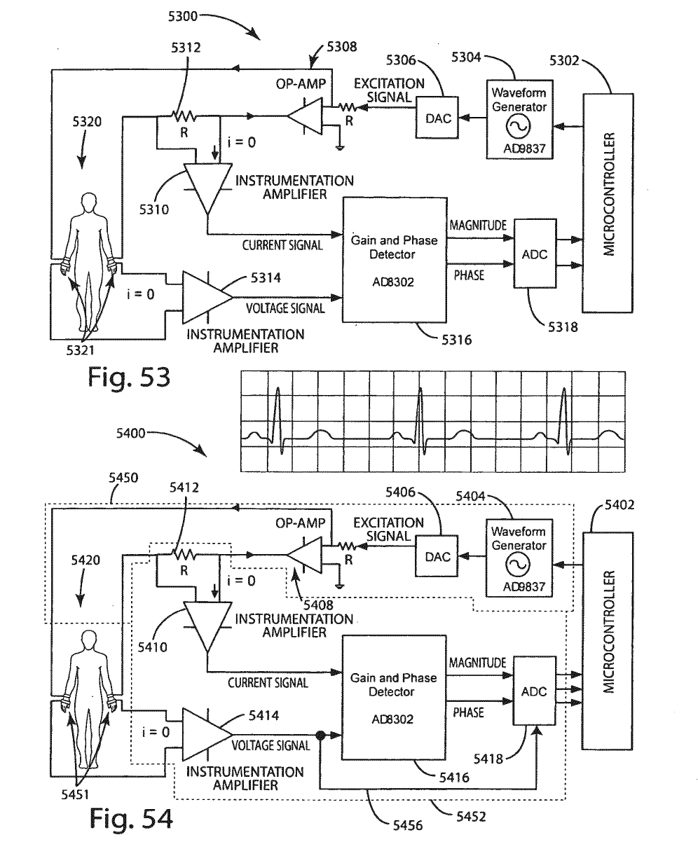

Bio-impedance measurements may be made across the arms and torso of the body when a personal device 5321 is worn on the wrist, as shown, for example, in FIG. 53. If the personal device 5321 is worn around the ankle, the bio-impedance measurement may be performed across the vertical length of the body as the user holds the outside of the personal device 5321 with the hand on the same side of the body as the leg it is being worn on, as shown in FIG. 2.

As shown in the illustrated embodiment of FIG. 6, a personal device 610 may include a mechanical clip 640 enabling the personal device 610 to be worn on a belt or waistband. The clip may also enable the personal device 610 to be clipped to an article of clothing such as a waistband, belt, pocket, collar, etc. bioelectric signals from the user. The personal device 610 may also include exposed electrodes 642, 644 used to measure bioelectric signals from the user. The electrodes 642, 644 may also enable measurements such as bio-impedance and bio-resonance when the user holds onto the personal device 610. Similar to the personal device 510 in the illustrated embodiment of FIG. 5, the personal device 610 may include one or more of a 3-axis accelerometer, wireless power transceiver, microphone and speaker, BTLE with antenna, a 916.5 MHz low power transceiver with antenna, battery, and temperature sensors. It should be understood that, like the personal device 510 described above with respect to FIG. 5, the personal device 610 may include a subset of these components, leaving out, for example, the wireless power transceiver and the lower power transceiver with antenna.

The personal device 510, 610, 710 in the illustrated embodiments of FIGS. 5-7 are described in connection with various configurations capable of measuring bio-impedance. However, the present invention is not limited to these particular configurations; any may also be incorporated into a shoe or other footwear that also enables a Bio-impedance or bio-resonance measurement to be made across the vertical length of the body.

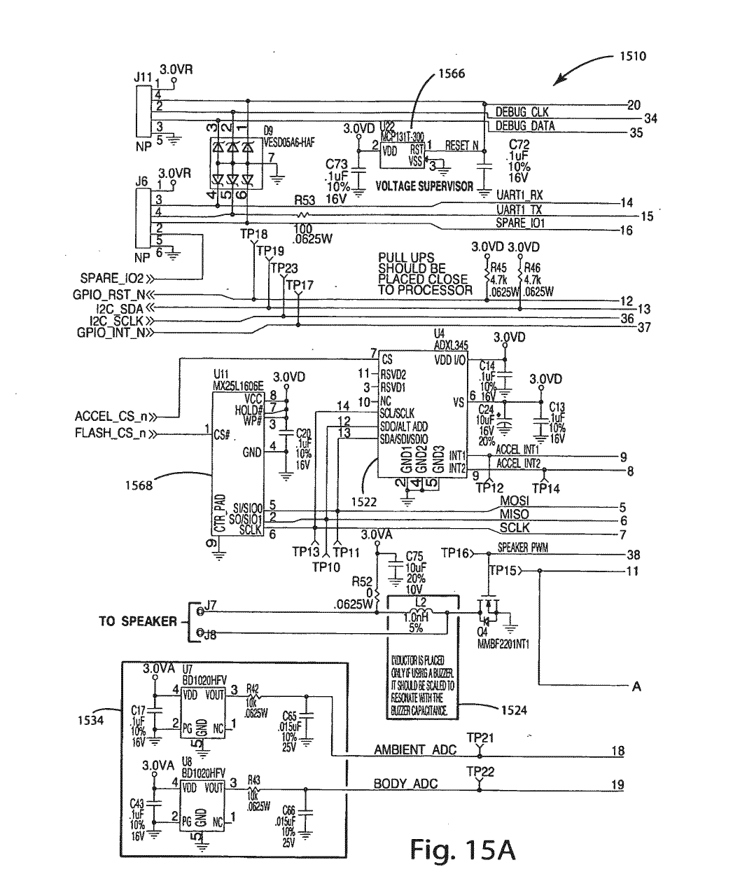

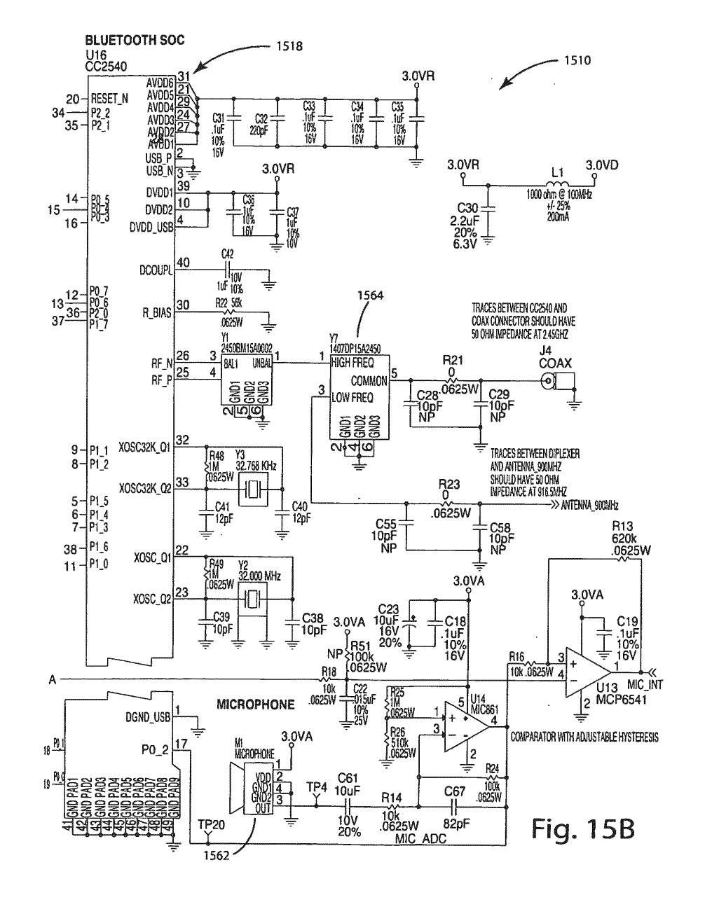

FIGS. 15A-B show a portion of a schematic for one exemplary implementation of a personal device. FIGS. 15A-B schematic includes a base controller 1518, temperature sensors 1534, 3-axis accelerometer 1522, microphone 1562, speaker 1524, Bluetooth RF layer 1518, RF control for the wake up mode 1564, micro controller 1518, supervisor circuitry 1566, non-volatile memory 1568.

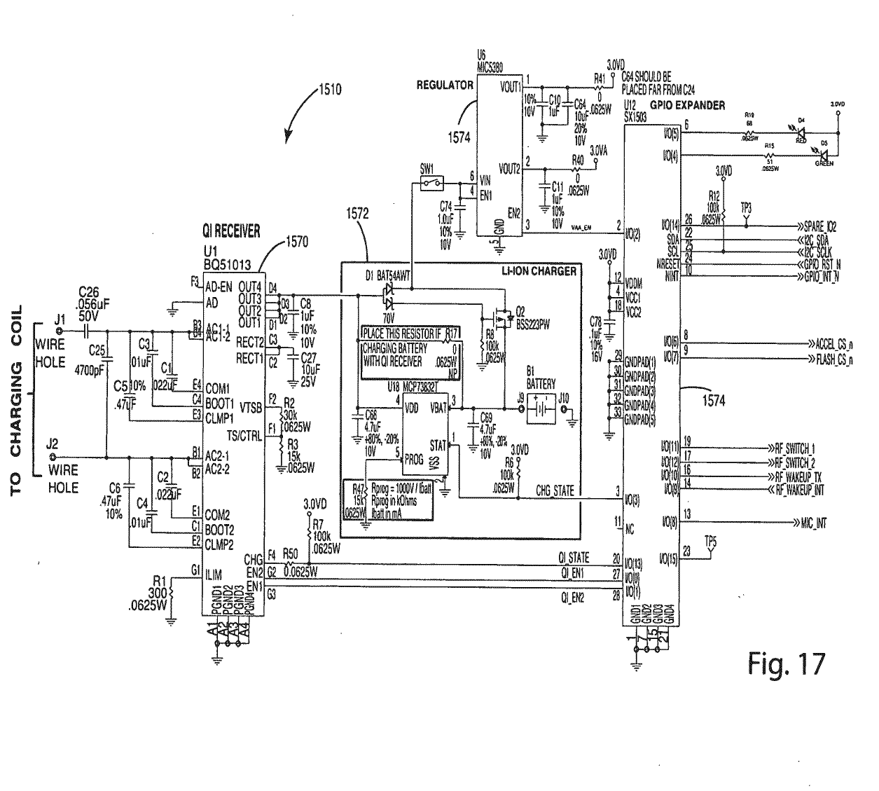

FIG. 17 shows a portion of a schematic for one embodiment of a personal device that contains a Qi wireless power controller 1570 along with a Li-Ion charger 1572 and system voltage regulator 1574. The personal device in this embodiment can include the wireless charging and power system. As shown, the personal device includes a GPIO expander 1574 to allow additional I/O for the system. It should be noted that the image near the bottom is a PCB layout of the complete system and can be made quite small. The Rx coil configuration can be single resonant coil or dual resonant coils. The same is true for the Tx.

A. Body Composition Capabilities

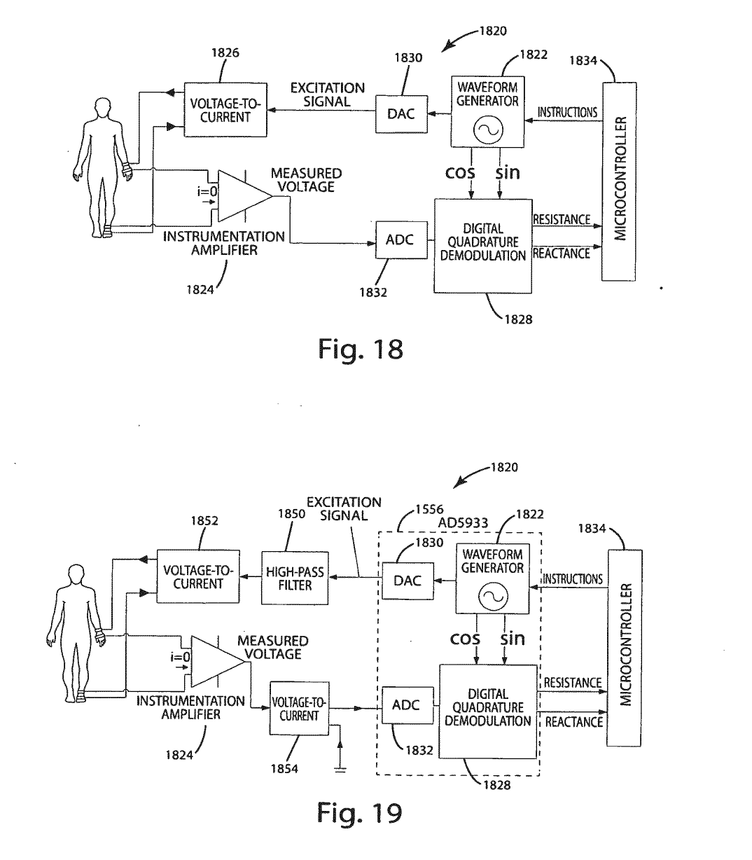

In embodiments in which the personal device is capable of monitoring body composition, the personal device may include bio-impedance and bio-resonance measurement circuitry, as discussed above. An example of bio-impedance and bio-resonance measurement circuitry is shown in FIGS. 18-20, as well as FIG. 53 and FIGS. 11A-C. The block diagram shown in FIG. 18 shows an example measurement circuit 1820 that includes microcontroller 1834, digital to analog converter 1830, a signal generator 1822, voltage-to-current translation circuit 1826, instrumentation amplifier 1824 to measure the resulting potential, analog to digital converter 1832 and a digital quadrature demodulator 1828 to measure the real and imaginary impedance of the body, as measured from hand to foot on one side of the body. FIG. 19 shows another example measurement circuit similar to the measurement circuit 1820 of FIG. 18, but further including enhanced measurement capabilities, including a high pass filter 1580 to AC couple the drive signal to the first voltage-to-current circuit 1852, as well as a second voltage-to-current circuit 1854 to provide a normalized measurement. In one embodiment, as shown for example in FIG. 19, the waveform generator 1822, digital to analog converter 1830, analog to digital converter 1832, and digital quadrature demodulator 1828 may be integrated into an analyzer 1856.

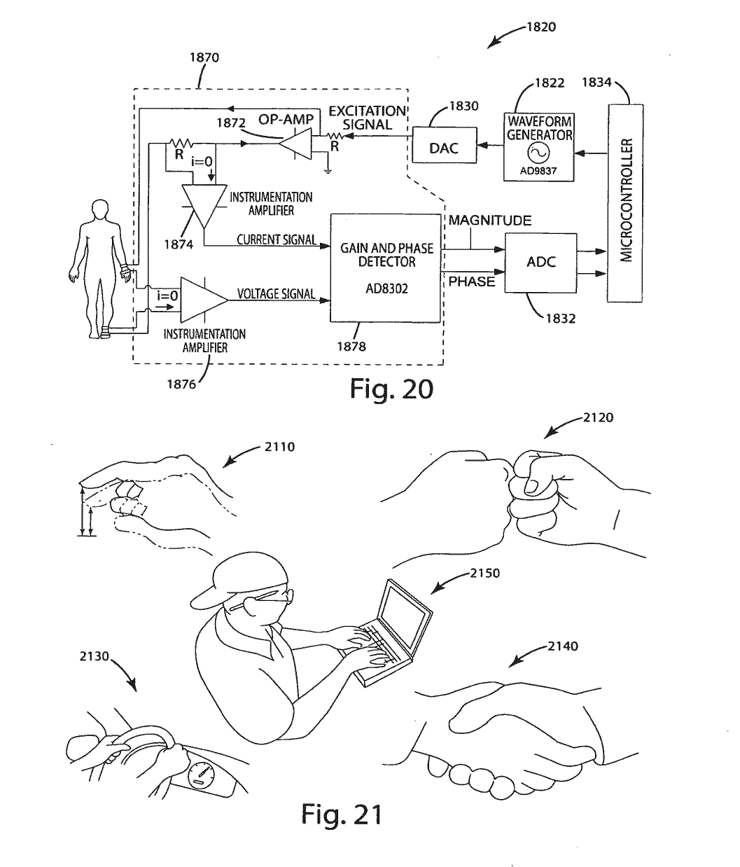

FIG. 20 shows yet another example bio-impedance and bio-resonance measurement circuit, similar to the measurement circuit of FIG. 18, but with several exceptions. This embodiment may include a gain and phase comparator circuit 1870 to measure real and imaginary impedances of the body as measured from foot to hand on one side of the body. The gain and phase comparator circuitry 1870 may include an inverting unity operational amplifier 1872, instrument amplifier 1874 to measure current, instrument amplifier 1876 to measure voltage, and a gain and phase detector 1878, which can output magnitude and phase signals respectively representative of the magnitude and phase difference between the current and voltage outputs of the instrumentation amplifiers 1874, 1876. FIG. 53 shows one embodiment in which the bio-impedance and bio-resonance measurement circuitry is used to measure the real and imaginary impedance across the torso from one arm to the other.

B. Gestures

A personal device or component in accordance with one or more embodiments of the present invention may be capable of performing predetermined actions or activities in response to detecting and identifying a predefined gesture.

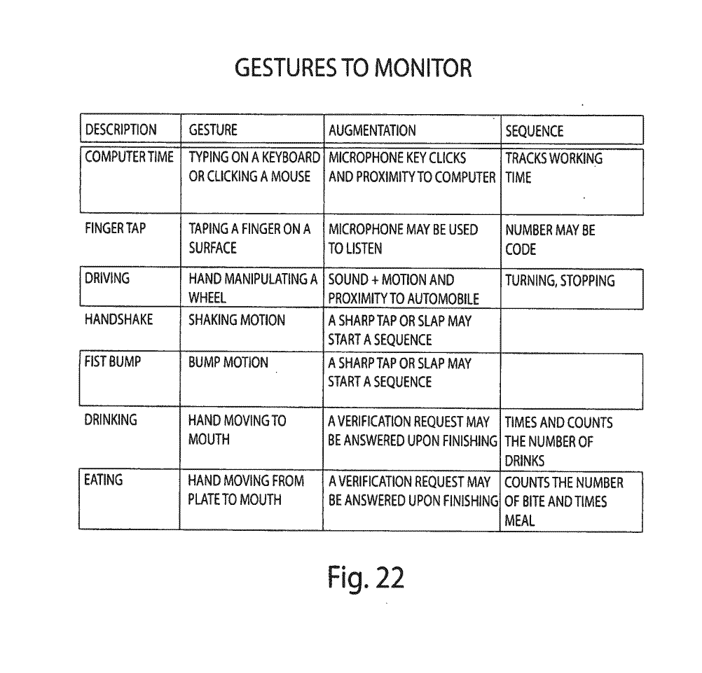

The illustrated embodiment of FIG. 21 shows some example gestures that the user may perform to initiate a predetermined action. In this embodiment, the personal device is configured to monitor a wrist 3-axis sensor, integrated in or separate from the personal device, to identify specific gestures. Each gesture can be used to initiate a social, monitoring or interaction activity. This gesture recognition can assist in understanding the user's activities by defining certain gestures to drive specific triggers. An example gesture that can trigger an activity can be tapping your finger 2110, which can be associated with an indication of stress or other indicators. For instance, tapping once can be an indication of stress, while tapping twice can be an indication of hunger. Tapping three times can be defined as an indication that the user wants a drink. Each predefined gesture can be tailored to a specific behavior modification activity. For example the system may monitor for typing 2150, handshakes 2140, driving 2130. These activities can be but are not limited to such issues as alcoholism, stress or anxiety, narcosis, weight management, social disorders, personal enhancement, environmental interaction, and many others. FIG. 22 provides a list of some basic gestures that can be monitored, and how these can be augmented by additional monitoring capabilities to make informed decisions, along with the sequence of activities.

In one embodiment, gesture or movement recognition may be used in conjunction with personal devices being worn by two different individuals. As described with respect to FIG. 21, each personal device can monitor for movement or predefined gestures, and perform an action in response to detecting movement or a predefined gesture. With a personal device being worn on the wrist of each of the two individuals, a high-five or fist-bump action 2120 such as those shown in FIG. 21 can result in a short and sudden spike in accelerometer amplitude. This change in amplitude can be used as a signal to wake up the personal devices and cause them both to begin searching for other nearby devices. By using this mechanical/gesture approach, both devices can be woken at approximately the same time. Similarly, other gestures could initiate actions from the personal devices, such as those shown in FIG. 22. Each gesture may be accompanied by an augmentation from the device, such as an audible tone, visible display, or mechanic feedback.

C. Position or Speed Determination

Components of the behavior modification system, such as a personal device, may be capable of monitoring a user's activity and determining one or more of position and orientation of the user. Although described in connection with the personal device, the user's activity may be monitored and categorized by one or more components, including or not including the personal device, in the system. For example, the personal device may be used in conjunction with a separate accelerometer sensor worn or carried by the user.

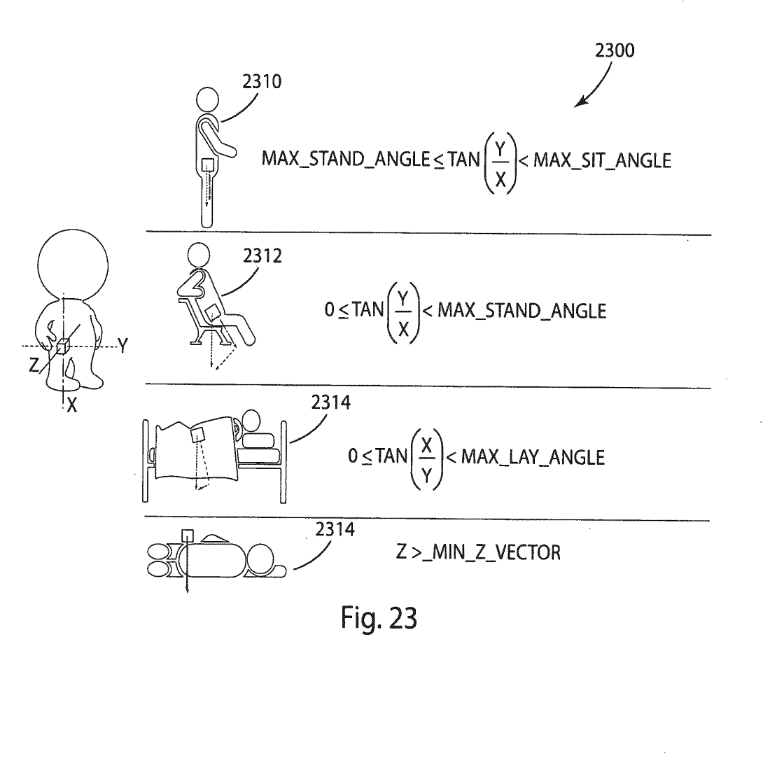

By monitoring data from the accelerometer sensor, the personal device may be capable of determining whether the user is standing, sitting, or laying. FIG. 23 shows the 3 main positions a user can be categorized into: standing 2310, sitting 2312 or laying 2314 (supine), along with the axis of measurement for a set of accelerometers (X, Y, and Z axis).

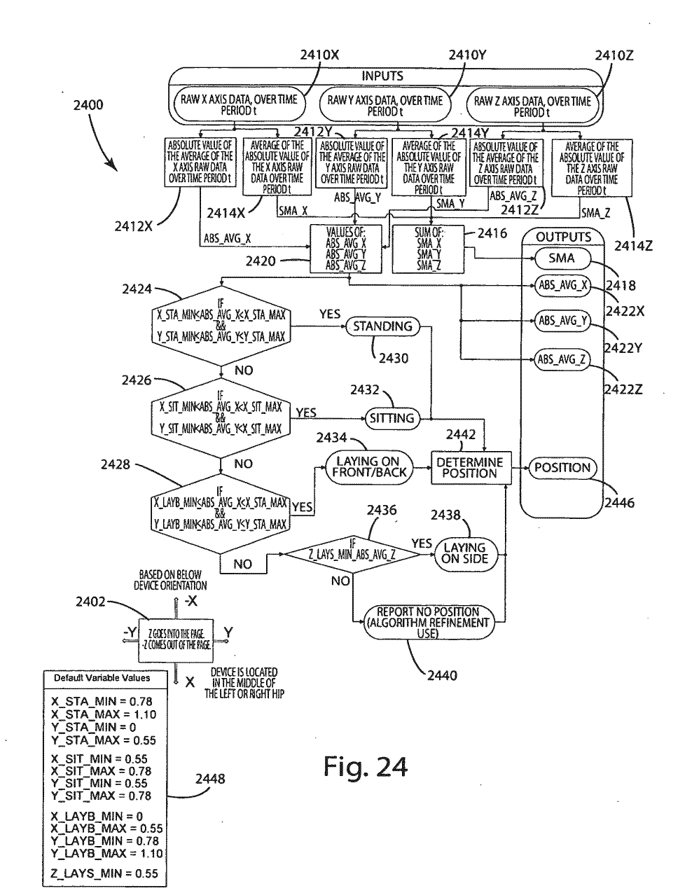

A method according to one embodiment is shown in FIG. 24 for determining position and activity (or SMA) based on sensed information from one or more accelerometers. Using this method, the personal device or another component in the system may categorize the position, orientation, or combination thereof, of the user. The method provided in FIG. 24 generally includes the step of taking raw data from the accelerometer 2402 over time t and analyzing the data to provide outputs representative of SMA, absolute value of the average of the x-axis raw data, absolute value of the average of the y-axis raw data, absolute value of the average of the z-axis raw data and body position (e.g. standing, sitting or lying). Referring now to FIG. 24, the method includes the steps of taking raw data from the x, y and z axes of the accelerometer 2402 over time t as shown at input boxes 2410x, 2410y and 2410z. The raw data from each axis of the accelerometer 2402 is separately analyzed to determine separate averages of the absolute value of the raw data for each axis over time period t, as shown at boxes 2414x, 2414y and 2414z. The averages of the absolute values of the raw data are summed at box 2416 to determine SMA, which is output at box 2418. Further, the data from the different axes of the accelerometer 2402 is separately analyzed to determine separate absolute values of the average of the raw data for each axis of the accelerometer over time period t, as shown at boxes 2412x, 2412y and 2412z. The absolute values are passed to box 2420. From box 2420, the absolute values are separately output at boxes 2422x, 2422y and 2422z. Additionally, the absolute values are passed to decision boxes 2424, 2426 and 2428 where the data is analyzed to determine if the user is standing 2430, sitting 2432, laying on front or back 2434 or laying on side 2438. Referring now to decision box 2424, if the absolute value of the average of the x-axis data is between a set of predefined values and the absolute value of the average of the y-axis data is between a set of predefined values, then the user is standing as shown at box 2430. In such cases, the value “standing” will be sent to box 2442. Referring now to decision box 2426, if the absolute value of the average of the x-axis data is between a set of predefined values and the absolute value of the average of the y-axis data is between a set of predefined values, then the user is sitting as shown at box 2432. In such cases, the value “sitting” will be sent to box 2442. Referring now to decision box 2428, if the absolute value of the average of the x-axis data is between a set of predefined values and the absolute value of the average of the y-axis data is between a set of predefined values, then the user is laying on the user's front or back as shown at box 2434. In such cases, the value “laying on front/back” will be sent to box 2442. If the outcome of box 2428 is “no”, then control passes to decision box 2436. If control passes to decision box 2436 and the absolute value of the average of the z-axis data is greater than a predetermined value, then the user is laying on the user's side as shown at box 2438. If not, the method may return “no position” as shown at box 2440. The outcome of these various decision boxes is output at box 2446. Although the predetermine values for determining body position may vary from application to application, a set of predetermined values is shown in list 2448 of FIG. 24.

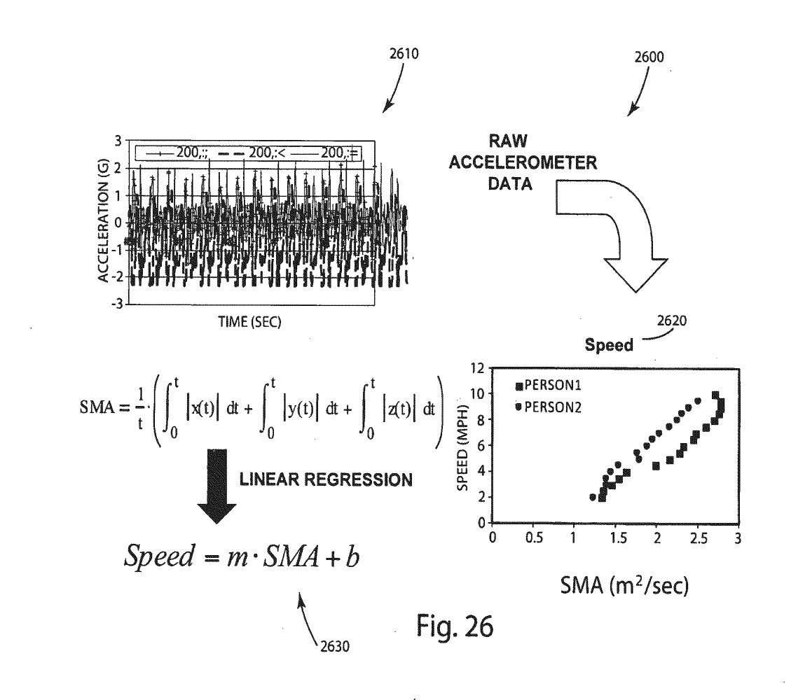

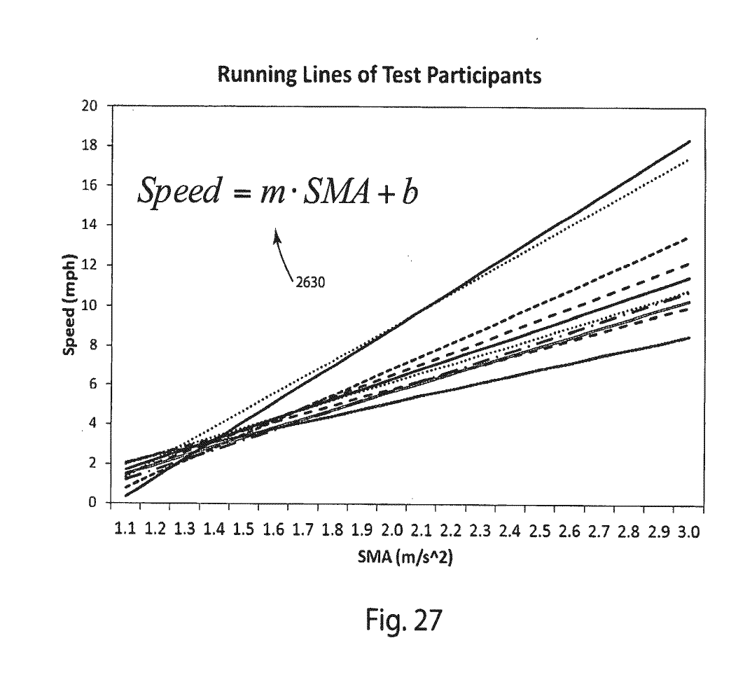

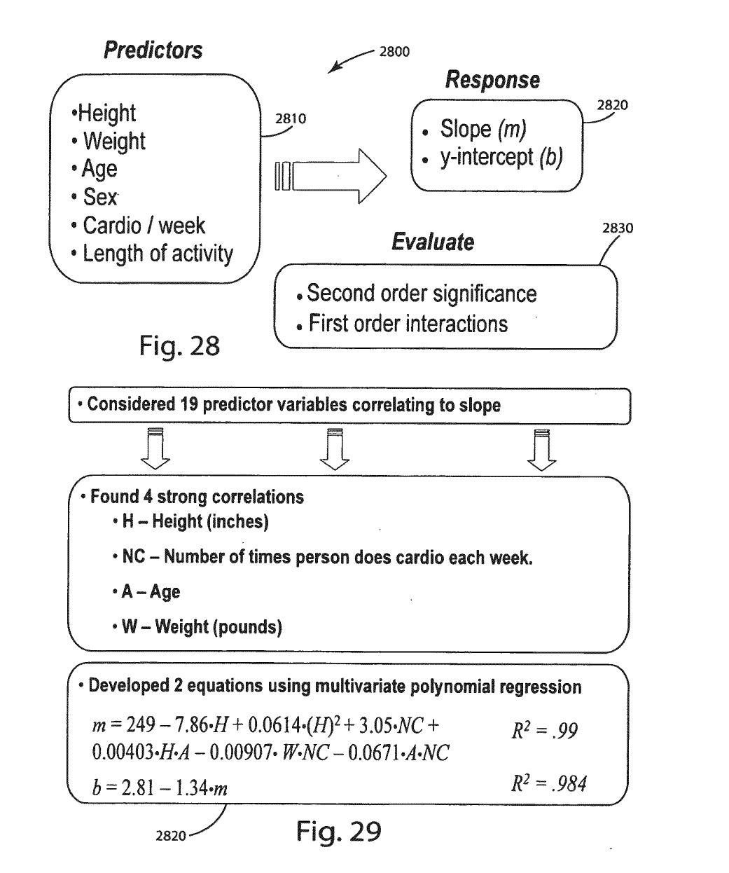

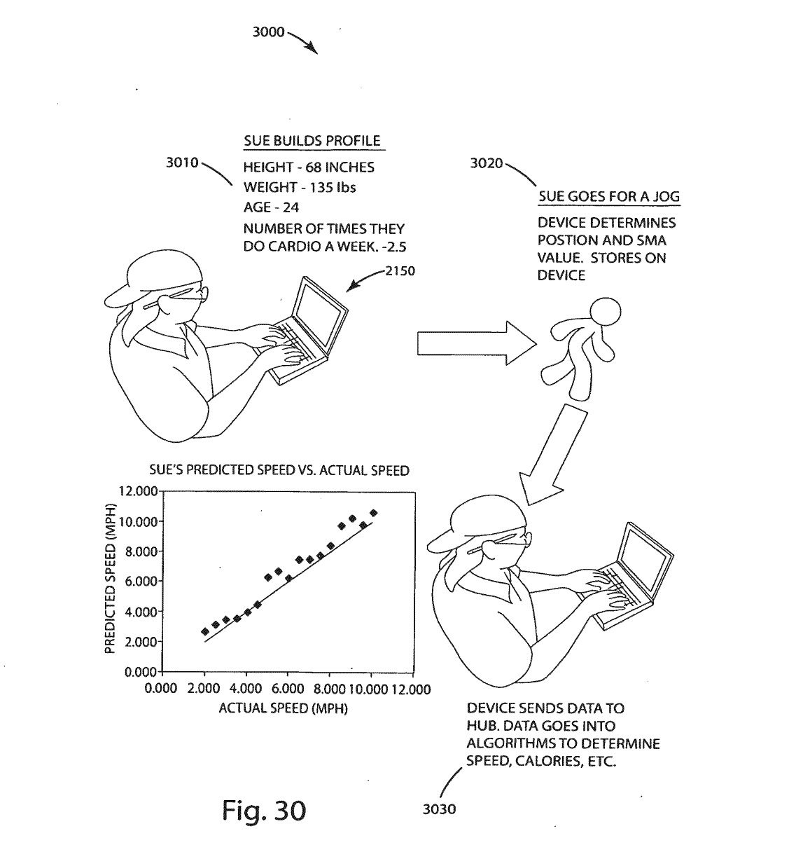

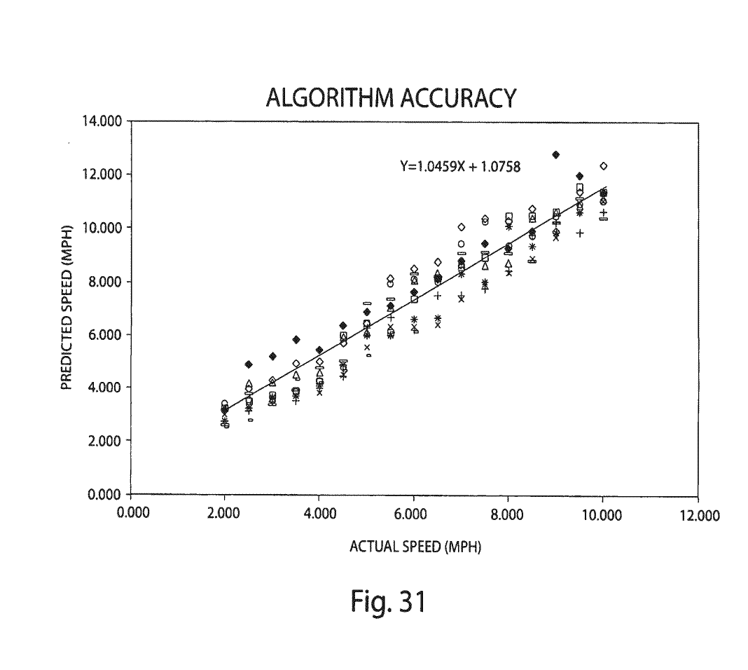

The graphs and information depicted in FIGS. 26 and 27 show a correlation 2630 between SMA (based on raw acceleration data 2610) and Speed 2620 for a number of users. By identifying this correlation, the user's activity can be monitored and identified at a later date. Specifically, as shown in FIG. 28, the relationships between predictors 2810 and correlation factors (m and b) 2820 for the Speed calculation 2630 can be deduced. The system may take into account one or more characteristics about the user, including, for example, height, weight, age, sex, cardio per week, and length of activity. With this data, correlation factors 2820 and the formula 2630 for calculating Speed from SMA can be determined, as shown in FIG. 29. And, once speed can be calculated from SMA, the user's predicted speed can be calculated in accordance with the method shown in the illustrated embodiment of FIG. 30. Specifically, in this embodiment, a user may build his/her profile, identifying characteristics about themselves, such as height, weight, age, and the number of times they do cardio per week. Step 3010. The user may perform an activity that results in an increased SMA level or value. This SMA value can be monitored and stored on a component (e.g., a personal device) in the system. Step 3020. The personal device may send data relating to the SMA value to a hub or other component in the system. The data may be analyzed based on the user's profile and characteristics to determine speed based on the formula 2630 and correlation factors 2820. FIG. 31 shows the predicted speed based on the method 3000 vs. actual speed measurement for a number of users all running at various speeds on a treadmill.

The personal device may have essentially any type of housing. For example, the housing may be in the form of a wearable item, such as a wristband, bracelet, anklet or other similar item. As another example, the housing may be in form suitable for carrying or clipping to a user's clothing. In any event, it may be desirable to provide a housing that is water-resistant or waterproof.

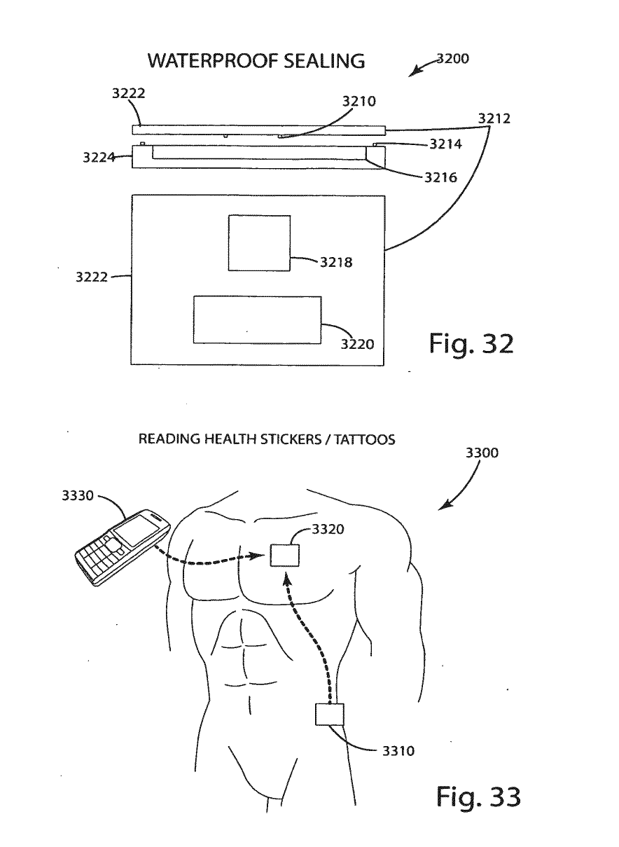

FIG. 32 shows one embodiment of a protective ultrasonically sealed enclosure 3222, 3224 that allows exposure of the sensor elements while sealing the core electronics 3216. In this embodiment, the sensors or contact surface 3218, 3218 can be insert molded into the body facing surface 3222. The molded insert 3218, 3220, 3222 of the enclosure can mate with the PCBA 3216 to specific pads 3210 that enable the sensor or sensor connections 3218, 3220 to complete the sensor operation while allowing a waterproof seal. Ultrasonic ribs 3214 can form a waterproof seal between parts of the enclosure 3222, 3224. To ensure that the device is durable in its construction, the device may be sealed using an ultrasonically welded plastic housing, such as the construction shown in FIG. 32. By molding the PCB into the plastic housing with copper pads from the PCB exposed, the electrodes that are used become part of the rigid construction.

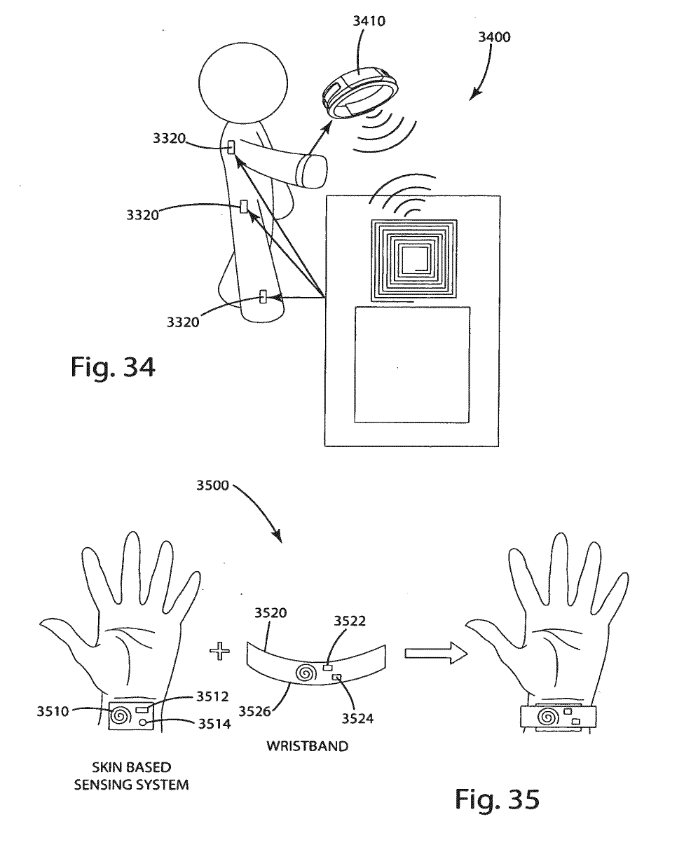

As noted above, the personal device may be capable of communicating with separate sensors to collect data from those sensors. For example, a user may wear one or more sensors that are separate from the personal device and are capable of wirelessly providing data to the personal device. FIG. 34 shows the personal device 3410 communicating wirelessly with several remote sensors 3420 located on the user that are attached, carried, or worn by the user. In this embodiment, the personal device 3410 may optionally power the sensors 3420 wirelessly by configuring its wireless power receiving circuit into a wireless power transmitting circuit. Once able to transmit power, the personal device 3410 may power other sensors and collect data during and after powering. The user may hold the personal device 3410 up to the remote sensors 3420 to provide close-range inductive power, or the personal device 3410 may transmit energy over larger distances using mid-range or far-field techniques.

FIG. 35 shows an example of how a wirelessly powered conformal skin sensor 3510 can be powered by personal device 3510 that is in the form of a wristband. The conformal skin sensor 3510 could have one sensor or a plurality of sensors 3512, 3514. The information collected by these sensors 3512, 3514 could be wireless sly transmitted and stored on a microprocessor 3522 located on the wristband 3520. The wristband 3520 may include an energy storage element 3524, such as a battery, and a transmitter coil 3526 for one or more of transmitting wireless power and communicating with the wristband 3520. The microcontroller 3522 may control power transfer from the energy storage element 3524 to the transmitter coil 3526, and ultimately to the skin sensor 3510.

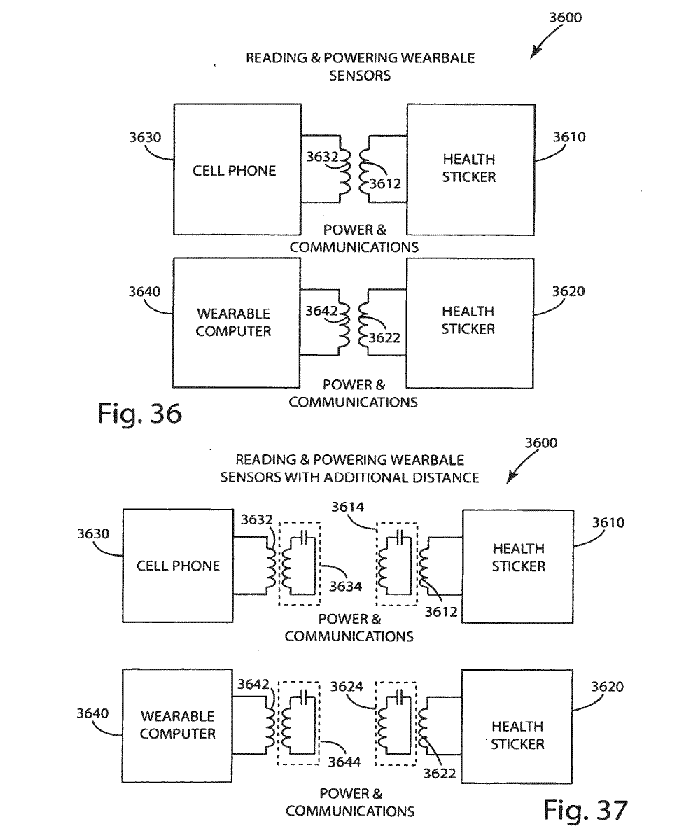

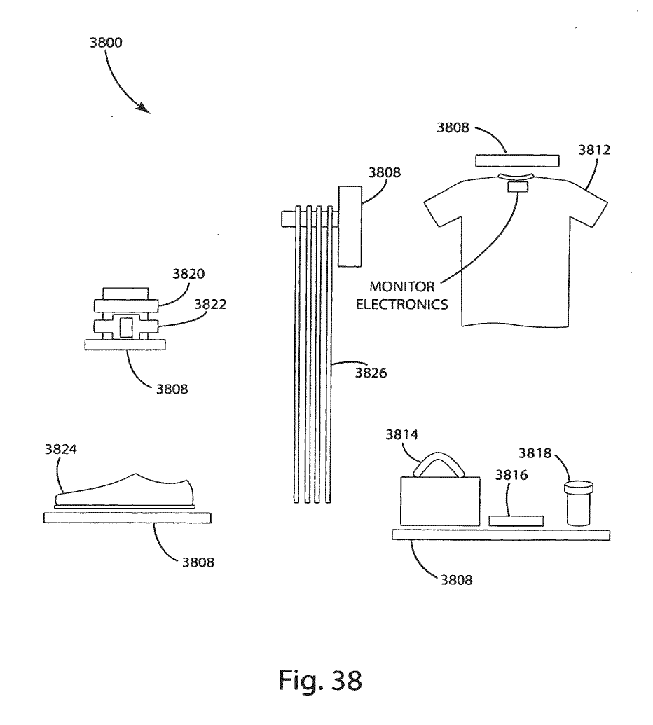

FIG. 36 shows several examples of how power and communications is achieved using one embodiment of the wireless power system. In the upper example, a cell phone 3630 is used to provide power to a remote sensor 3610 and to collect data from the sensor 3610. In this embodiment, power may be inductively transferred to the remote sensor 3610 and the remote sensor 3610 may communicate with the cell phone 3630 using backscatter modulation or essentially any other form of communication. Coils 3632, 3612 may be used in conjunction with this power transfer or communication. In the lower example, a personal device 3640 in the form of a wearable computer (rather than a cell phone) provides inductive power to and communicates with the remote sensor 3620. Power and communication may be transferred via the coils 3622, 3642. FIG. 37 shows the systems in FIG. 36, but with added range using additional resonant coils 3614, 3624, 3634, 3644. FIG. 38 shows how various chargers can be configured to charge monitors and devices that allow maximum convenience to the user. By making the use of these systems easier and more convenient we see a higher use ratio. In this diagram we show example charging solutions for ties 3826, belts 3826, watches 3822, wrist bands & bracelets 3820, shoes & shoe inserts 3824, wallets & money clips 3816, purses 3814, pill bottles 3818, packages, and clothes 3812. A wireless charger 3808 may be used to provide power wirelessly to one or more of these items depending on the configuration.

### III. Predicting Caloric Intake

In one embodiment, the behavior modification system is capable of predicting caloric intake based on one or more factors. The prediction processing may be located on any component within the system. For example, the prediction processing may be carried out by a processor located on the personal device. As another example, the prediction processing may be carried out by a processor located on a server on the Internet.

In one embodiment, the method for predicting caloric intake uses the change in body composition, U(t), along with the caloric expenditure, E(t). Equation 1 shows one calculation of caloric intake I(t):

U(t)+E(t)=I(t) (1)

There are a number of methods of obtaining information relating to change in body composition and caloric expenditure. A number of examples of obtaining U(t) and E(t) are described herein.

A. Energy Expenditure

E(t) is the energy or caloric expenditure of a user over a period of time. In one embodiment, E(t) can be calculated from the user's total activity along with other means of energy expenditure. In an alternative embodiment, the caloric expenditure could be input by the user or otherwise obtained as discussed herein.

One estimation of total E(t) over a defined period of time (shown in equation (1)) is comprised of basal metabolic rate (BMR), activity induced energy expenditure (AIE), the thermic effect of food (TEF), and non-exercise activity thermogenesis (NEAT). Total E(t) for an individual can be calculated by equation (2).

E(t)=BMR+AIE+TEF+NEAT. (2)

Since BMR is a clinical measurement that can only be measured while the person is completely stationary, The system may substitute RMR (resting metabolic rate) which has more tolerance for small movements while measuring. There are many equations that can be used to predict RMR. By comparing predictive equations for resting metabolic rate in healthy non-obese and obese adults, the RMR can be predicted. One equation that can be used to predict RMR is the Mifflin-St Jeor equation:

Men: RMR=9.99·weight+6.25·height−4.92·age+5 (3)

Women: RMR=9.99·weight+6.25·height−4.92·age−161 (4)

As part of equation (2) the system may calculate AIE. In one method of finding AIE, speed is a component. Speed of a moving person may be calculated based on certain physical characteristics and data collected by a 3-axis accelerometer. The speed may be calculated using equation (5):

$$Speed ( \frac{meters}{minute} ) = ( \frac{1609344}{60} ) \cdot ( SMA - 1.34 ) \cdot ( 249 - 7.86 \cdot H + 0.0614 \cdot {( H )}^{2} + 3.05 \cdot NC + 0.00403 H \cdot A - 0.00907 \cdot W \cdot NC - 0.0671 \cdot A \cdot NC ) + 2.81 \qquad ( 5 )$$

The following variables from equation (5) are defined below.

H—Height (inches)
NC—Number of times person does cardio each week.

### A—Age

W—Weight (pounds)

VO₂=α₁·S+β₁·S·G. (6)

Another component of AIE is VO₂, which is a measure of the rate at which a person's body uses or transports oxygen. Equation (6) from the American College of Sports Medicine (ACSM) can be used to estimate VO₂. VO₂ can be expressed in liters per minute, or as a rate per unit mass of the person such as milliliters per kilogram per minute. In equation (6) there are three parts, horizontal, vertical, and resting. Resting is left out for our purposes since it is address earlier. The horizontal portion is the first part of equation (6). The α₁ term is constant, and S is the speed the person is moving in meters per minute. The second portion is the vertical piece where β₁ is a constant S is speed, and G is the gradient of the hill.

Another way to estimate VO₂ is identified below in Equation (7). Equation (7) may be implemented in one embodiment of the personal device:

VO₂=αₙ·S+βₙ·S·G+F(GP,A,S). (7)

The first part of equation (7) is similar to equation (6), however, the coefficients change depending on what segment of speed the user is moving at. If the user is walking, these coefficients are different from when the user is running. By collecting accelerometer data, the personal device can determine these coefficients to smaller speed segments, and may be able to fit them to a function based on speed as can be seen in equation (8) and (9),

αₙ=a·S+b, (8)

βₙ=c·s+d, (9)

where a, b, c, and d are constants. Substituting these equations into the first portion of equation (7) results in a multivariable polynomial equation (10):

VO₂=a·S²+b·S+c·S²·G+d·S·G+F(GP,A,S)+ε, (10)

ε is an error term, and F(GP, A, S) is a function of genetic profile, age, and sex. This function can make the calculations specific to the user. Each user takes in a different amount of oxygen when working out, and according to the ACSM equations two people weighing the same will have the same VO₂ levels. However, this is typically not the case. For example, an out of shape 130 lb male child will burn energy at a different rate than a 130 lb female marathon runner.

Equation (10) uses the following conversion equation (11) to calculate AIE. It is based on the premise that the average person burns 5 kcal per liter of O₂.

$$AIE = {VO}_{2} \cdot Weight ( lbs ) \cdot \frac{2.2}{1000} \cdot \frac{5 kcals}{{LiterO}_{2}} . \qquad ( 11 )$$

The thermic effect of food (TEF) portion of equation (2) for calculating E(t) is based on the number of calories consumed in a day. An accepted approximation for TEF is given below in equation (12):

TEF=0.075·I(t) (12)

As for the non-exercise activity thermogenesis (NEAT) portion of E(t) in equation (2), NEAT is a fixed caloric expenditure value based on a person's lifestyle. Whatever is not quantified by the personal device from the AIE equation can be adjusted for with NEAT approximations using activity codes and Metabolic Equivalent Task (MET) intensities. If I(t) is unknown, the system may ignore the NEAT portion of the E(t) calculation.

B. Body Composition

U(t) is the change in energy stored (positive) or used (negative) by the body. This energy is stored either as Fat Mass or Fat Free Mass. One method for determining U(t) is based on bio-impedance spectroscopy, which is discussed in the background. In one embodiment, the U(t) determination may be based on bio-resonance, which is discussed herein.

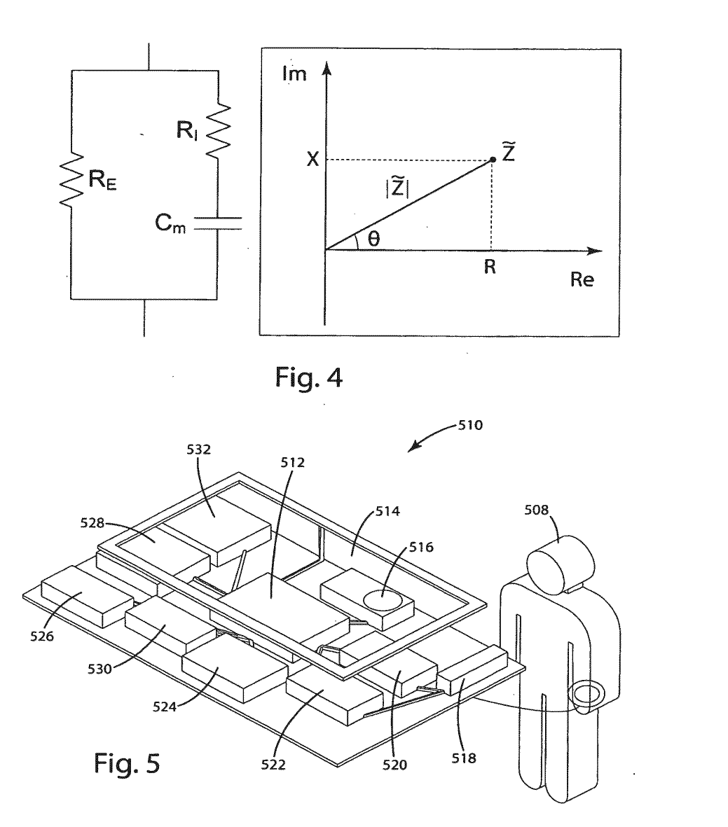

In one embodiment, the system may include bio-impedance measurement circuitry. FIGS. 11A-C show an example circuit including a signal generator A, a constant current drive B to translate the voltage signal to an applied current, and a magnitude and phase measurement circuit C. In this example, the signal generator may sweep the frequency of the signal from 3 kHz to 1 MHz. The magnitude and phase measurement circuit may compare the current output from the signal generator to the voltage being measured at the skin electrodes. This magnitude and phase measurement may be used to calculate the real and imaginary impedances for each frequency being measured. FIG. 4 shows a model equivalent circuit having two resistors in parallel, one which is in series with a capacitor. The capacitor represents the cellular walls of the cells, the series resistor represents the resistance of the intracellular water, and the parallel resistor represents the resistance of the extracellular water. These real and imaginary impedances for the measured frequencies may be used to calculate the intracellular and extracellular water. For example these values may be plugged into the Hanai model that outputs water volume. In alternative embodiments, total body water for a user may be derived using a different model, or based on additional or different data.

Intracellular and extracellular water can be indicative of fat free mass and fat mass in a user's body. That is, in one embodiment, extracellular water and intracellular water provided by the Hanai model can be converted to FFM and subsequently FM. More specifically, extracellular water and intracellular water from the Hanai model can be combined to estimate an individual's total body water. Total body water may be converted to FFM using an empirical model. For example, one empirically determined model is FFM=TBW/0.73. Put another way, for a typical person total body water weight is about 73% of free fat mass. The estimation of free fat mass can be used to estimate fat mass by subtracting FFM from total body mass. Total body mass may be provided by a user or determined by a sensor in the behavior modification system.

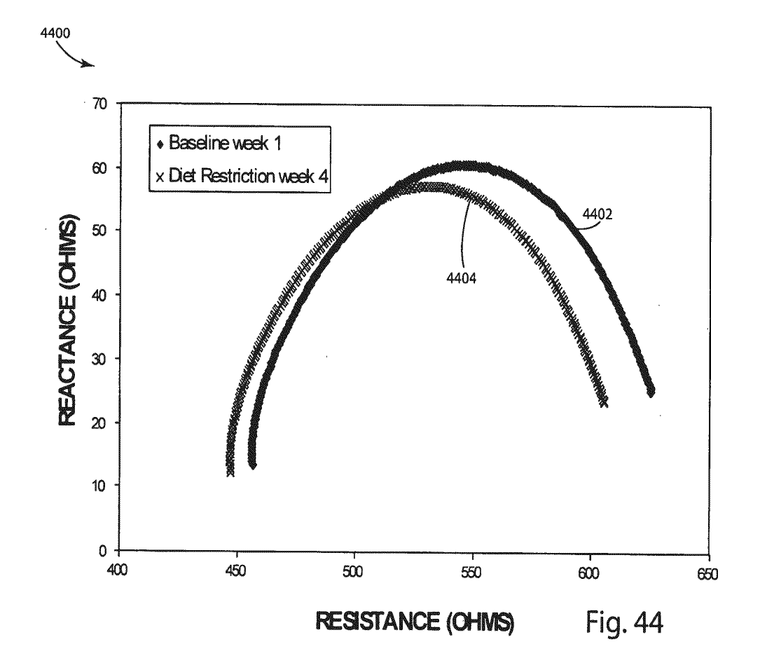

Bio-impedance spectroscopy can be used to determine changes in body composition (e.g., weight loss). FIG. 44 shows a bio-impedance graph 400. The graph plots bio-impedance during a baseline 4402 and after a diet restriction 4404. The graph can be used to in conjunction with an analysis on a subject during a weight loss study using averaged Bio-impedance Spectroscopy measurements. During the first and second weeks of the study, the user maintained a standard diet. During the third and fourth weeks of the study, the user was placed on a restricted diet that reduced caloric intake by 20%. It can be seen that the average resistance-reactance measurement (bio-impedance spectroscopy measurement) changes from the first week to the fourth week, indicative of weight lost by the individual.

### IV. Bio-Resonance

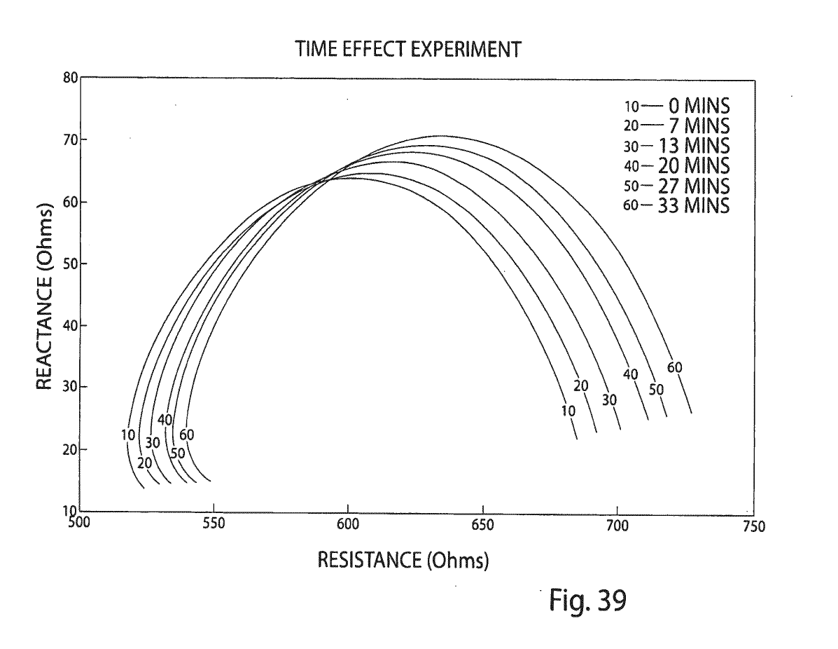

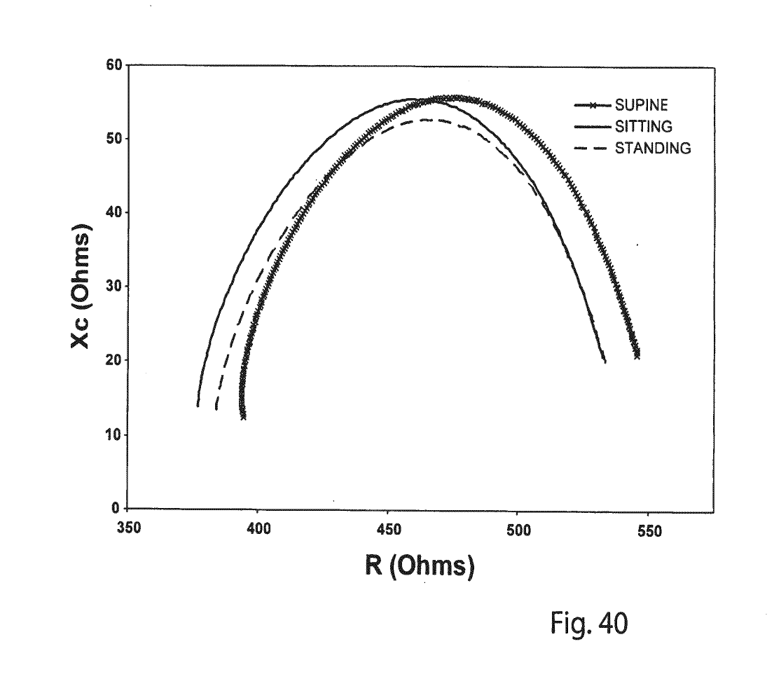

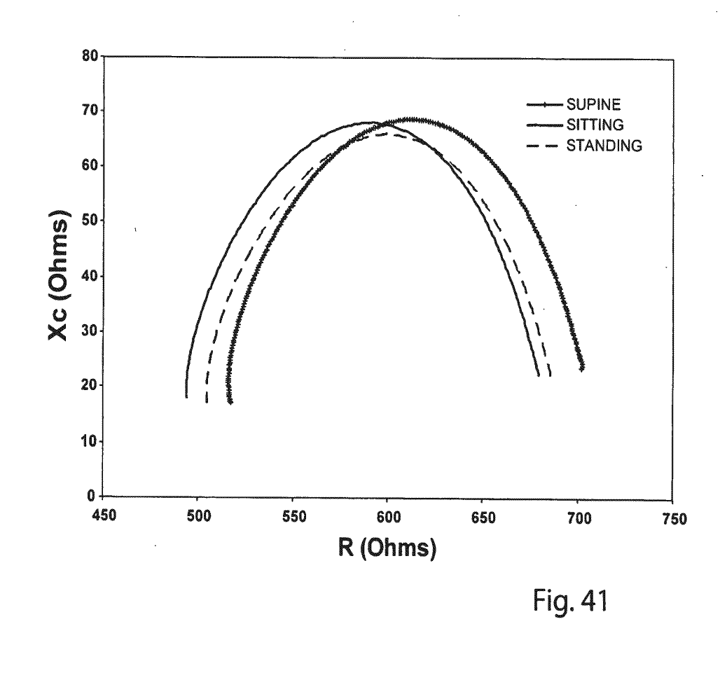

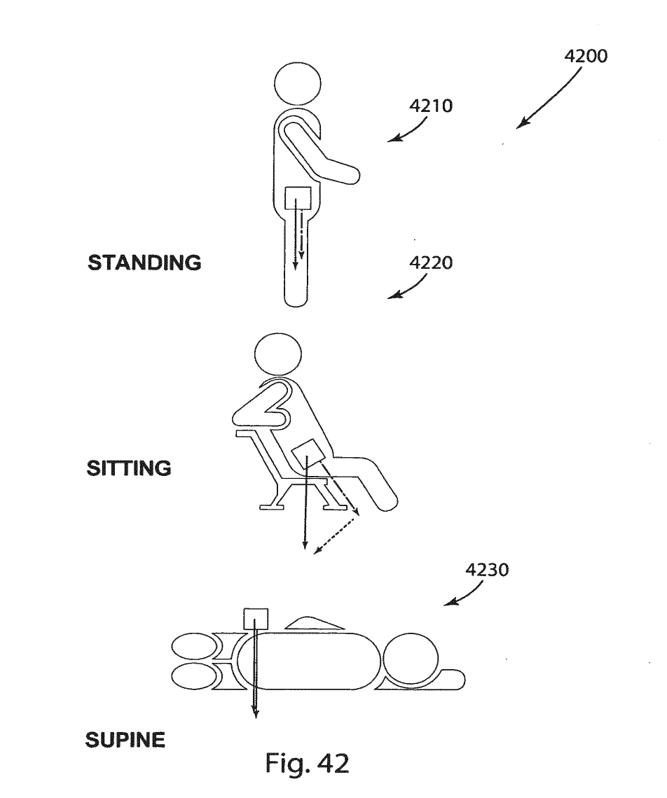

Measurements taken using bio-impedance spectroscopy can be subject to short term variations due to a number of factors. FIG. 39 shows the variation of bio-impedance over a period of 33 minutes for a subject. FIG. 40 also shows the variation in Bio-impedance measurements for a subject depending on the subject's body orientation. As shown, whether the subject is sitting, standing, or supine (lying down) changes the resultant bio-impedance. It can be seen that even though these measurements are taken within 2 minutes of one another, to keep variations in hydration small, there are drastic changes to the curves. FIG. 41 shows the resultant data for a second subject under similar circumstances. By using a 3-axis accelerometer attached to the hip of a user, the position of the user can be determined and used to either normalize the measurement of the X-axis intercepts, or can be used to adjust the calculation of TBW. FIG. 42 shows the location of the accelerometer and the gravitational vectors measured in one embodiment to determine whether the user is sitting 4220, standing 4210, or supine 4230.

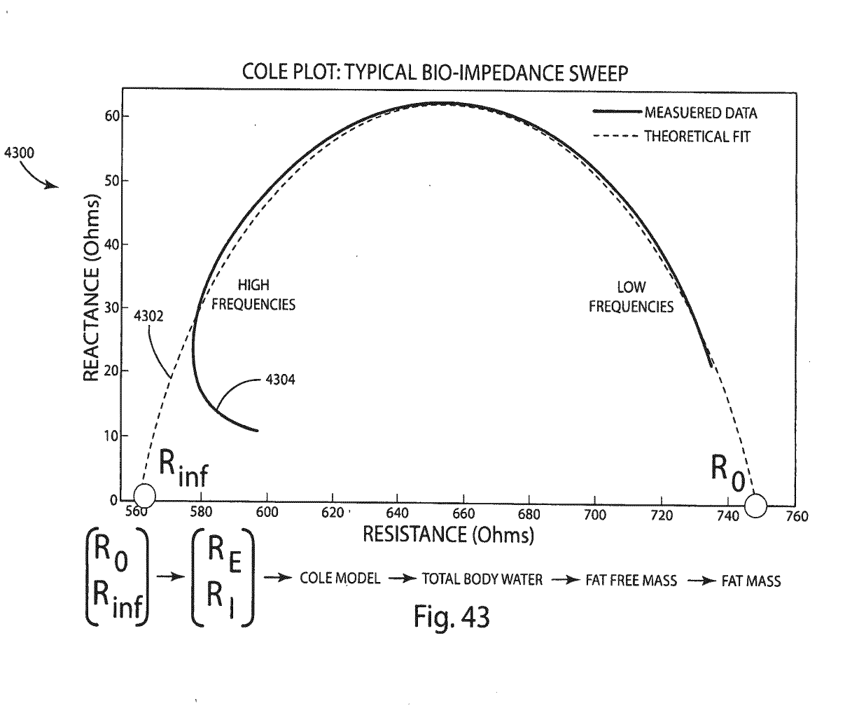

FIG. 18 shows an exemplary schematic of a bio-impedance spectroscopy measurement circuit. This circuit can also be used for bio-resonance measurements. FIG. 19 shows an alternate schematic of a bio-impedance spectroscopy measurement circuit that can also be used for bio-resonance measurements. FIG. 43 shows a Cole Plot 4300 of resistance vs. reactance as measured by the bio-impedance circuit 4304. The X intercepts are calculated using a best-fit curve 4302. These intercepts are used as R₀ and R_{inf}, or the DC resistance (R₀) and the AC resistance (R_{inf}).

In one embodiment, bio-resonance includes improving the accuracy of bio-impedance spectroscopy. For example, bio-resonance includes adjusting the bio-impedance spectroscopy readings based on additional sensors indicative of the user's state. Information from the additional sensors may be used to normalize bio-impedance readings over time.

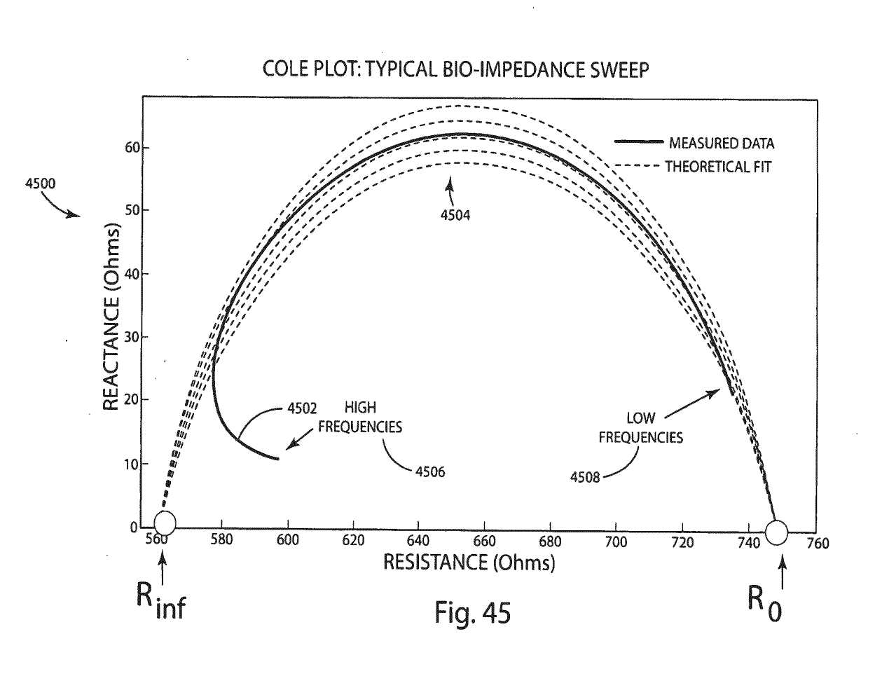

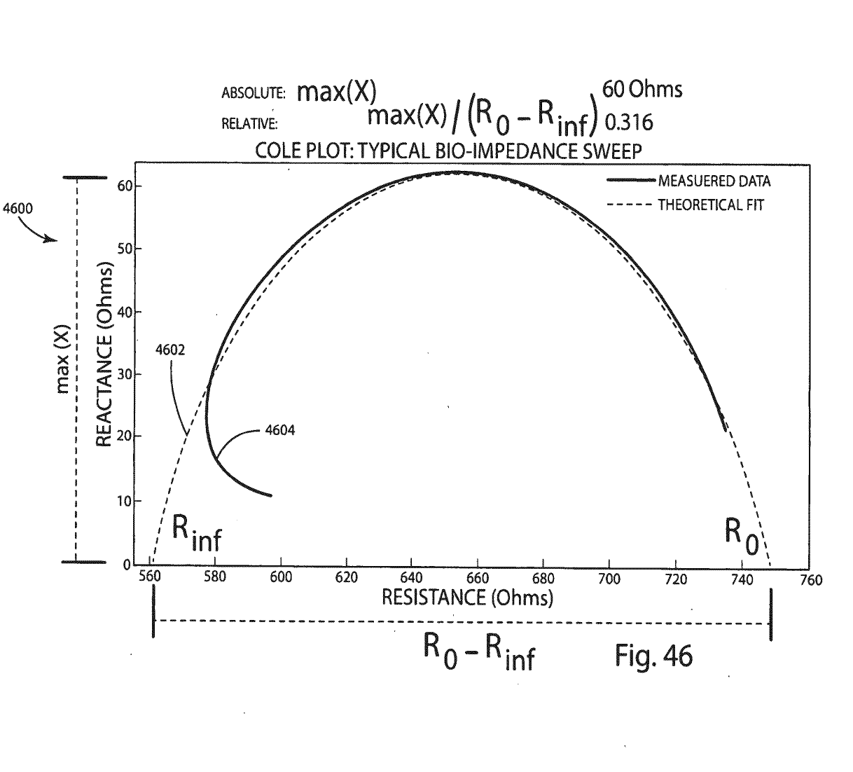

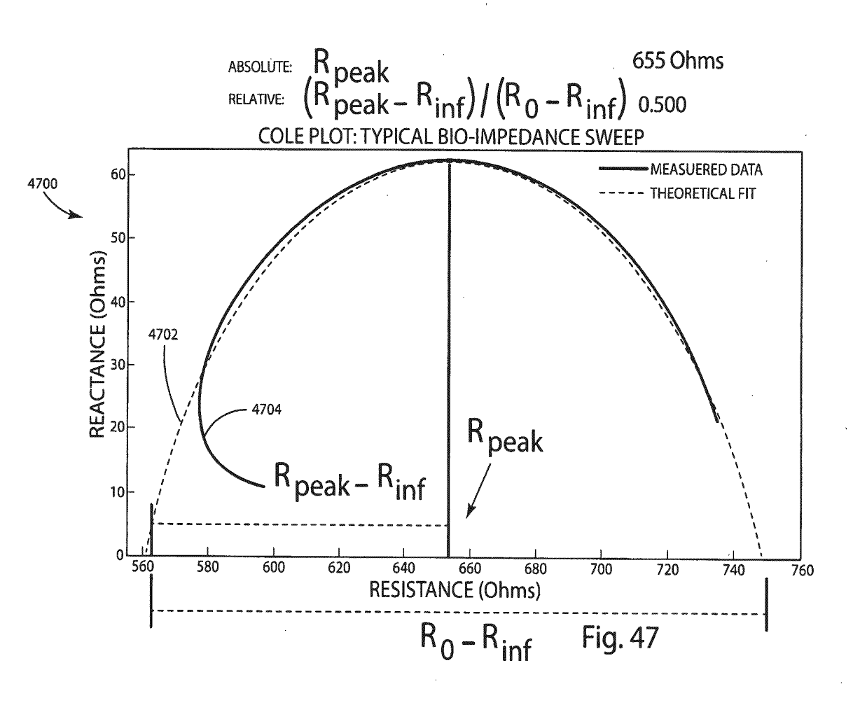

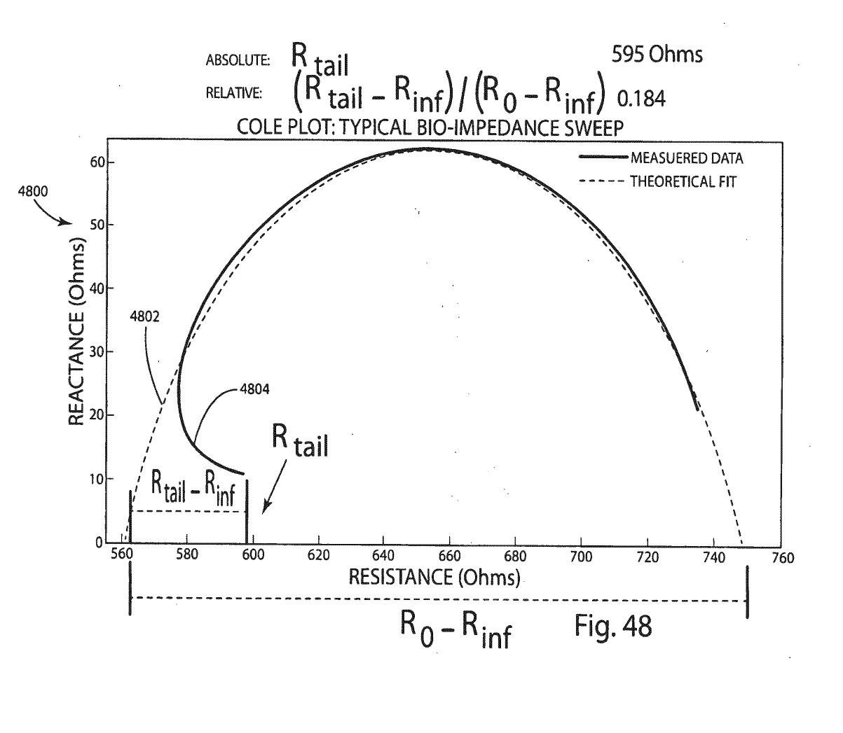

FIG. 45 shows a Cole plot 4500 of a typical bio-impedance sweep. Measured data 4502 can be compared against one or more theoretical fits 4504. The measured data sometimes is referred to as having a high frequency portion 4506 and a low frequency portion 4508. This plot illustrates how several potential bio-impedance curves may all have the same or similar intercepts even though the peak reactance may change. FIG. 46 shows another Cole plot 4600 of measured data 4604 and a theoretical fit 4602. This information can be used to calculate the ratio of max reactance to the difference in R₀ and R_{inf}. FIG. 47 shows yet another Cole plot 4700 of measured data 4704 and a theoretical fit curve 4702. This graph shows the calculation of the ratio of the high frequency portion of the curve to the low frequency portion of the curve. This ratio shows the tendency of the curve to “lean” to the left or right. FIG. 48 shows another Cole plot 4800 that includes measured data 4804 and a theoretical fit curve 4802. The graph shows the ratio of the high frequency tail to the total width of the curve.

For example, a heart rate measurement may be taken before or after a bio-impedance or bio-resonance measurement to provide additional information to the component about the current state of the user. For example, a high heart rate may be indicative of strenuous activity of the user and can be used as a tag along with the Bio-impedance measurement. This can be used to normalize the Bio-impedance data if each measurement is correlated to the position and state of the user. For example, all of the measurements taken while the user's heart rate is elevated can be grouped and analyzed apart from all measurements taken when the user's heart rate is low.

Additional sensors may include, for example, a hydration sensor or a three axis accelerometer worn by the user. These sensors may provide additional information to more accurately predict the bio-impedance reading, which lead to increased accuracy in determining Fat-Free Mass (FFM) and Fat Mass (FM). The majority of FFM is made up of a conductive water-electrolyte solution, in contrast to FM, which is mostly composed of lipids that are generally non-conductive. Therefore, FFM can be estimated based on total body water (TBW). User hydration level can affect the measurement of TBW even without a change in FFM or FM because hydration level affects the conductivity of the electrolyte solution.

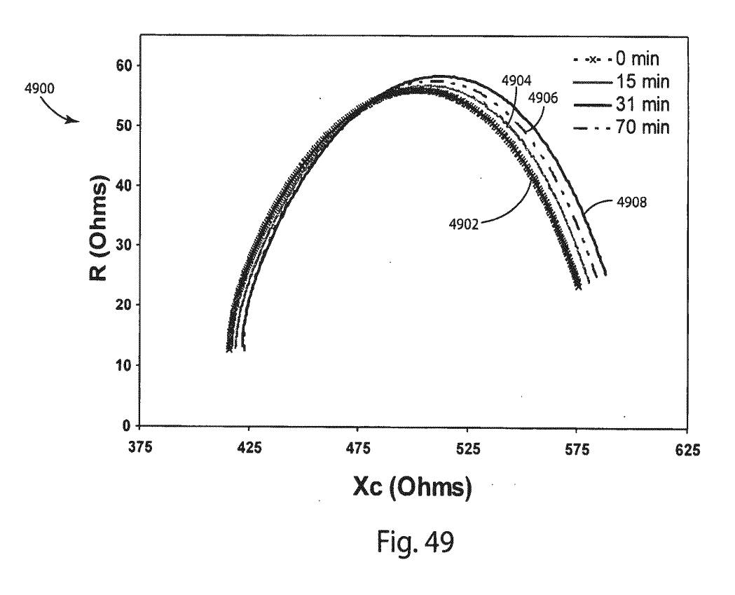

FIG. 49 shows a graph 4900 of the effect of hydration level on bio-impedance. The graph shows measured bio-impedance data for 0 min 4902, 15 min 4904, 31 min 4908, and 70 min 4906. This example illustrates the effect on bio-impedance over time after drinking 1 liter of water. It can be seen that the peak reactance goes up during the first 15 minutes, and eventually drops back down towards its original value over time.

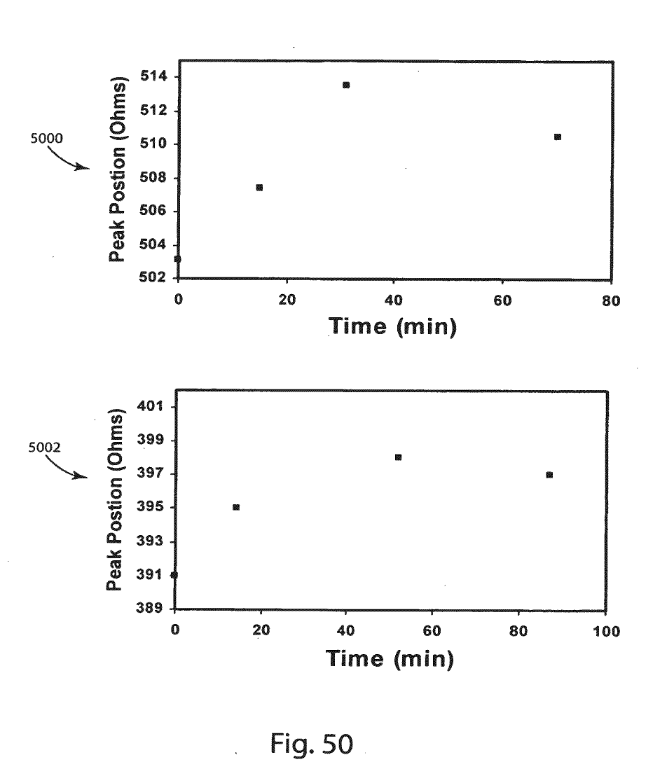

The same hydration level can affect the bio-impedance of two people differently. Specifically, FIG. 50 shows two graphs 5000, 50002 of two different people and variation in peak reactance over a period of 100 minutes after drinking 1 liter of water. It can be seen that in both cases, the peak reactance increases initially, and eventually begins to back towards its initial value, though the variation in time may be different for each individual.

By using a hydration sensor, the measurement of TBW can be normalized to a nominal value. The hydration level of a user can be determine by monitoring the liquid or by measuring hydration levels directly. For example, by measuring the presence of sweat, the component can estimate hydration levels, since as a user sweats, their hydration state is lowered, increasing the electrolyte concentration within the body and lowering the measured TBW.

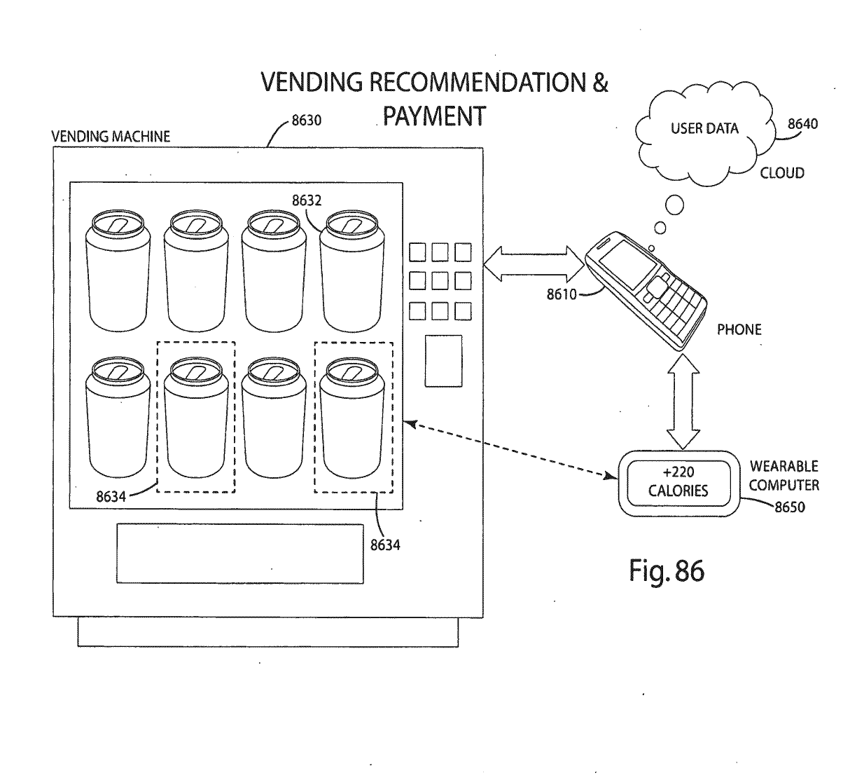

A fluid intake sensor may be utilized to track hydration level. In one embodiment, the fluid intake sensor may be a remote sensor located within a beverage container or dispenser may communicate the type and volume of liquid consumed by a user to predict the change in hydration. FIG. 86 shows an example of a water bottle, which is enabled to read the amount of liquid dispensed. This measurement may be transmitted to the personal device using a wireless communication protocol. This water bottle may also be identified when it is placed on a wireless power supply, where the wireless power supply is enabled to measure the liquid within the package. This wireless power supply can transmit data to the personal device, hub, smartphone or mobile computing device, or to the internet, or any combination thereof.

### V. Bio-Impedance and Bio-Resonance Measurement Intervals

As the device increases its sampling rate of data collection, the resolution of measurements for activity levels, body composition, location, and other physiological data can increase. Likewise, the more often the personal device communicates to the hub or to other remote sensors, the greater resolution of information. However, this can drain the battery of the personal device.

To increase battery life and decrease the required memory space of the personal device, a variable sampling rate may be used for data collection. FIG. 24 shows the determination of SMA and average position of a user. By measuring the average position, the personal device can determine if the user is generally performing a consistent action. For example, if a user is standing still, the average position will not change, reducing the need for a higher sampling rate. However, the user may be active but generally in the same position, such as running. The SMA provides a measurement of the activity level for an individual. As the user becomes more active, the sampling rate may be increased to record the movements of the user, especially if they are rapid. For example, jogging involves sudden movements and a slow sampling rate may not sufficiently capture the movements of the individual, even though the user is generally in the same position. To determine an appropriate sampling rate, the personal device may determine the relative or average position of the user, as shown in FIG. 24. By using the average position of the user, a simple method of determining sampling rate can be done without calculating the SMA of the user. Using this method, the personal device may use a higher sampling rate while the average position of the user is standing, a medium or lower sampling rate while the average position of the user is sitting, and the lowest sampling rate while the user's average position is lying down, or supine.

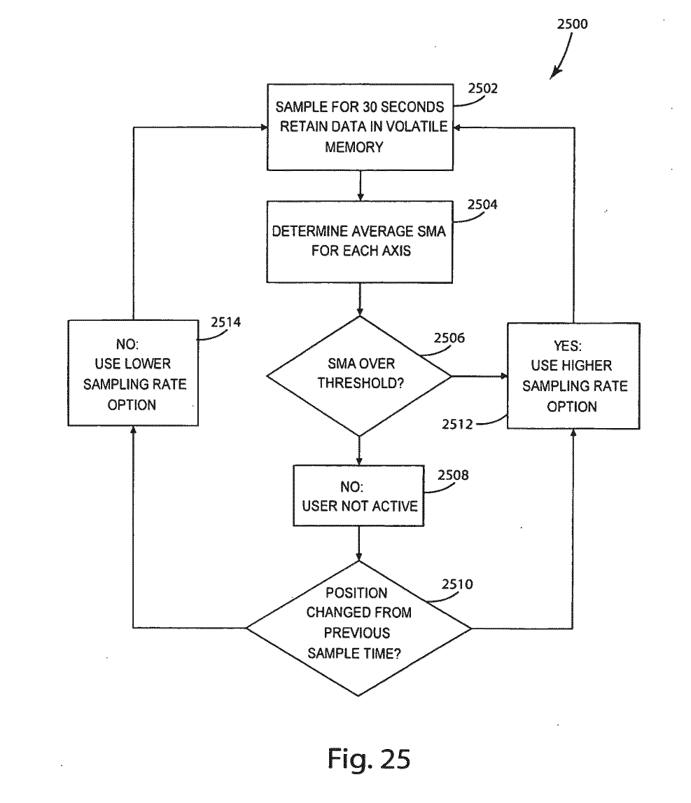

Alternatively, the personal device may use the method shown in FIG. 25. After a predetermined length of time—30 seconds in this embodiment—of sampling the accelerometer data (Step 2502), the personal device calculates the average position and the SMA (Step 2504). If the user is active, the SMA will also be higher. The sampling rate may have two options of high or low, or may have ranges defined by activity levels. For example, if the SMA is in a range of moderate activity such as walking, a moderate sampling rate may be used. If the SMA is in the range of high activity such as running or playing basketball, a higher sampling rate may be used. (Steps 2506, 2512.) However, if the SMA is low, the personal device can determine if the user is in the same position as before. (Steps 2506, 2508, 2510, 2514) If they are not, then the sampling rate may be maintained at the previous level or increased. (Step 2514.) This is done because if a user is not active but is changing positions—from sitting to standing to laying—it may be indicative of a user that may become active. To ensure that pertinent data is not missed, the sampling rate can be maintained or increased.

The average position of the user may be determined by taking averages of each of the columns to determine the force vector on the accelerometer during that portion of time. The location of the accelerometer is shown in FIG. 23 as generally being located on the hip or waistline of the user. If the user is standing, the force vector is considered to be vertical +/−30 degrees. This is determined by looking at the X and Y axis measurements to determine if the X-axis is generally positive and near its maximum value and the Y-axis is generally near its minimum. If the user is sitting, it can be seen in FIG. 23 that the 3-axis accelerometer is generally at an angle defined by the posture of the individual. As a user sits, the hips generally rotate at an angle between the legs which are horizontal and the torso which is more vertical. This force vector is generally considered to be between 30 and 60 degrees from vertical. When the user is lying down, the force vector is generally considered to be between 60 and 90 degrees from vertical.

To ensure that the 3-axis accelerometer is oriented according to the defined axis, the personal device may be constructed to clip to a belt or article of clothing to ensure that it is oriented in an expected manner. For example, in FIG. 6, the personal device may use a mechanical clip to attach the personal device to the users belt.

Alternatively, the personal device may be constructed to be worn on the wrist such as the embodiments shown in FIG. 7. In this configuration, the personal device may use the same settings for sitting and lying down to calculate energy expenditure or other measurement settings. If the personal device is constructed to be worn on the ankle or leg, the personal device may use the same settings for sitting and standing to calculate energy expenditure or other measurement settings.

The personal device may be constructed in a way that may be worn or attached to the user. The personal device may be calibrated to determine the vertical and horizontal axis. To do this, the personal device may prompt the user to stand, sit, and lay down and record each state using the gravitational force to define the vertical axis. In one embodiment, this determination can be made using a three axis accelerometer. The personal device may prompt the user for alternate actions such as jumping or walking to further calibrate.

For taking bio-impedance or bio-resonance measurements, the personal device may take measurements at standard intervals throughout the day at specified times to reduce variation in measurements due to hydration, activity levels, and body position. However, a person's daily schedule can be subject to fluctuations and may not be relied upon for standardizing measurements in some situations. To compensate, the personal device may use activity levels along with general time intervals to determine when to take a Bio-impedance measurement.

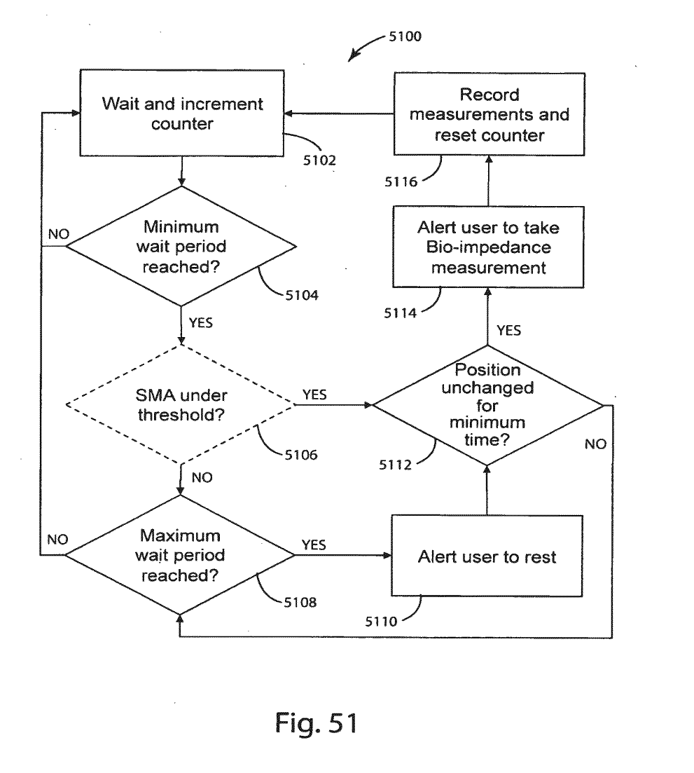

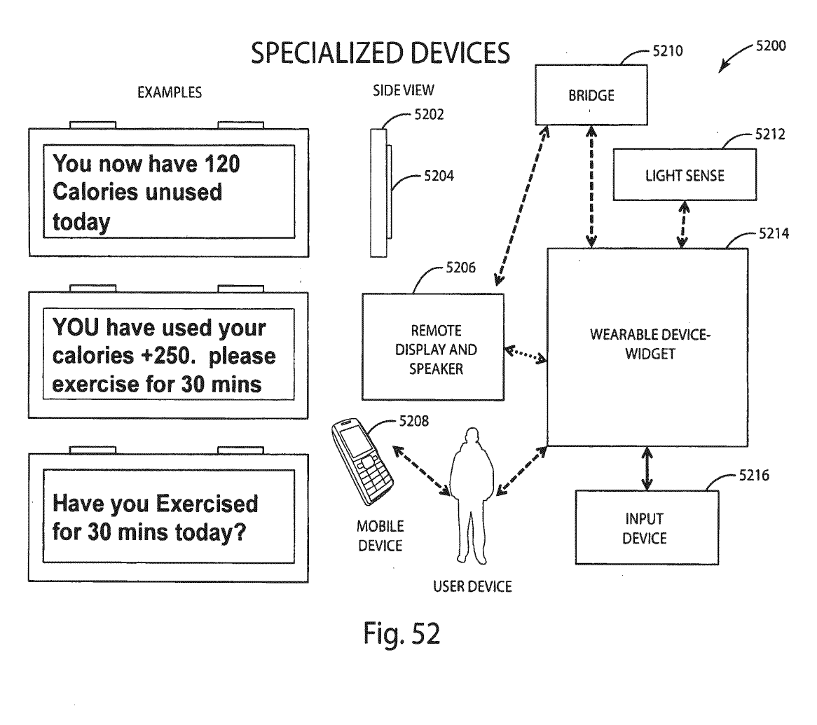

FIG. 51 shows one embodiment of a sequence for determining when to take a bio-impedance of bio-resonance measurement. Put differently, FIG. 51 shows one embodiment of a process for determining when to take a Bio-impedance measurement. A minimum sample time can be used to ensure that the personal device limits unnecessary measurements and wasted memory space. The process includes waiting and incrementing a counter 5102. Once the minimum wait period has been reached 5104, the personal device can analyze the activity level of the user to determine if the user is in a relaxed state by checking to see if the SMA is under a threshold value 5106. The personal device may alternatively, or in addition to, use the average position of the user to determine if the user is in a relaxed position. This relaxed state or position may be used to increase consistency of measurements. If the user is in a relaxed state and the user's position is unchanged for a minimum time 5112, the personal device can alert the user to complete a bio-impedance measurement 5114, for example by alerting the circuit to hold the exposed electrodes of the personal device as described above, allowing the personal device to perform a Bio-impedance measurement. This measurement can be recorded and the counter can be reset 5116. If the user is not in a relaxed state or position, the personal device can determine if the maximum allowable wait period has been reached 5108. If it has not, the personal device can continue to wait for the user to rest, or until the maximum allowable wait period has been reached 5102, 5104. Once the maximum allowable wait period has been reached, the personal device can alert the user 5110. This can be done using a visual indicator such as an LED or display, through an audible feedback like a speaker, through mechanical feedback such as a vibrating motor, or can send a prompt to an alternate component such as a smartphone, computer, or other display component such as a TV or remote display, such as the display shown in FIG. 52.

### VI. Reconfigurable Sensor—Additional Measurements

As discussed above, a bio-impedance measurement may be conducted on a user 5320 using bio-impedance measurement circuitry 5300 shown in FIG. 53. FIG. 53 shows the schematic diagram for a 4-wire bio-impedance measurement circuit that uses the bracelet construction described with respect to the personal device 5320, or any other design in which a user holds a component with both hands to complete the circuit. The bio-impedance circuitry in the illustrated embodiment includes a microcontroller 5302, a waveform generator 5304, a digital-to-analog converter 5306, an inverting unity amplifier 5308, a current sensor including a resistor 5312 and an amplifier 53100, an instrumentation amplifier 5314, a gain and phase detector 5316, and an analog-to-digital converter 5318. In operation, the bio-impedance measurement circuitry may be used to measure the real and imaginary impedance across the body, such as across the torso from one arm to another.

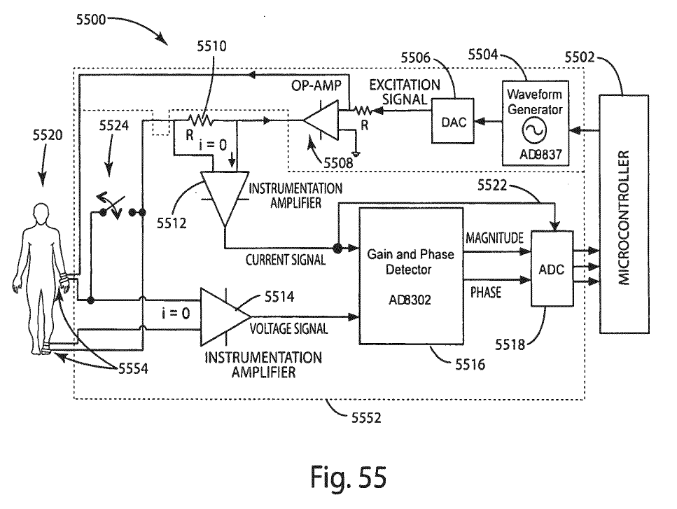

In one embodiment, bio-impedance measurement circuitry may be used to take bio-impedance measurements using electrodes and be reconfigurable to measure other biological factors, such as heart rate or skin resistance, using electrodes. FIG. 54, for example, shows bio-impedance measurement circuitry reconfigurable to take a heart rate measurement. In this embodiment, the measurement circuitry generally includes a microcontroller 5402, an excitation subcircuit 5450, a measuring subcircuit 5452 and two pair of sensors 5454 (e.g. electrodes). The excitation subcircuit generally includes a waveform generator 5404, a digital-to-analog converter 5406 and an op amp 5408 that are coupled to a first pair of sensors. The measuring subcircuit 5452 generally includes a current sensor 5410, 5412 (e.g. an op amp) coupled to the excitation subcircuit 5450, a voltage sensor 5414 (e.g. an op amp) coupled to a second pair of sensors, a gain and phase detector 5416 and an analog-to-digital converter 5418. The measuring subcircuit 5450 also includes a bypass subcircuit 5456 connecting the output of the voltage sensor 5414 directly to the analog-to-digital converter 5418. As another example, FIG. 55 shows a bio-impedance measurement circuitry reconfigurable to measure local resistance of the skin, which may be indicative of sweat. In this embodiment, the measurement circuitry generally includes a microcontroller 5502, an excitation subcircuit 5550, a measuring subcircuit 5552 and two pair of sensors 5554 (e.g. electrodes). The excitation subcircuit 5550 generally includes a waveform generator 5504, a digital-to-analog converter 5506 and an op amp 5508 that are coupled to a first pair of sensors. The measuring subcircuit 5552 generally includes a current sensor 5510, 5512 (e.g. an op amp) coupled to the excitation subcircuit 5550, a voltage sensor 5514 (e.g. an op amp) coupled to a second pair of sensors, a gain and phase detector 5516 and an analog-to-digital converter 5518. The measuring subcircuit 5552 also includes a bypass switch 5522 for selectively coupling the excitation circuit 5550 to one of the first pair of sensors and one of the second pair of sensors. The measuring circuit 5552 also includes a bypass subcircuit 5558 connecting the output of the current sensor 5510, 5512 directly to the analog-to-digital converter 5518.

Describing FIG. 54 in more detail, the bio-impedance measurement circuitry may be reconfigured to measure heart rate. The bio-impedance measurement circuitry may include an optional bypass line (or bypass subcircuit) that enables the microcontroller to directly measure voltage amplitude at the electrodes. In this embodiment, the stimulus signal for the bio-impedance measurement from the waveform generator is turned off. The voltage potential measured at the sensing electrodes through the bypass line is then converted to a digital measurement by the ADC and sent to the microcontroller. This enables the component to measure the voltage potential created by the electromechanical functions of the heart. This voltage potential is also shown in FIG. 54. The signal from the instrumentation amplifier may optionally be sent through an electrical filter circuit (not shown) to remove frequency components that do not contribute to the measurement of the heart signals and then sent to the ADC.

As discussed above, a heart rate measurement may be taken before or after a Bio-impedance or bio-resonance measurement to provide additional information to the component about the current state of the user. This additional information can be used to normalize the Bio-impedance data if each measurement is correlated to the position and state of the user.

In the illustrated embodiment of FIG. 55, the Bio-impedance and bio-resonance measurement circuit may be reconfigured to measure the local resistance of the skin between two electrodes. For example, an optional bypass switch can be used to reconfigure the circuit to measure a local resistance. In this embodiment, the switch is used to connect the sensing electrode near the first stimulus electrode. If the component is constructed as a bracelet worn on the wrist, the two electrodes on the inside of the bracelet that are always in contact with the forearm are used in this embodiment. By being in contact with the skin, the two electrodes enable a measuring the Electrodermal Response, or the resistance of the skin in a small area. If the bracelet is not in contact with the skin, the component may be able to alert the user that it is either not being worn, or is not able to take measurements of the user. Once the skin is in contact with the component, the component may also be able to determine the amount of sweat on the skin by measuring the resistance of the skin. As more sweat accumulates, the resistance decreases, which is sensed as an increase in the current through resistor R. The output of the instrumentation amplifier is then provided to the ADC to be converted to a digital measurement and provided to the microcontroller. As discussed above, by measuring the presence of sweat, the component can estimate hydration levels, since as a user sweats, their hydration state is lowered, increasing the electrolyte concentration within the body and lowering the measured TBW.

### VII. Behavior Modification

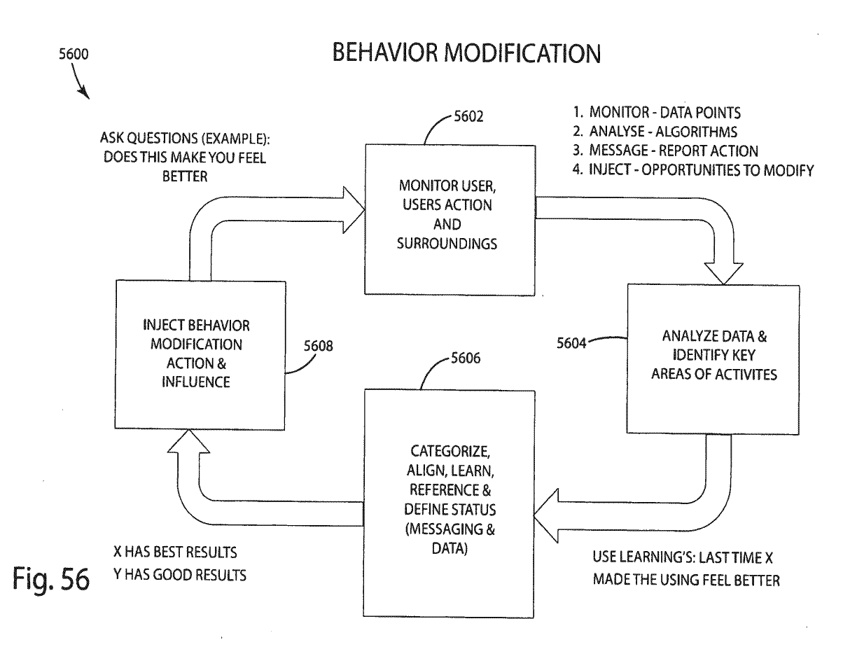

In one embodiment of the present invention, the behavior modification system includes a network of components that are able to take measurements of: a user's present physiological state, the user's actions and location, the environment around the user, the devices and objects around the user, and also has a user interface for the user to receive data and also input information into the system. This network of components can be enabled to wake one another up using RF signals or inductive power, or the wake up can be motion based. These components can provide fast information transfer and storage, and can even be connected to the internet so that data can be gathered and pushed to an online storage and tracking system. The components may be powered by energy storage elements such as batteries or can be directly powered from a wired or wireless connection to another device, and can use essentially any charging connection. The components can also sync data information—for example, when connected to a computer via USB, a wearable device may charge, but may also sync its data history to the computer. Additionally, this network may include a hub or set of hubs to download data to be shared amongst components and stored remotely in a cloud computing device, or remote server. This reduces the memory and processing power required by the networked components, making them smaller, less costly, and reduces their power consumption. FIG. 56 shows one example of a behavior modification method 5600 with a feedback and pattern learning cycle for behavior modification. The method 5600 includes the steps of minoring user actions and surroundings 5602, analyzing data and identifying key areas of activity 5604, categorizing, aligning, learning, referencing, and defining status 5606, and injecting behavior modification actions and influence 5608.

An example of one embodiment of the behavior modification system generally can be used to change the behavior of a user or the user's environment by providing recommendations, automatic updates, warnings, reminders, and progress information to a user. These pieces of information can also include a user's electronic calendar of appointments, electronic grocery lists, and data from external resources, such as a weather database. To assist in accomplishing the behavior modification, the system may make determinations based on the data the components gather, the information provided by the users, and the correlation of data to activities, moods, changes to a person's health, and diet.

This network of components includes devices that can be worn or carried by a user, or may be embedded in articles already worn or carried by the user. One example may include a wristwatch capable of taking skin measurements, heart rate, levels of dissolved oxygen, and temperature. Another example may be a pedometer that can be worn as a device on the belt of a user, or it may be embedded in the belt, shoe, or other article of clothing, and is capable of gathering the same information. These devices can also be applied directly to the skin of a user, or even implanted in the user. For example, a sticker or temporarily adhered flexible circuit may be applied to a user to measure the amount a user sweats for certain period of time. Another example is an implantable medical device such as a pacemaker or a blood sugar monitor that is capable of not only gathering biometric information, but also transmitting that data wirelessly along with being wirelessly charged. This charging could be through an inductively coupled system that not only charges but provides a secured data interface between the base and the device.

These devices may also communicate with one another to provide a constant (or near constant) stream of user data, and may also detect when one device has been removed from the network. In this instance, the system may determine that the location (based on a GPS signal) where the device was last detected may be an unacceptable location to be left behind, such as a restaurant or other public location.

Additionally, these components may be powered from one another either through wired connections or wireless connections. For example, devices in accordance with the present invention may be charged by the hub while transferring data to and from the hub. This wireless charging may be used to initiate the data connection, prompting the transfer of information. This device may also be capable of powering other devices or sensors as well. For example, this device may provide power to removable sensors worn on the body. These may include adhesive backed skin patches, RFID tags, pedometers, or other wearable sensors. These sensors may provide information back to the device including number of steps or distance walked, heart rate, perspiration, hydration, temperature, or any other type of biological data. This enables remote sensors to be used that are not enabled with a longer-range wireless data connection such as Bluetooth or WiFi.

This network may also include user interactive components. These components may be woken by a proximity signal from the device(s) being worn on the user such as the articles of clothing shown in FIG. 38. The components can also be woken by events, such as a timer-based event. If the component was woken from a movement or timer-based event, it may transmit a proximity signal to wake other devices being worn by the user. Once the devices establish a connection, information identifying who the user is, the users current status, and information that the remote device is collecting can be transferred. For example, a refrigerator's data transfer protocol may be woken up when the door is opened, which initiates a connection to the nearest user within a limited range. Once the user is identified, refrigerator or the device being worn by the user may prompt the user to identify which foods and in what quantities were taken. Alternatively, the refrigerator may be enabled to identify foods and quantities within the shelving units and containers held in the fridge. In such a case, the refrigerator may send information regarding what was taken to the device being worn or carried by the user.

Another example is a scale in a bathroom that can be woken by a user stepping on the scale. Alternatively, a device being worn or carried by the user may determine that the user should be stepping on the scale if it has been too long since last used. Once the scale and the device(s) being worn or carried by the user sync together, the scale may display the weight and will also transmit that data to the remote devices. If the scale detects devices being worn or carried by the user have sufficient weight to change the measurement taken, the scale may adjust the recorded weight by the estimated weight of said devices/articles of clothing. Additionally, this scale may be capable of measuring Fat Mass (FM) and Fat Free Mass (FFM) using Bio-impedance spectroscopy or bio-resonance (as described in more detail below). This data may be transmitted to a device where it is used to calibrate the on-board Bio-impedance or bio-resonance measuring circuit, may be used to calculate caloric intake as compared to energy expenditure, may be stored and later transferred to the hub to be analyzed by a remote computing device, or any combination thereof. Alternatively, this data may be transferred directly to the hub.

Another example is a television that is woken up with the remote control. Once woken, the television may synchronize with all of the users within a specified range. The antenna may also be made as a directional antenna so that users at a specified range in front are recognized, but users behind are not detected as easily. This prevents users in another room, but close to the location of the television, from being detected. Devices being worn by users watching TV may record the event, and the TV may periodically (or continuously) check to see which users are within range, in case some (or all) of the users leave the room but the television is left on.

These devices may use various user interface methods to interact with a user including a touch screen, button control interface, a microphone or set of microphones to obtain audio information, and a speaker, transducer, or any other type of audio output device, or LEDs indicating various states of the devices.

This system may also be enabled with location based sensors and long range network connections that interact with one another when the devices are within a certain distance from one another but out of range of their proximity based sensors and communication systems. For example, a device being carried by a user may be enabled with a GPS receiver to detect when the user enters a building, such as a hotel. Alternatively, the lobby of the building may be enabled with a proximity based system that detects the user entering the lobby. Once detected, the hotel's computer system may send a proximity based message, an SMS message, or an email to the user letting them know that (if they had previously booked a room) that their room was ready, their room number and location, and any instructions the user may require. The hotel computer system may then send a message through a communication network, such as a LAN network, to the door lock of user's reserved room. This lock may unlock once the signal is received, once the users device is in proximity to the door itself, or it may be enabled with an unlock code. If a code system is used, the device the user is carrying may receive the code from the hotel computer system and may provide a numerical code for the user to enter, or may provide a code that is then transmitted to the door lock through a proximity system once the device is near the door. For example, a cell phone may be enabled with a GPS system that alerts the hotel once a user has entered the hotel, and in response, the hotel computer system sends an unlock code to the cell phone. Once the user approaches the door of his/her room, the cell phone may be used as the key either using a proximity-based RF system, or can be used as an inductive interface or RFID/NFC device.

Another example may be a restaurant location that automatically downloads information, such as a menu, list of specials, or other information, to a user's phone once the user is in proximity to the restaurant's proximity sensor network. Alternatively, a user's phone may be equipped with a GPS receiver and may be configured to automatically communicate to the restaurant's computer system either directly through a proximity communication network or through an internet connection to download restaurant information.

This system of devices may also be enabled with a (set of) hubs or central devices capable of communicating to remote devices over several different wireless communication methods, such as Bluetooth, ZigBee, Wi-Fi, NFC/RFID, and a number of wired communication methods, such as an internet connection, USB, FireWire, LAN, X10, or other such communication topologies. This hub can connect to devices, download information from the devices, and transfer that information to a central data storage area either on a large memory storage device (such as a hard drive or desktop computer), or can be sent through the internet to a remote storage location or server.

This hub can also receive device updates, instructions, warnings, or event information that can be sent back to the remote devices so that they can be updated. Finally, this hub can send messages through a wired connection either through a local network connection or through an internet connection to control remote devices that the user does not wear or carry, such as a thermostat, television, lighting system, exercise machine, or any other non-mobile or semi-mobile device a user may interact with.

The system may track caloric intake directly or indirectly. It may track caloric intake directly by using any combination of methods. For example, a user's device may communicate to food packaging or home appliances to detect what foods in which quantities the user may be taking and eating, a user may take a picture of a meal and allow an image processor to determine the nutritional and caloric values, a user may take a picture of a receipt or product label, or a user may specifically enter a food and quantity into a survey or other user prompted data input (a program running on a cell phone for example). Other means of tracking caloric intake may include inventory management wherein a refrigerator, pantry shelf, or other inventory management hardware may determine the removal of products while in proximity to certain users. This may prompt a device being carried by the user such as the health monitoring device if the user did in fact remove said product. Alternatively, the system may determine without prompting the user that the said product was in fact consumed by the user. Additionally, appliances or computing devices managing recipes or an automated cooking setup may communicate with the device, bridge, or other networked communication protocol to provide nutritional information about the food being prepared.

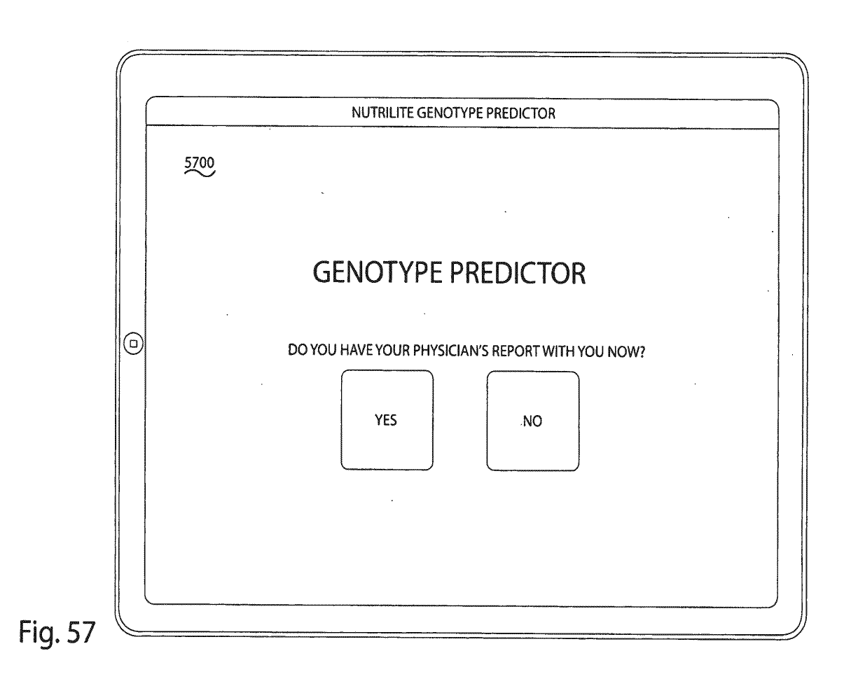

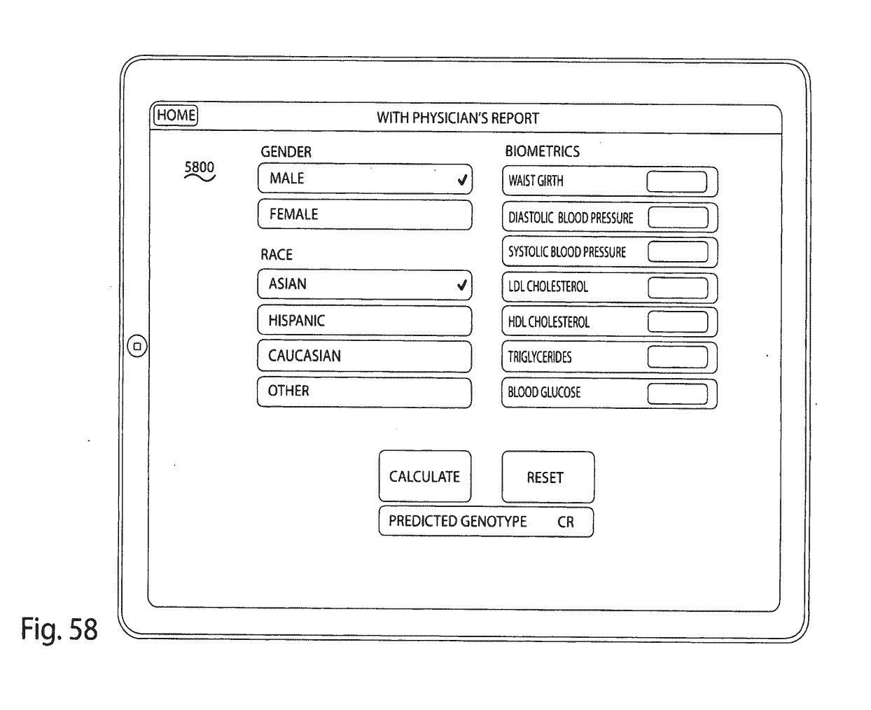

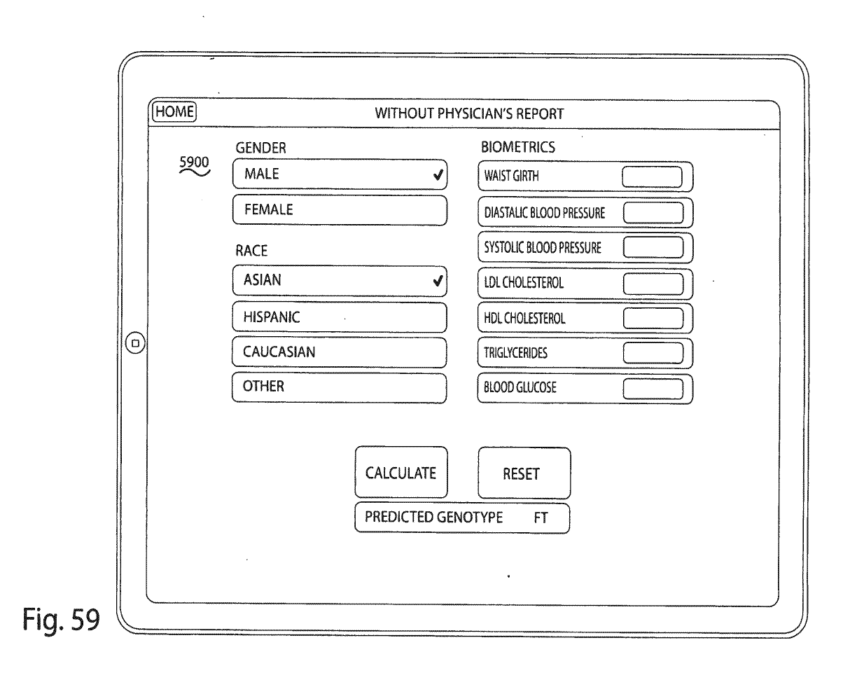

The system may also include input devices that can collect information directly from the user such as a computer, tablet, mobile phone, or other type of computing device. By prompting the user to enter information about himself or herself, the system may collect information about the user that may be difficult to directly measure. For example, information gathered from the survey shown in FIGS. 57-59 may be used to predict certain biological factors about a person based on some background medical information. The user may additionally provide information such as height, gender, age, race, and other personal information. FIG. 57 shows one possible input screen 5700 for a software application to collect additional data using genetic predispositions through test data and predefined test criteria. FIG. 58 shows one possible input screen 5800 for a software application that uses certain fields with a physician's report to get to a predicted genotype. FIG. 59 shows one possible input screen 5900 for a software application that uses certain fields without a physician's report to get to a predicted genotype.

A. Event Packeting

In order for the behavior modification system to track the information received from the components, the system may generate event logs.

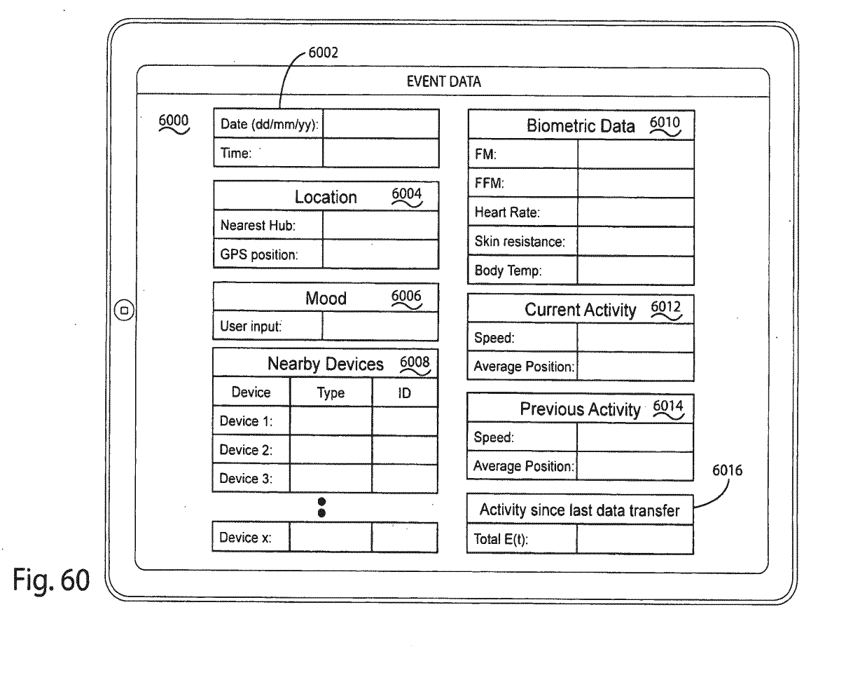

FIG. 60 shows an example log entry of an event 6000. Specifically, the event data shows how data may be collected by the network of components to create event based packets. These event packets may include biometric data 6010 such as FM, FFM, heart rate, skin resistance (sweat), body temp, blood pressure, cholesterol, or any other types of measureable biological data. Event packets also may include the current activity 6012 levels of the user such as SMA, average or current position, or other accelerometer based measurements. The location 6004 of the user may be determined by a GPS signal or from information received from a nearby hub. For example, a hub may transmit a mailing address and room information that can be recorded by the component. Additionally, the packet may include the total energy expenditure since the previous data packet 6016. The packet may include current activity 6012, previous activity 6014, and mood 6006. The packet may also include a list of nearby devices 6008. This may be represented as a sum of SMA, E(t), or other measure of total energy expenditure. For each packet, some pieces of information may be missing for various reasons. These blanks can be ignored by the system. Each packet may be tagged with a date and time 6002.

The personal device can also build a list of nearby components including their identification, type, and optionally their current status or location. These components may be other personal devices worn either by the same user, or remote sensors worn by the same user, sensors worn by the user such as those shown in FIGS. 35, 33, and 34. Additionally, these nearby components may be sensors or personal devices worn by another user that is nearby. These components may be remote sensors or identification devices that provide information to the personal devices such as a thermostat that communicates room temperature, a piece of exercise equipment that communicates a type of activity, or a scale that communicates a weight measurement.

The packet may include a tag from a user indicating their mood, stress level, energy level, or other types of emotion or physiological information. These tags can be stored along with the current status of the user for further analysis. This information may be input into the personal device using a touchscreen, button interface, or other type of user interface. Alternatively, the user may enter information into a networked component such as a cell phone or personal computer. This entry can be routed back to the hub, personal device, or server based analysis tool to be combined with additional event data.

These packets may be collected and stored on the personal device, where each piece of information can be recorded by the personal device. Alternatively, the personal device may measure some of the values, and may collect some of the other values by communicating with other remote sensors or with the hub. The hub may also collect and store information either in addition to or instead of the personal device. By collecting information on the hub, data may be processed by the hub or by internet connected components such as personal computers, cell phones, or server based computing devices.

B. Data Transfer

The transfer of information between a component and its surrounding may be triggered through many different ways. Some triggers may include a maximum time requirement for a physical measurement, change in location or activity, a tagged input from the user such as their mood or emotion, or an RF wakeup pulse from a hub or other component.

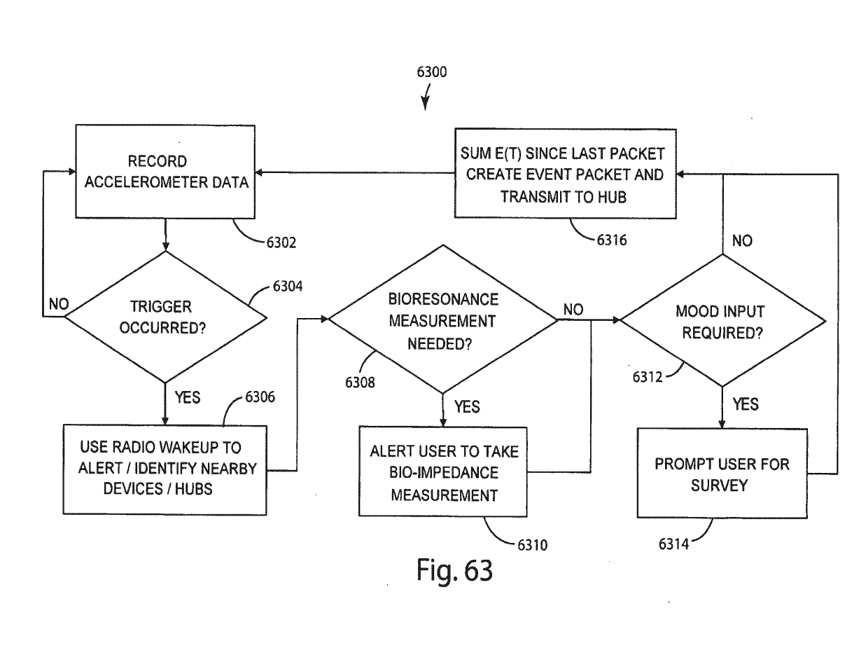

When the personal device is triggered to record an event packet, it may proceed according to the method 6300 shown in the flow diagram of FIG. 63, which includes a sequence for recording events. In the illustrated method, the behavior modification component can record accelerometer data 6302, check to see if a trigger occurs 6304 and determine the nearby components or hubs that may be in proximity to the personal device using a radio wakeup 6306. Once these components are identified, the necessary or available data can be transferred between the components. The personal device may then determine if a Bio-impedance and bio-resonance measurement is desired 6308 and alert the user 6310. The personal device may determine if a user input is desired, such as a mood 6312 or emotional survey 6314 response or other type of information. Once this data is gathered, the personal device may transfer the data to the hub or other internet connected component 6316. Alternatively, the personal device may be configured to store recorded packets within non-volatile memory, or may store packets if there are no hubs or internet connected components within proximity, to be transferred to a hub or internet connected component once one comes within proximity of the personal device.

The triggers may be many different types of events. For example, if the user suddenly changes their activity level or average position, the personal device may record an event packet to note the change from one state to another. Alternatively, the personal device may be triggered from a time-out warning for a Bio-impedance and bio-resonance measurement, heart rate measurement, or other type of physical measurement. Additionally, a component may be triggered by an RF wakeup signal, which can result in the successful identification of a hub or other component. When a wakeup signal is detected along with the identification of a hub or other component, the personal device may determine that the user has changed locations based on identification of new hubs, or may have changed activities based on new components within proximity or previous components no longer being within proximity.

For each trigger, the personal device may prompt the user for an input response to indicate mood, emotion, or other data that may not be able to be determined from the components within proximity. For example, the personal device may not be within range of any hubs capable of indicating location. In this circumstance, the personal device may prompt the user to enter a location to be included in the data packet.

C. Behavior Identification

By tagging as many of these event packets with a mood or emotion tag, the system may begin to associate the event packets with behaviors and activities. Additionally, the system can analyze the current and previous states to determine the top causal relationships for certain moods or emotions. This data may be analyzed after event packets are collected, or it may be included within each event packet, where the current and previous activity, location, and connected components may be recorded. By understanding the top causes of changes in mood or emotion, the system can begin to predict changes in mood or emotion based on the identified patterns.

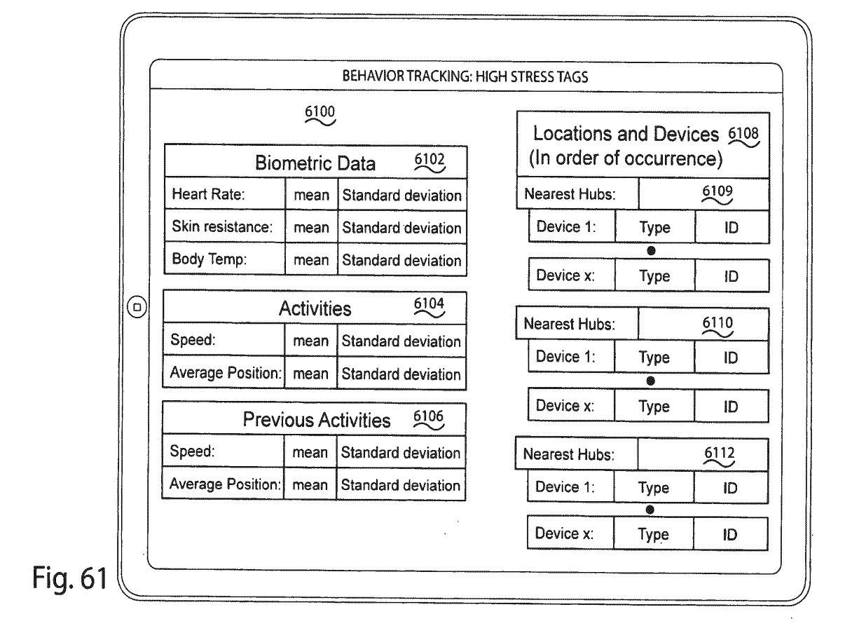

FIG. 61 shows an analysis log for mood, behavior, or both that can be used in connection with a behavior modification method. For example, the method may include an analysis of the high stress tags entered by the user 6100. The system may identify the typical levels of activity for both the state of stress 6104 as well as any state that may have preceded the indication of stress 6106. Typical measurements of biometric data 6102 such as heart rate, perspiration, and body temp for high stress tags can be included as well. A list of top locations and the components associated with the locations can also be made 6108-6112. Alternatively, lists of the most common locations and most common components may be done separately. By identifying patterns, the system may analyze the user's current and previous state to determine if and when a user is likely to become stressed once again.

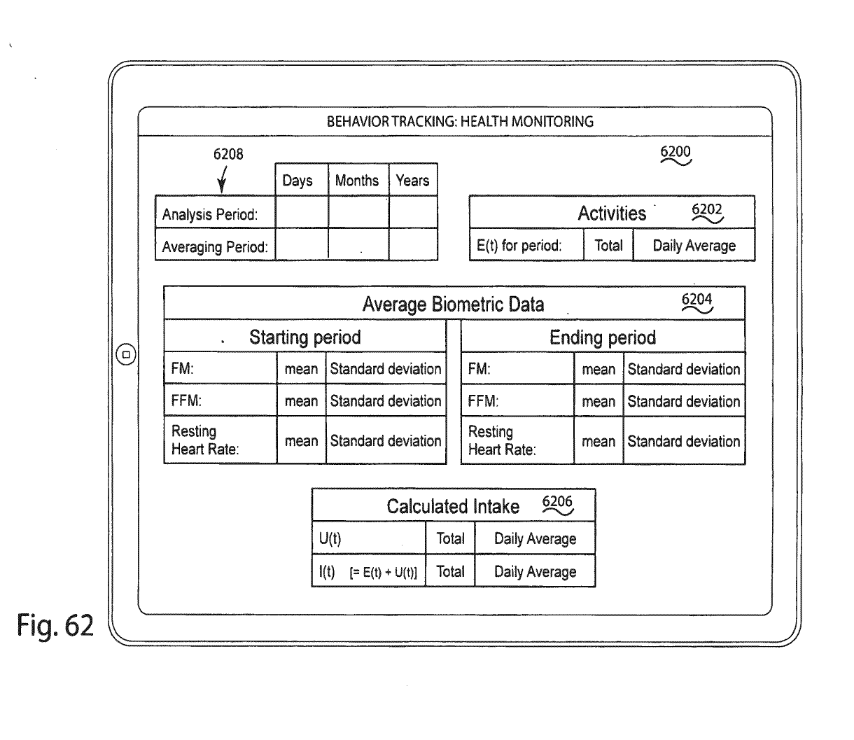

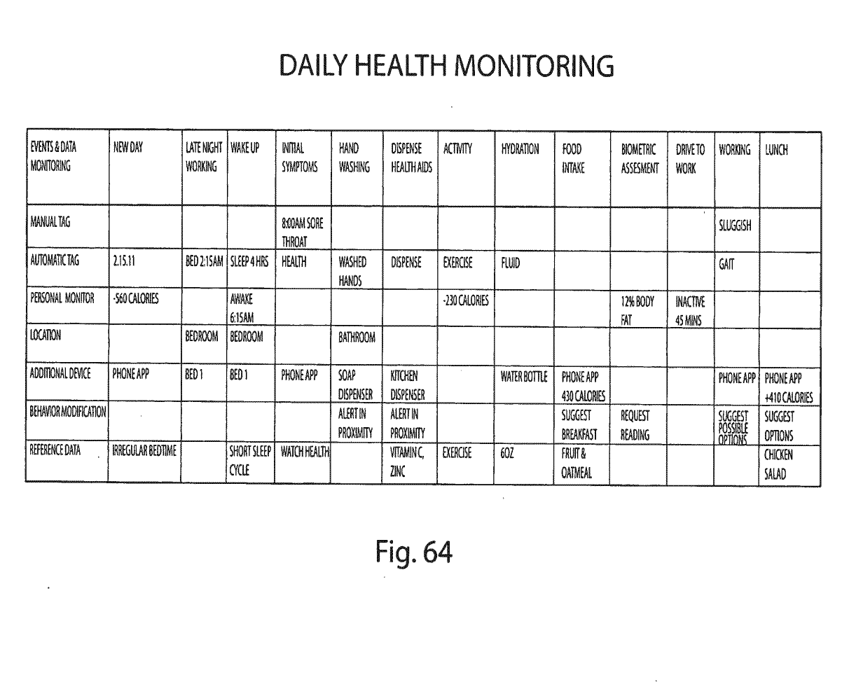

FIG. 62 shows an exemplary analysis log 6200 for a health monitoring system that may analyze data over a period of time. By calculating the body composition for a start and end period of time 6204 as well as the total energy expenditure over the same period of time 6202, the system may calculate the caloric intake of a user 6206. The system may optionally take the average starting and ending body composition 6208 for a smaller subset of time than the total analysis length. For example, the system may analyze the caloric intake of a user over the period of a month, where the starting and ending body composition measurements are averaged over the first week and the fourth week of the analysis. FIG. 64 shows a daily health log example. The health log may include manual and automatic tags. Each component may contribute to the stream of data tracking events. Also shown is a caloric table vs. weight and speed for reference when calculating caloric expenditure.

Behaviors can be identified by combining actions, locations, biometric data, and components that a user is interacting with, and detecting patterns. These behaviors can be simple, like how a driver behaves while driving their normal route to work, or can be complex, like how a user interacts with other people in a work or home environment. When behaviors are identified, the data processor can begin linking behaviors together to form a lifestyle based on net caloric intake, stress factors, and relationships within a user's life. The psychological effects of such a lifestyle can be measured by number and type of user tags, the number of positive relationships, and can also appear in the physical effects. The physical effects of such a lifestyle can be measured by tracking a user's weight, blood pressure, sleeping habits, and activity levels.

Once these behaviors and lifestyles are identified, the data processing unit (either on a mobile computer such as a laptop, cell phone, or tablet, or on a central data processing machine such as a desktop computer or internet server, or on essentially any other component) can start to recommend changes in activities and nutrition to begin to modify a user's behavior and ultimately their lifestyle. These recommendations are made based on a target behavior or set of target behaviors with a desired outcome. For example, if a user wants to lose weight, the program can recommend different eating habits by suggesting different restaurants, different recipes at home, or supplements to try and improve a user's metabolism. The recipes used may automatically upload items to a user's shopping list for their next trip to the store, or may be automatically ordered if a user prefers to set up an automatic system with limits for price and quantity. The supplements may automatically be dispensed by a pill or liquid dispenser in the quantities needed by the user. The program may also recommend changes in levels of activity by giving suggestions for activities that would fit the user's lifestyle in terms of length of activity, level of exertion, and type of workout (muscle building vs. cardio vs. just walking). These activities may be targeted to simply burn more calories than a user normally burns, or they may be activities to prevent a user from eating at a time he or she would normally eat something unhealthy. Over time, the system can track the user's progress against set goals, and can make adjustments. For example, adjustments can be made if the progress is not meeting the set goals.

The goals for the behavior modification may be entered by the user, by a physician or doctor, can be suggested by the program if the program detects bad or potentially dangerous habits or lifestyles in the user, or can be uploaded from a set list of suggested goals, or a combination thereof. Once the goals are established, the system may use a set formula for determining the behaviors that require modifying and how it suggests such changes, or the system may use a subset of possible changes, begin suggesting them, and adjust the suggestions based on how well they worked. For example, a person struggling with hypertension may have goals entered by a physician, targeting a specific weight, blood pressure, and sodium intake levels. The system can make recommendations to avoid foods high in sodium and fat, provide activities that are aerobic but at a low exertion level to prevent high blood pressure during exercising, and suggestions for people to be around, to avoid, or to improve a relationship with. If the user does not respond to messages about which foods to avoid by either continuing to eat them or if their body simply does not respond by removing certain foods from a diet, the system can alter its suggestions by giving other options of food that a user may enjoy.

Another example is a person who wants to train for a marathon. The user can select a race date and distance, and the system can provide recommended activities, nutritional supplements, and a workout plan to help the user reach his or her targets. The system may also provide warnings to users that perhaps are unfit to train for a certain goal in a short timeframe, and may suggest an alternative goal (perhaps a shorter race at a more distant date).

The system can also be configured to track the progress of a user against a set goal. For example, a user may set a target weight and use data gathered to track not only the current progress of a user against his or her targets, but also look at the reasons why he or she is making the progress they are making.

The system may also suggest changes to a person's schedule. The schedule changes may be suggested to change the time of day when they interact with certain individuals, avoid traffic delays or other activities that create stress. For example, the system may suggest a workout in the morning instead of in the evening if the person is having trouble waking up in the morning.

The system may also change settings or operating conditions for components within the system to aid the user in reaching his or her goals—for example, for just living a more comfortable life. For instance, the personal device may detect elevated body temperatures and levels of movement while the user is trying to sleep, and may decide that the ambient temperature is set too high. Rather than suggesting that the user change the temperature, the system can automatically adjust the room temperature until the user is comfortable. For example, the temperature may be automatically adjusted until measurements on the user's personal device indicate the user is comfortable, such as when the user's temperature reaches a threshold or when the user's activity level returns to normal. The comfort level of the user can be preprogrammed by the system or set based on the user's input. This change can also be recorded and repeated over time to ensure a consistent sleeping pattern for the user, and may determine that the user should be made aware of the change once he or she wakes up. The program may also automatically update components within the network with new settings as the user's behavior changes. For example, as a user improves his or her cardiovascular strength, their walking pace may increase in speed, along with their running pace. The system may choose to update the motion sensors in the network with new values to determine whether the user is walking or running.

The system may also provide up to date information to the user in an effort to modify behavior. For example, when a user walks up to a vending machine, the system may provide an up-to-date calorie count for the day, with an estimate as to how far over or under the user will be for the day or week. Alternatively, the system may prompt the user with an event reminder to try and change the user's current actions. For example, the program may remind a user that they have an early morning meeting the following day, and need to turn off the TV and go to bed. Another example is when a user sits down to eat lunch, and the system may remind the user that they are going to be at a dinner meeting later, and that they should probably not eat as large of a lunch.

In addition to providing recommendations to a user, the system may provide the user with access to data and other types of information collected, calculated or otherwise obtained by the system. For example, the system may provide the user with data collected by system-enabled components. The data may relate to specific activities or combinations of activities. As another example, the system may provide the user with result tracking data and efficacy information. The data and information made available to a user may be limited to that user's data and information, or it may include data and information for other users. If it includes data and information from other users, the data and information of other users may be made anonymous.

The system recommendations may include product and service recommendations based on data and information collected through the system. For example, the system may allow tailored product advertising. The system may identify potential product recommendations for a user by evaluating the data and information collected from that user. The data and information may suggest that the user might have an interest in a specific product. As a few examples, the locations frequented by a user, the types of activities of the user and the consumption habits of a user may alone or in combination allow the system to determine products or services of potential interest to a user.

The system can also be used to train animals. In one embodiment, a device for training animals is provided that is similar to the personal device describe herein. The device can be embedded in a collar to track a pet's activity and location relative to other remote components in the house and can be used to track the pet's status. For example, the device may use proximity communications to detect when the pet is near its food dish, and can alert the owner within a short time frame that the pet may need to go to the bathroom. The system can also time how long it has been since the pet last went to the bathroom, and again alert the owner, or perhaps open a pet door to let the pet into the yard. The device can also determine how far the pet has gone from the house, and if equipped with a GPS based location system, the pet can be tracked. If the pet wanders too far, a correction tone or voltage stimulation may be used to correct the pet.

### VIII. Interactions

The system of components described in the embodiments above can also use proximity based interactions with other individuals or pets to understand how the interactions between these people and animals affect the users. For example, the personal device, sometimes referred to as a widget, being worn by users can use proximity-based sensing to determine the users within a room, and which other types of components are present. If a number of people are gathered in a conference room with few other components around, the system can categorize the gathering as a type of meeting. The biological sensors may be able to detect levels of stress based on audio analysis, heart/respiration/perspiration rates, and other biological responses. These interactions can be tracked over time to determine who in your list of relationships causes stress, causes you to relax, and causes other reactions based on these interpersonal interactions.

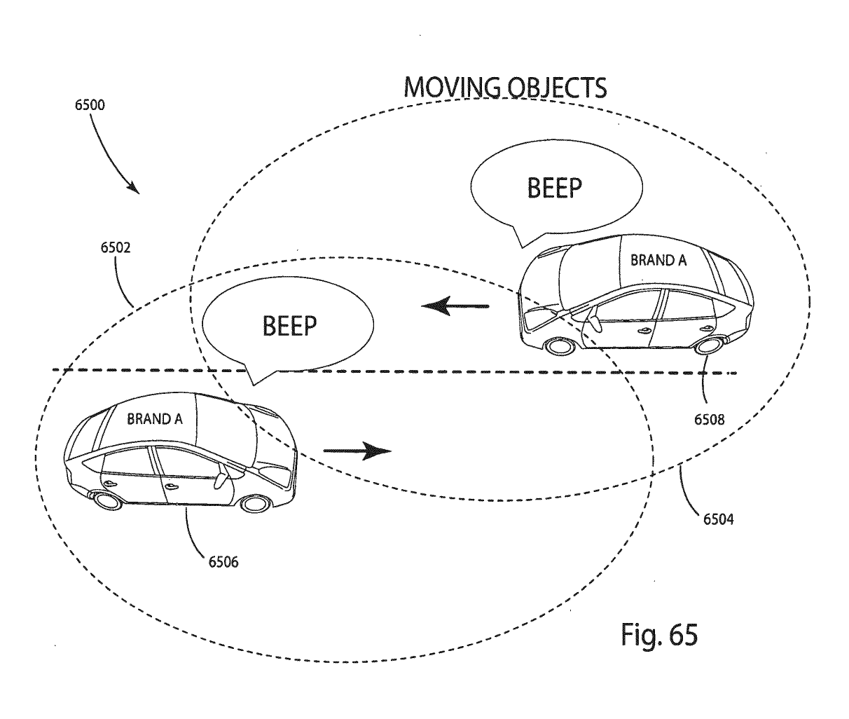

Additionally, components may determine the proximity of other similar components and produce a response. For example, two vehicles 6506, 6508 passing each other, such as those shown in the FIG. 65 diagram 6500, may detect one another and automatically honk the horn or flash the lights at one another. An interaction area 6506, 6508 around each car is shown. Where the interaction zones overlap, the brands may recognize one another and the system may take an appropriate action. This type of interaction can be used to accomplish a form of automatic brand recognition. FIG. 65 shows one example of how the proximity wake up system described herein can be used for brand to brand interactions for modification of market and social behaviors. Presently, the owners of certain brands wave or indicate a social response when they see another owner of that brand. The present invention enables a more vivid interaction by enhancing that identification and interaction experience.

Another example is tracking the effectiveness of exercising with other individuals or pets to determine which method best fits the needs of the user. It could be that when a user is exercising to relax himself/herself, the best method is to exercise alone. However, when they are feeling tired or sluggish, it may be best to exercise with their friends to push them harder or encourage them to exercise longer. It could also be that a pet with a collar enabled with a component can be detected by the user's personal device when they are running, and can determine if exercising with a pet is more or less effective base on speed, duration, or caloric output and weighing them against the desired workout type. The system can make a recommendation to the user based on this determination to encourage or discourage particular activities.

Pet training can also be done by monitoring pet activities and correlating them with desired or undesired events and activities. For example, a pet may be more active on the days when the owner is not around and the pet sleeps more during the day. On those days, the pet may be more likely to be destructive or ill-behaved, causing stress for the user.

Behaviors involving interactions with others can also be modified using in the behavior modification system. The moods of the user along with the user's circle of people they commonly interact with can be tracked and users can be given updates or warnings if the system detects that the user is about to interact with another person that is in a bad mood, that the user commonly causes stress to, or that someone they know is feeling down. The system can suggest actions for upcoming interactions such as a compliment to diffuse a potentially tense situation, a reminder that it is some one's birthday and they feel tired or down, or a suggestion to buy flowers for a spouse if they have had a rough day and you are on your way home.

The system can also suggest activities and interactions based on where a user is and what their needs or goals may be. For example, if two users have not burned enough calories for the week and they both enjoy similar activities, the system may suggest that the two users get together for a game. The system can even check the calendars of the two users, suggest a time that works best, and automatically make an online reservation for a restaurant, tee time, or any other type of reservation. Another example may be a user walking home from work may pass a restaurant or bar, and the personal device may detect a number of people either in the user's normal network of interactions, or a number of people matching the user's usual type of interactions, or people matching the user's desired interactions. The personal device can provide a text message or other alert as to who may be in the restaurant, can automatically download the menu as the user walks in, can send a message alerting the restaurant or bar of their typical order, and can even set up a secure payment system with the personal device the user is carrying or wearing.

### IX. Data Gathering and Processing

In one embodiment of the present invention, the behavior modification system, sometimes referred to generally as a network, may gather data from components within the system. This gathered data may be used to obtain information about the user or the user's environment. For example, one or more sensors within the network may gather information relating the user's activity, audio levels, and biological data. This data may be combined or aggregated to understand the user's actions, mood, and track physical health and status over time. The data may also be combined with user information input.

Sensors can be worn or carried by a user (for example, a wrist-worn sensor device), embedded in an article of clothing or device worn or carried by a user (for example, sensors embedded in a shoe or used in a cell phone), implanted in or ingested by a user (for example, a sensor device placed in a capsule to be swallowed by a user), or even applied directly to the body of a user (for example, a sticker or temporary tattoo). The data gathered by the sensor network may be gathered and shared by processing unit of the system, which can organize the data.

Biometric data gathered by the sensor network may combined to indicate levels of stress, tension, or biophysical state by measuring skin salinity (perspiration and content of the perspiration), heart rate, respiration rate (either by measuring breathing motions or my measuring dissolved oxygen levels in the bloodstream), and body temperature, along with other known biometric sensors.

Another example is the detection of stress or activity based on respiration rate. When a user is breathing long slow breaths (detected either through motion sensor located around the chest cavity, or by measuring dissolved oxygen levels), the network can detect that a user is at a more relaxed or calm state, indicating that a user may be sitting comfortably or even sleeping. If a user is drawing deep breaths at a faster pace, the user may be more active or at an increases state of stress or anger. When the breaths become very short and not very deep, it may indicate that a user is at a high level of stress, is nervous, or perhaps is active but running short of breath.

The components within the system may gather data, analyze the data, and categorize activity patterns for use with the behavior modification system. For example, the sensor network may also use accelerometers or other motion sensors to more directly measure activity level and type of activity. These sensors may be a single stand-alone sensor such as a pedometer, or can be a combination of sensors sharing data with one another, a central hub, or another component within the behavior modification system. This network of sensors can detect activity levels by measuring the amount of motion. For example, accelerometers located in a phone or embedded in a shoe can detect elevated levels of motion when the user is running as opposed to walking. By using several sensors located at various parts of the body, such as the feet, wrists, arms, or chest, the motion of each area of the body can be measured and compared to one another to detect the activity type. For example, when a user is running a distance run, the motion of each sensor may be rhythmic and relatively at the same level as one another, since the entire body is moving forward at a near constant rate. As another example, when the user is playing basketball or another type of sport involving numerous twists, bursts of speed, or motions that involve one part of the body and not another, the sensors can detect varying amounts of motion over time, and at a rate different to one another. Still another example is when a user is asleep, the network of motion sensors may be able to detect when a user is less comfortable based on how much a user is moving around, or may be able to detect which sleep phase a user may be in.

The sensor network may also gather environmental information to share within the network. Data such as temperature, audio level, ambient audio level, light level, ambient light level, presence of allergens or pollutants, and other known environmental sensors can be used to understand the environment a user may be in. For example, a microphone on a cell phone may be activated periodically to measure ambient audio levels as well as the general frequencies of the ambient audio. For example, a component can detect large amounts of speech in a busy conference room or waiting area by sensing elevated audio levels in the range of human speech frequencies (90 Hz to 500 Hz), or a manufacturing environment with extremely elevated audio levels and lower frequency components (below 100 Hz), or a concert with elevated audio levels at higher frequencies (above 1 kHz). By using more advanced speech recognition technology, stress levels within human speech may also be detected.

Additional input from the user in the form of surveys, periodic questions, or other forms of user entered events can also be recorded for further analysis by the system. For example, a user may periodically be prompted by a component to input information about how they are feeling both physically and emotionally, or a user may determine on their own to tag certain events with specific information. For example, a user may input information to their personal device about which TV show they watch when they turn the TV on so that additional data can be correlated with that event. Alternatively, a user may prompt a delay of certain events by giving specific information. An example of this is when a user removes food from the refrigerator, the user may tag the event by saying that the food removed will be consumed at a later time, or by multiple users, or both. A user may also be able to prompt surveys themselves by tagging a meal or event and answering questions about that meal or event. A user may also be able to record information about an event for the network to process. For example, a user may take a picture of a meal, tag the event as their own meal at a certain time/place, and the system can process the image to determine caloric and nutritional information about the meal. That data may be correlated to other time-relevant data about the user and the user's environment.

The system may also include a knowledge database or an expert system capable of providing recommendations based in part on feedback to select questions from the user. For example, the user may indicate that she has a headache and the system may begin to ask questions that may assist in determining the cause of the headache and providing one or more potential solutions. Expert systems for various categories of interaction may be incorporated into the system. For example, a medical expert system, such as WebMD, may be incorporated into the present invention and may be used to determine appropriate questions to ask the user, to analyze the user responses and make appropriate recommendations to the user. The present invention may generate recommendations based on user feedback from the expert system queries in combination with other information collected by system-enabled components, such as activity data and biometric data collected by the system. Hybrid recommendations of this type may provide better results than recommendations based on only one type of input.

A survey may be used to determine how a user is predisposed to respond to certain events both in a physical and emotional way. This survey may include information about health information, such as height or weight from the user, or can automatically pull in information gathered during a health physical from a physician. It may also include relationship information about the user, such as current job status, marital status, history of mental health, and other such information. The information collected in the survey may vary from application to application to collect essentially any information that might conceivably be relevant to operation of the system.

In one embodiment, the system may be configured to solicit user feedback on the efficacy of system recommendations. For example, the system may ask the user to provide feedback on how successful a particular recommendation was in addressing an issue. As another example, the system may ask the user to provide feedback on the relative effectiveness of different recommendations, such as the relative effectiveness of two alternative recommendations previously made by the system. The system can use this user feedback in formulating future recommendations for that user and for other users. The questions presented to a user by the system may extend beyond subject matter relevant to user recommendations. For example, the system may present essentially any type of question that might benefit from consideration by a user or a large pool of users, such as questions concerning a user's impression of a new marketing concept or a potential new product. If desired, these types of questions may be intermixed with user feedback questions or question presented by an expert system or knowledge database.

In one embodiment, the system may be capable of providing different recommendations to different groups of users so that, among other things, the efficacy of different recommendations can be assessed. The system may create two or more groups and provide each group with a different recommendation or different set of recommendations. The system may implement a control group and may provide with a placebo recommendation.

The data from the arrays of biological, environmental, and motion sensors may be combined with location based information, data shared between remote devices and components located around the user, and information directly input from the user to detect a user's mood. A user's activity level, location, and the identification of surrounding components provides data as to what type of activity a user is most likely doing. By determining the mood of the user for given points in time, the network can begin to identify trends and habits. For example, if a user has an elevated heart rate and perspiration along without a large amount of activity, it can be determined that the user has an elevated excitement level due to stress, nervousness, anxiousness, or other elevated states of anxiety. If the system then detects the television being turned on and the accelerometers detect that the user has sat down, the user is most likely now watching TV. Now if the user's heart rate and skin salinity become reduced, the system can determine that this action relaxes the user. The system may additionally prompt the user to input information at that time about the person's current mood to verify, or calibrate, the prediction algorithm. However, if the heart rate and skin salinity stay elevated, the system can determine that this action does not in fact improve the user's level of stress.

When location, activity levels, and surrounding component data are combined with biological data, the user's activities can be tied to a physical or emotional state and recorded. For example, if a user is sitting watching TV but has an elevated heart rate and shallow breath, the user may be watching an exciting movie or sports program. If the user had an elevated heart rate and shallow breathing prior to turning on the television, the user is most likely stressed or angry, and is using the television as a method to cope or distract from the elevated stress levels. Another example is when a user is getting food from a refrigerator, the proximity sensors in the user's personal device connect with the refrigerator and information about which user, what food, and what time of day is removed. The biological sensors on the user may also record the state of the user before and while the user is taking the food and given timestamp information. Once the data is collected—or while it is being collected—personal device and the refrigerator can sync the data to one another, or can sync information to a common hub or bridge, or set of bridges, or can store the information along with the timing and location data on their own internal memory storages to be later downloaded to a central bridge or hub. Information can then be processed to determine the state of the user before food was taken (stressed, relaxed, dehydrated, tired, etc.), what foods were consumed by the user, and what effect it had on the user (became relaxed, woke up, felt nauseas, fell asleep) by tracking the biological data for a period of time after the food was consumed. By tracking these before and after states and correlating them to the event trigger, the system can detect foods or activities that have either positive or negative effects on a user. For example, a food allergy can be detected by correlating a nauseas feeling with eating certain foods over a long period of time. The system may also be able to detect patterns of eating, drinking, and activity with a user's physical and emotional state. For example, a user may be more likely to sit and watch TV when he or she is tired and stressed, but may be more likely to go on a walk when they are stressed but not as tired.

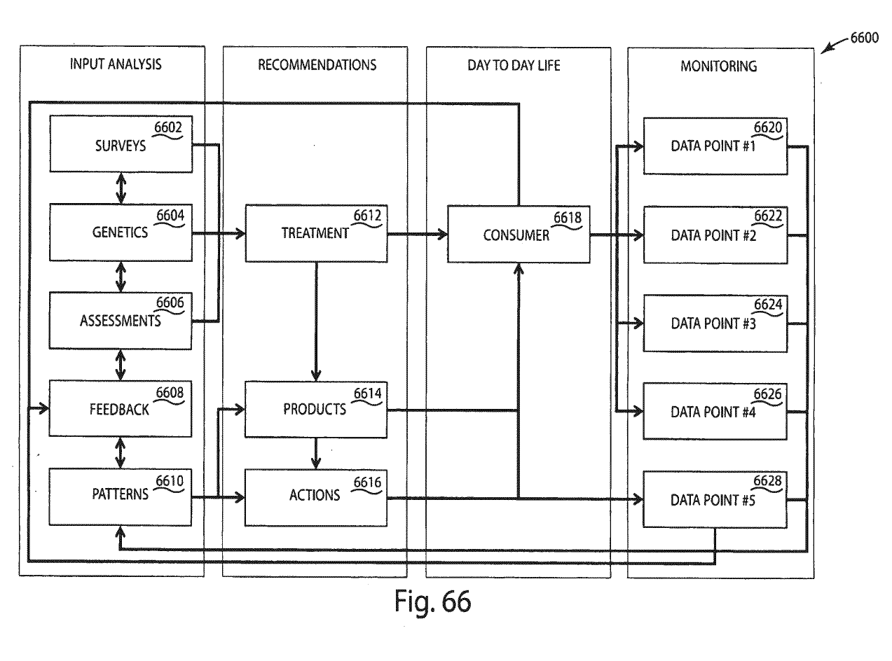

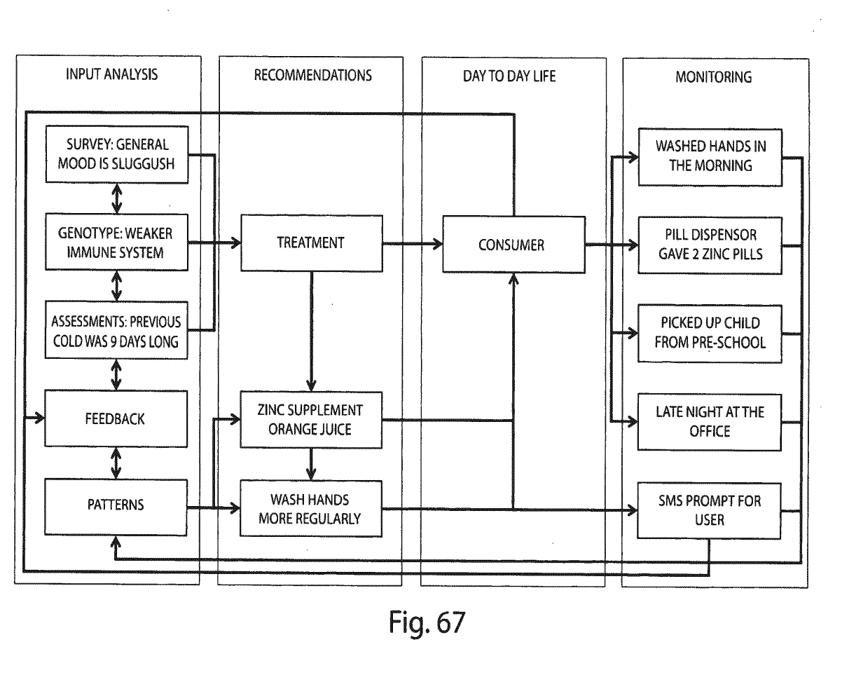

The system can also detect patterns by looking at the users physiological data over time such as how well a user is hydrated, body temperature, and information input from the user about how they are feeling and compare that to past data tagged by the user. FIG. 66 shows an example system for data collection and pattern recognition. The system may include input analysis such as survey analysis 6602, genetic analysis 6604, assessment analysis 6606, feedback analysis 6608, and pattern analysis 6610. The system may include recommendations such as treatment options 6612, products 6614 and actions 6616. Input can be provided by a consumer during day to day life 6618. Various monitoring of data points 6620-6626 and user interfaces 6628 can be done. For example, a cold may be detected by matching personal information such as a decrease in activity, decrease in appetite, an increase in body temperature, and a tagged response from a user that they were feeling sluggish for similar parameters. The system may also be able to determine potential causes to the illness by looking at data prior to the illness, such as locations visited, sleep levels, stress levels, activity levels, and nutritional input. FIG. 67 shows a collection of data that can be actively monitored or measured by the system such as sleep schedules, interactions with other people, actions such as washing hands, and variations in diet. This body of prior data can be used to determine the leading factors for disease for a user, such as lack of sleep, lack of nutrition, or increased levels of stress.

The illustrated embodiment of FIG. 66 shows one system approach to data collection, input analysis, assessments, feedback and pattern recording and matching to form recommendations for treatment. The consumer may be monitored and asked questions for feedback. FIG. 67 shows another example of the system level approach from FIG. 66 to identify, treat, and prevent the spread of a cold in a user.

The system can also use data gathered to track the health of an individual over time, rather than looking at specific events. For example, the system may be used to track the long term effects of changes in environment, diet, or activity levels. A user may tag a day, week, or month in which they made a major shift in habits, such as drinking more water and less coffee.

The system may also be able to determine effectiveness of certain activities against certain moods. For example, the system can determine which type of activity or food is best for relaxing the user when they are stressed by comparing previous events of when the user was tagged as stressed and comparing the different results against the various activities performed and food/beverage eaten. Alternatively, the network can determine the most likely causes of certain emotions based on events, activities, locations, sleep and work habits, and food.

The processing of data can be accomplished by a central program running on a computer or server that collects all of the pertinent data from the network of components. This central processing unit can match events and data with the timestamp information and user tags to build a linear database of information in the appropriate order and timeframe, so that events can be tracked not just at a certain point, but over time.

The processing of data can also be accomplished by a distributed program running on several different components located in proximity to or associated with various hubs (such as a server or desktop computer) but also components located near or on the user. For example, a program that processes data to understand a user's mood may use a large server system, while a program that processes health and exercise data may be running on a cell phone or other personal device that the user carries with them.

### X. Behavior Monitoring

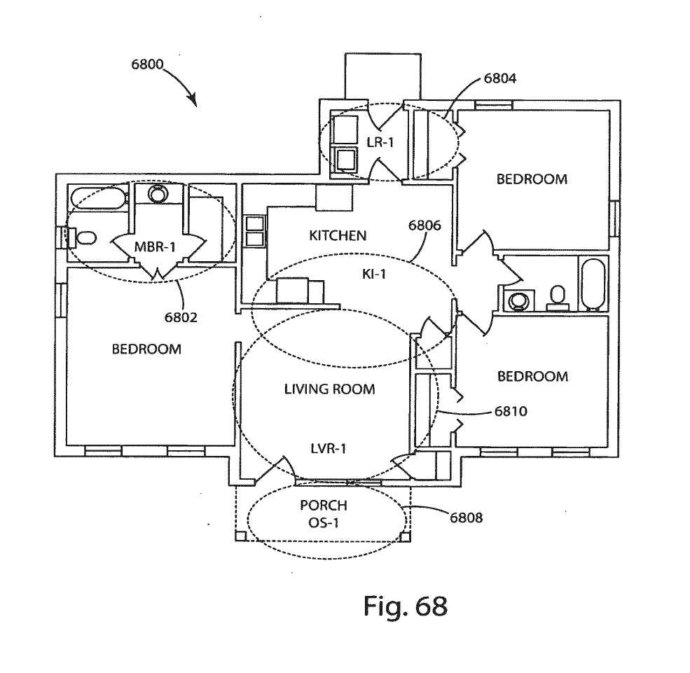

FIG. 68 shows a floor plan layout 6800 that illustrates how zones may be used to indicate movement and proximities. This can help to understand when children are getting ready for school, when an elderly person is moving about and who is present. This can be helpful when tracking Alzheimer patients and elderly activity, among other things. In FIG. 68 a number of components are located throughout the home that form various zones including a master bedroom bathroom zone 6802, a patio zone 6804, a kitchen zone 6806, a living room zone 6810, and a porch zone 6808. These zones can be used to tag data for use in the behavior modification system.

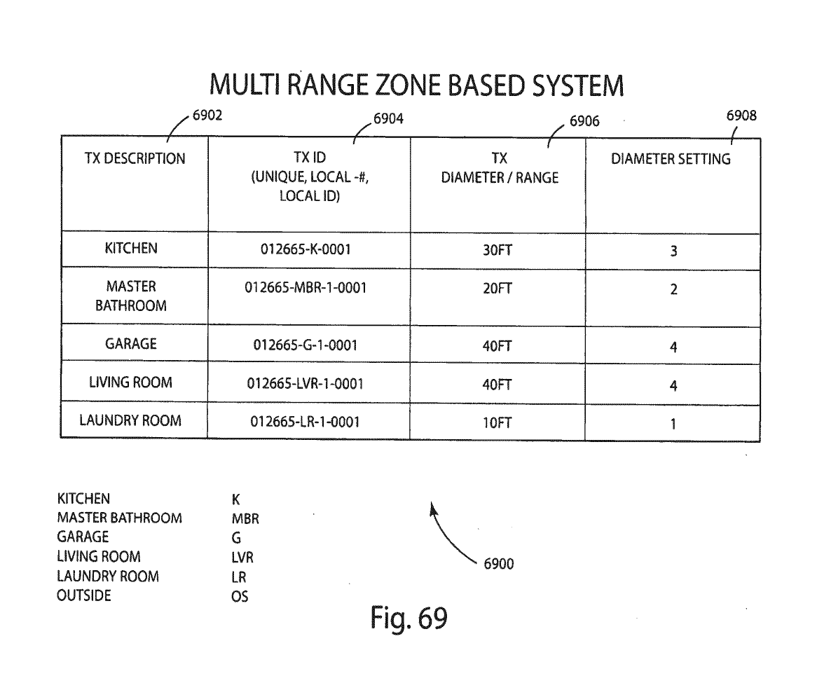

FIG. 69 shows one implementation of how the tracking can work with the configuration of zones and the ID configuration of zones. The proximity range of these zones can also be programmed or adjusted for each specific zone. In the table 6900 illustrated in FIG. 69, the multi-range zone is described in terms of transmitter description 6902 or location, ID 6904, transmitter range 6906 and setting 6908.

The present invention may incorporate the use of a behavior monitoring survey. The behavior analysis survey assists the systems in identifying the daily habits of a user. For example, the survey can be completed by a user via communication with the personal device. The personal device may monitor various activities, such as how often the user visits certain rooms. The survey can be used to assist in understanding the behavior of the user better.

With the system having an understanding of the user's behavior, the system can compare the stored information with current personal device readings. From this the system can build metrics on behavior analysis. Behavior analysis is sometimes referred to generally as the field of Applied Behavior Analysis (ABA). This field monitors behavior, analyzes behavior, and introduces stimulus to affect changes in behavior.

Three Applied Behavior Analysis metrics are repeatability, temporal extent, and temporal locus. Repeatability deals with the count, rate/frequency, and celeration (how the rate changes) of a behavior. The temporal extent is a dimension that indicates how long a behavior occurs. The temporal locus deals with when the behavior occurs in time. It uses measurements such as response latency and inter-response time. Response latency is the measure of time that elapses between the onset of a stimulus and the initiation of the response, and the inter-response time is the amount of time that occurs between two consecutive instances of a response class. When trying to obtain quantifiable measures for a behavior it can be helpful to look at one or more of these three metrics.

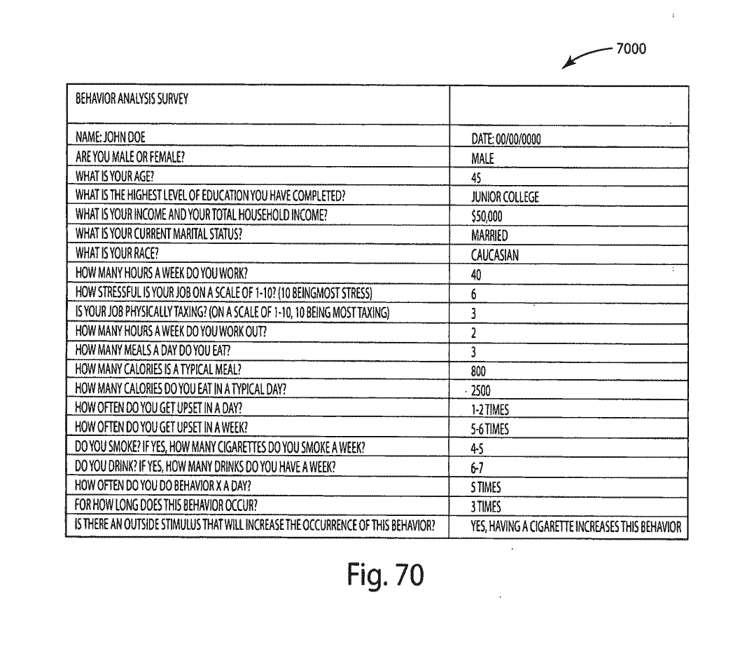

To monitor behavior and develop these metrics and measures, multiple surveys and tracking components may be used. The survey shown in FIG. 70 (Schmoe) is an example that can be provided to a person to program settings into their personal device. In some embodiments, the user can fill out a more detailed survey to increase accuracy of the behavior modification results from their personal device.

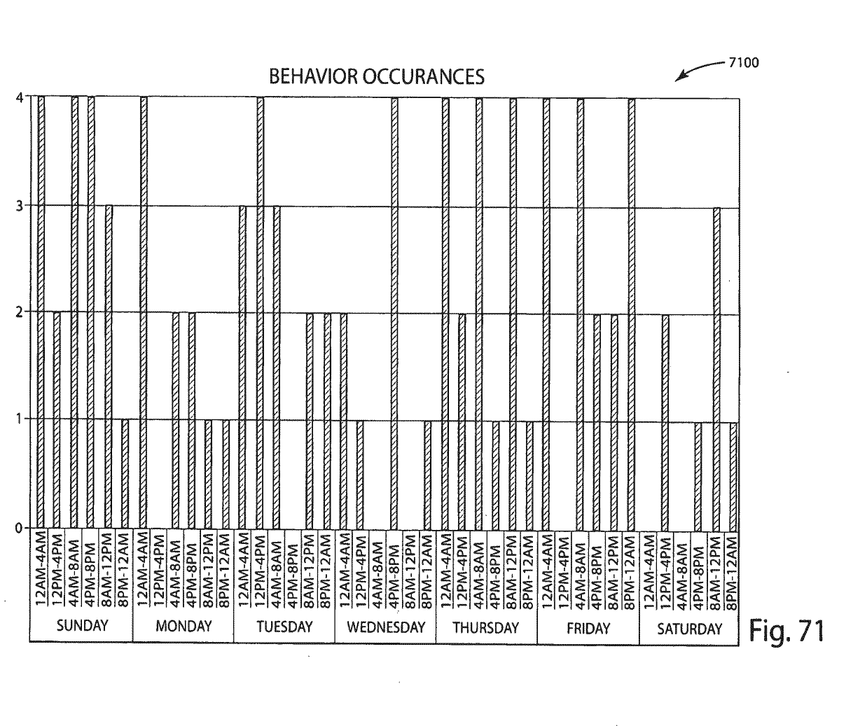

In alternative embodiments, the survey in FIG. 70 could have additional questions that may assist in further understanding user habits. By using a survey and keeping track of the data gathered from the personal device, the system can analysis behavior. The analysis can be conducted in a variety of ways. For example, by identifying the frequency of a certain behavior, patterns can be recognized. For purposes of disclosure, the graphs shown in FIGS. 71-73 illustrate graphs 7100, 7200, 7300 that show the frequency with which a certain behavior is performed, but it should be understood that behavior analysis may be conducted by analyzing data without generating a graph.

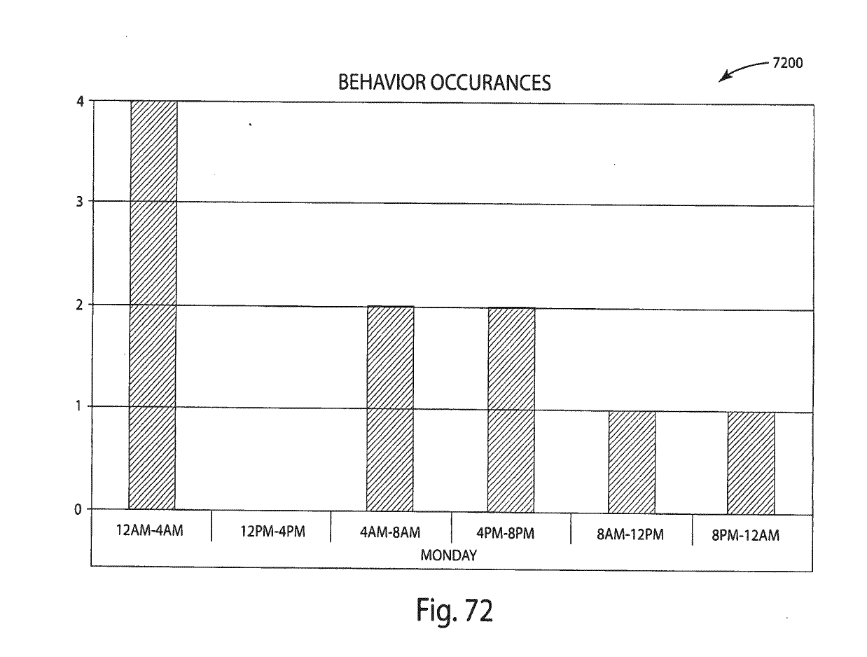

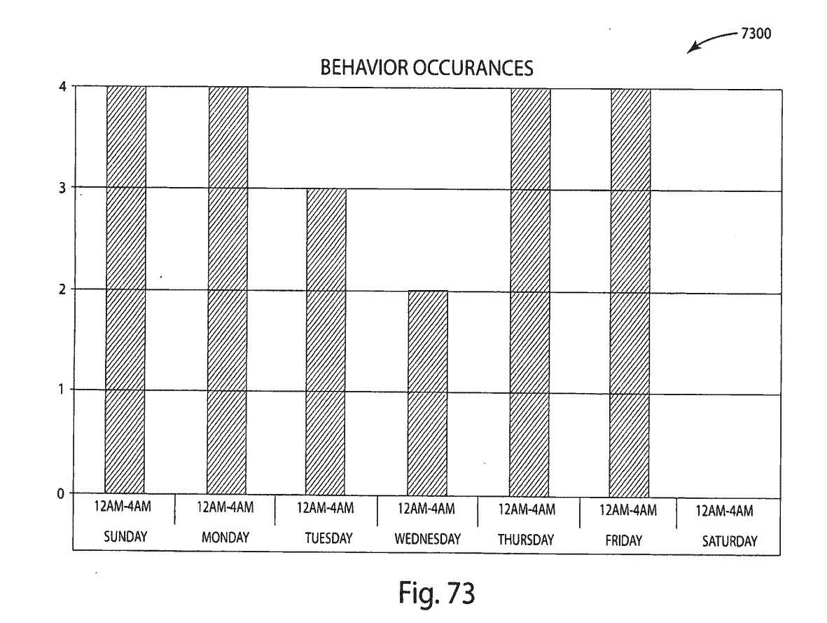

FIGS. 71, 72, and 73 provide a breakdown of a behavior by what day it was performed and at what time. Because the graphs in FIGS. 72 and 73 are pivot graphs the system can identify particular behaviors on a Monday, or that occur every day from 12 am to 4 am. Such a graph may be generated and provided to the user for understanding their behaviors on Monday or daily from 12 am to 4 am. Using this information, it can be seen how, in one example, behavior can be tracked and monitored over a period of time. This analysis can be extended to greater lengths of time.

One embodiment of the present invention may be capable of providing input with respect to essentially any behavior. Behaviors that are predictable or correlate with another action may be simplest to modify. Behaviors that are erratic and non-predictable may be more complicated to modify; however, they probably happen infrequently and may not be of particular concern. Behaviors that are tied to an action can be straight forward to modify. For example, say you want to quit smoking. Many smokers have a cigarette with a drink, or when they are bored or not occupied. If the system knew when you were having a drink, it may recommend having a piece of Nicorette to curb the need for a cigarette. Also if the system notices the user is stagnant, and there is a strong correlation between this behavior and smoking, then the system may be capable of sending you an article on your phone, or bringing up a game or puzzle to occupy your brain and limit the amount of stagnation or boredom.

Any behavior that can be correlated to surroundings, interactions, actions, or emotions can be modified. Having a user interact with the personal device and tagging certain situations can provide numerous data points for identifying correlations. Also, knowing who the user interacts with can provide valuable insight into correlations and modifying behaviors. If for instance a user is informed he/she has a cigarette every time he/she runs into a certain person at work, the user can try to eliminate the subconscious behaviors.

In one embodiment, the behavior modification system may implement component-assisted behavior modification to affect a user's behavior. For purposes of disclosure, the example in which the system can be used in connection a hypothetical user—John. It should be understood that, in alternative embodiments, the described sequence may include additional features as described herein, and may include some but not all described features.

The scenario described below can lead to multiple behaviors by hypothetical user, John. Four of John's behaviors are highlighted to demonstrate how they could be modified using one embodiment of a behavior modification system and an Antecedents, Behaviors, and Consequences (ABC) approach to behavior modification. In the ABC approach, observations are made on the Antecedents, Behaviors, and Consequences. Antecedents can be defined as the events or conditions present in the environment before the behavior occurs, Behaviors can be what is said or done by the person, and the Consequences can be the results, outcomes, or effects following a behavior.

When using the ABC approach for behavior modification there may be particular attention paid to the antecedents and the consequences. When analyzing the antecedents it can be useful to understand who was present, what activities are or have occurred, the time of day, season, time of year, and the location or physical setting in which the behavior occurred. When analyzing the consequences of a behavior, the consequences can be classified into at least three categories: i) reinforcing, ii) non-reinforcing, or iii) neutral. These consequences can occur naturally or be applied. Naturally occurring consequences can occur without intentional human intervention and applied consequences can be defined as those that are deliberately arranged.

Scenario: On Monday John wakes up late for work because his wife forgot to reset the alarm before she went to work. Realizing he is going to be late for work, he takes very quick shower and rushes to get out of the house. In his haste, John forgets to take his ADHD medication, and to take the dog out for its morning walk (Behavior 1). When he gets to work he realizes that he has an important report that needs to be completed. He spends the entire morning sitting at his desk, but cannot concentrate well enough to make any progress. At 11:45 am John realizes that he forgot his lunch and will not have time for his normal routine of going to the gym before he eats. Instead, he goes out to a local restaurant with his colleges and eats a bacon cheese burger (Behavior 2). After lunch, he goes back to work feeling very tired and gets about one quarter of the report finished. Just as John goes to save the report, his computer crashes and he loses all of the work he did after lunch. Frustrated with his day, he curses at his computer and leaves the office. When he gets home, he is greeted by his wife who is upset because he forgot to take out the dog in the morning (resulting in a large mess on the living room floor). In response to these acquisitions, John yells at his wife about forgetting to reset the alarm (Behavior 3). They get into a blowout argument, causing his wife to storm out of the house. For dinner, John makes a frozen pizza and eats it alone while sitting on the couch and watching his favorite football team. At half-time, he gets up and goes to the kitchen and gets a bowl of ice cream (Behavior 4). While watching the game, John falls asleep on the couch.

### Behavior 1—Forgetting to Take Medication:

### Antecedents:

1) No alarm
2) Waking up late
3) Taking a quick shower
4) Morning

### Behavior:

1) Not taking ADHD medication

### Consequence:

1) Lack of focus and concentration→hard time with report
2) Gets flustered and stresses out
   3) Temper when computer crashes
   Examples of a System Interaction that would Help Modify this Behavior:
1) Personal device with built in 3-axis accelerometer, clock (with date), Bluetooth communication, thermometer for environmental surroundings, microphone, thermometer for body temperature, and hygrometer

### Operation:

a) The system knows that Monday through Friday you usually get up for work at 7:30 am. When the individual doesn't start moving until 8:15 am, as tracked by the 3-axis accelerometer, it stores this as a first warning signal.
b) The personal device tracks the time you spent in the shower by measuring both the temperature (thermometer) and the humidity (hygrometer). It realizes that the individual took at 5 min shower and they usually take a 10 min shower.
c) Personal device communicates with ADHD medication bottle and realizes that you usually open the bottle by 8 am and you have not yet opened the bottle today. This event is stored as a third warning.
d) Three concurrent warnings within a defined window of time cause the personal device to send text message to your phone. This message could read something like: You seem to be in a hurry and running late today, don't forget to take your ADHD medicine.

### Behavior 2—Skipping his Workout:

### Antecedents:

1) Rushed in the morning
2) Forgot his lunch
3) Afternoon
4) Work colleges
5) Sitting at desk by computer

### Behavior:

1) Did not go to gym for his workout

### Consequence:

1) Possible weight gain
2) Stress
3) Eating unhealthy
4) Tired→hard time with report
   Examples of a System Interaction that would Help Modify this Behavior:
1) Personal device with built in 3-axis accelerometer, clock (with date), Bluetooth communication, thermometer for environmental surroundings, microphone, thermometer for body temperature, and hygrometer

### Operation:

a) System knows that the individual typically goes the gym for 30 to 45 minutes on Monday, Wednesday, and Friday based on internal date/time clock, body temperature, and movement.
b) Personal device knows that the individual is sitting at their desk via established communications with their computer.
c) At 11:50 am the personal device sends an instant message to the individual's computer saying: remember that you need to go to the gym today.
   Behavior 3—Argument with Significant Other:

### Antecedents:

1) No Alarm in the morning
2) Not taking his medication
3) Computer crashing
4) After work (evening)
5) Dog making a mess in leaving room

### Behavior:

1) Yelling at his wife

### Consequence:

1) Doesn't get to eat dinner with his wife
2) Spends the night alone watching TV
3) Eats poorly
4) Wife leaves the house
   Examples of a System Interaction that would Help Modify this Behavior:
1) Personal device with built in 3-axis accelerometer, clock (with date), Bluetooth communication, thermometer for environmental surroundings, microphone, thermometer for body temperature, and hygrometer.

### Operation:

a) Personal device knows that that individual woke-up late today and did not take his medication (see behavior 1 for details).
b) Personal device knows that individual did not go to the gym on a day that they typically go (see behavior 2 for details).
c) Personal device knows that individual had some type of bad encounter based loud voice recordings on the microphone.
d) Personal device knows that individual will be heading home soon, based on date/time stamp.
e) Personal device sends a text message to individual's wife saying: Your husband may have had a bad day today. Be a little forgiving when he gets to the house.

### Behavior 4—Ice Cream Snack:

### Antecedents:

1) Watching TV
2) Sitting on the couch
3) Alone
4) Evening

### Behavior:

1) Going to the kitchen and getting an unhealthy snack

### Consequence:

1) Weight gain
2) Falling asleep on couch
3) Stress for eating unhealthy
   Examples of a System Interaction that would Help Modify this Behavior:
1) Personal device with built in 3-axis accelerometer, clock (with date), Bluetooth communication, thermometer for environmental surroundings, microphone, thermometer for body temperature, and hygrometer.

### Operation:

a) Personal device knows that the individual did not exercise today (see behavior 2 for details).
b) Personal device also knows that the individual was not very active today by 3-axis accelerometer readings and time spent near the computer.
c) Personal device knows that the individual has been sitting on the couch for the last hour watching TV based on communication with TV or an in-home base station.
d) Personal device communicates with the refrigerator/freezer and knows that you are opening the door.
e) Personal device sends a message to the refrigerator and it displays the following message: you may want to eat an apple based on your daily activities.

In one embodiment, if the system uses an event packet approach to behavior modification, it may determine recommendations based on the identified relationships between different states. For example, if the behavior modification system is able to predict that the current actions, activities, locations, and nearby components typically cause the user to go from relaxed to stressed, the system may determine the most common relationships that cause the user to go from stressed to relaxed, and suggest such actions.

In one embodiment, the network of components may change their control or communication methods in response to the identification of certain actions or events. For example, the system may determine that a user is not sleeping well based on the time of day, the level of activity, average position of the user, the location of the user, and the identification that these antecedents typically result in the user prompting the system with information that they are tired. The system may identify that the user typically sleeps better with a cooler temperature, and rather than prompting the user, the system may automatically adjust the thermostat cooler.

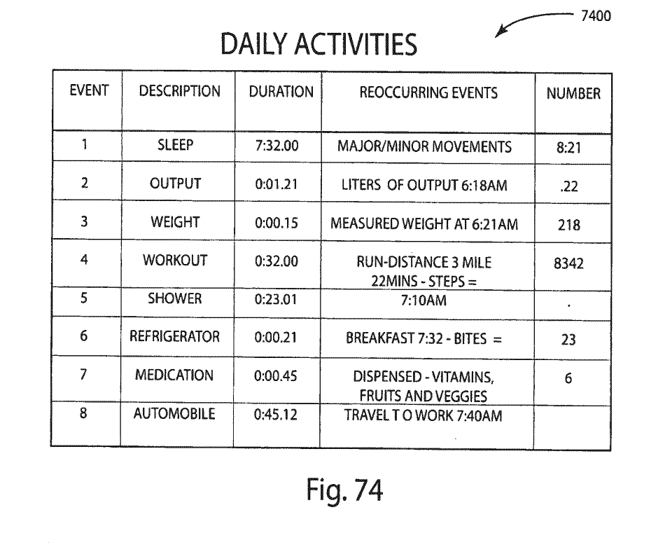

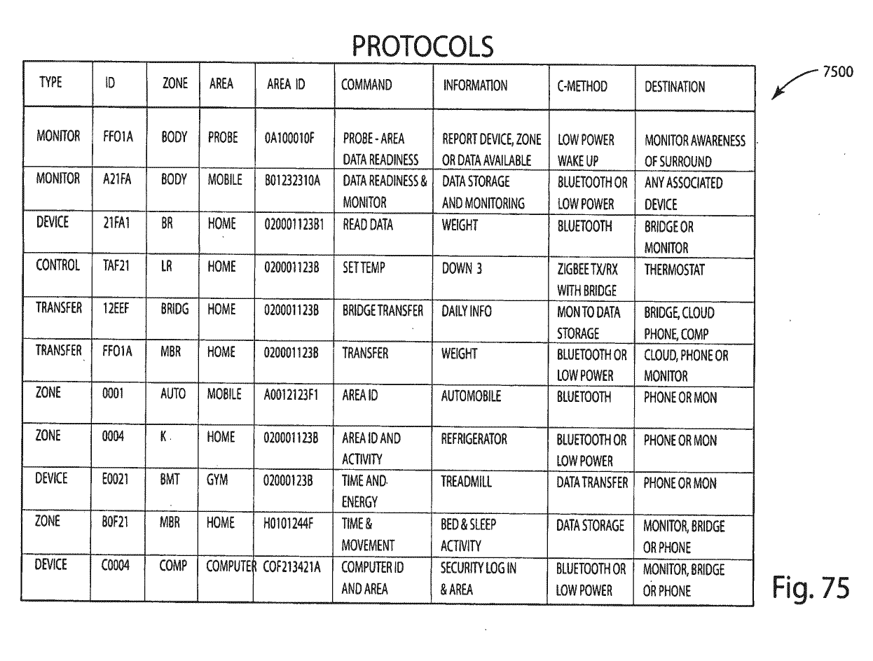

The system may track daily activities of the user. For example, as shown in the illustrated embodiment of FIG. 74, the data and timing of a nights worth of sleep and the daily trip to work may be tracked in a table 7400, such as a database table. Monitoring such activities can provide a means to improve performance, save time, analyze behavior for future recommendations and provide a general understanding of your life's activities and time spent. This information can assist in making informed decisions and identifying opportunities for health, beauty and the future needs and growth for each user. FIG. 75 shows another example of a system protocol 7500 for monitoring, transferring data, controlling components, requesting data from components and understanding and tracking zone movements.

Components may also be used to collect information about a user or set of users and the components they may be interacting with. This data may be used for market research, for automatic component to component, or component to user interactions. For example, two vehicles of the same brand that are both equipped with a personal device may pass one another, detect one another using their proximity and identification protocols, and honk their horns at one another as they pass. Another example may be a store tracking movement of shoppers through their aisles using proximity and identification protocols. The store can understand how shoppers typically move through their store, get demographic information about the users, and can even understand how shoppers interact with product and components on the shelves by matching a user location with a component that is picked up off the shelf, turned on, or otherwise interacted with by a user at a given point in time.

### XI. Smart Hub

As discussed above, the behavior modification system may include a hub that is capable of routing communication throughout the network. The hub may include transmitters and receivers for communicating over different protocols along with circuitry for routing communication.

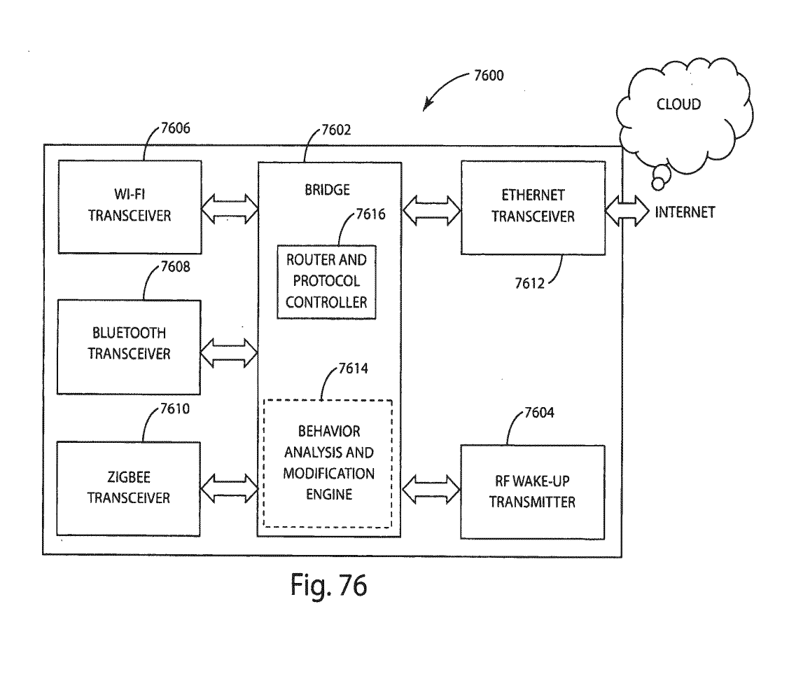

One example of a hub for use in one embodiment of a behavior modification system is illustrated in FIG. 76. The illustrated hub 7600 includes a plurality of transceivers including a Wi-Fi transceiver 7606, a Bluetooth transceiver 7608, a ZigBee Transceiver 7610, an Ethernet Transceiver 7612 and uses several communication protocols including wired or wireless communication protocols such as Wi-Fi, ZigBee, Bluetooth, and other various wireless interfaces to communicate with remote devices. The hub may include a bridge 7602 that has router and protocol controller 7616 to receive data from another component, collect data for storage, and convert data into a format that can be sent to via a wired transceiver to an internet connected storage device. Additionally, the hub can use an RF wake-up transmitter 7604 to alert, wake-up, or turn on remote devices periodically. Once components wake-up and become active, they can turn on their wireless interfaces and connect to the hub. The components and hub can determine if there is data to be transferred between the hub and the components.

The hub may use an RF wake-up transceiver instead of a transmitter so that components may be used to wake up the hub. For example, if a component enters a room it can send an RF wake-up signal to the hub. As another example, the hub may be currently waiting to send another wake-up signal, and the device may determine that it needs to determine the other devices and hubs in the room, so it may transmit an RF wake-up signal. For example, if a personal device has completed a Bio-impedance reading, it may communicate that measurement to the nearest hub. Rather than waiting for the nearest hub to send an RF wake-up signal, the personal device may instead send an RF wake-up signal.

The hub may include or include a portion of a behavior analysis and modification engine 7614 to identify behaviors, trends, habits, and patterns of the users and their devices, and take action to change the behavior of the users. One embodiment of a method of behavior analysis and modification that can be implemented as a behavior analysis and modification engine is shown in FIG. 62 and discussed herein. In the illustrated embodiment, the behavior analysis and modification engine is depicted as an optional module.

Components may be powered from one another either through wired connections or wireless connections. For example, components in accordance with the present invention may be charged by the hub while transferring data to and from the hub. This wireless charging may be used to initiate the data connection, prompting the transfer of information.

In one embodiment, the hub is a smart hub that includes wake-up circuitry for waking up components that come within proximity of the smart hub. Exemplary wake-up circuitry is described herein.

A smart hub may include a router and protocol controller along with wake-up circuitry. One embodiment of such a smart hub is illustrated in FIG. 76. The exemplary hub includes a Wi-Fi transceiver, a Bluetooth transceiver, a ZigBee transceiver, and an Ethernet transceiver. The communication transceivers provide interfaces to the respective networks and the components connected thereto.

The protocol translator can enable a command to be pushed from one component to another, even if those components are on different networks. Specifically, the protocol translator can enable a command to be pushed from any component to any network within the bridge network using the proper protocol. This may include, for example, pushing data from a simple network to an encrypted database on the cloud. A component can interface to a central controller that is compiling and synthesizing daily performance and activities to recognize patterns and behavior changes. In one embodiment, the central controller may be located in the hub as part of an internal behavior modification engine. In alternative embodiments, the central controller may be located remotely on a network.

An exemplary embodiment of a hub interacting with a plurality of behavior modification components is illustrated in FIG. 76. Each configuration of a component may have various network or communications capabilities and may interface with the other components within the behavior modification system. The hub of this embodiment is the bridge that connects each respective network by bridging these systems via network and protocol translation capabilities. In this embodiment, networks include a low power wake-up network, Bluetooth network, WiFi network, and ZigBee network for control capabilities and direct interaction to the Internet.

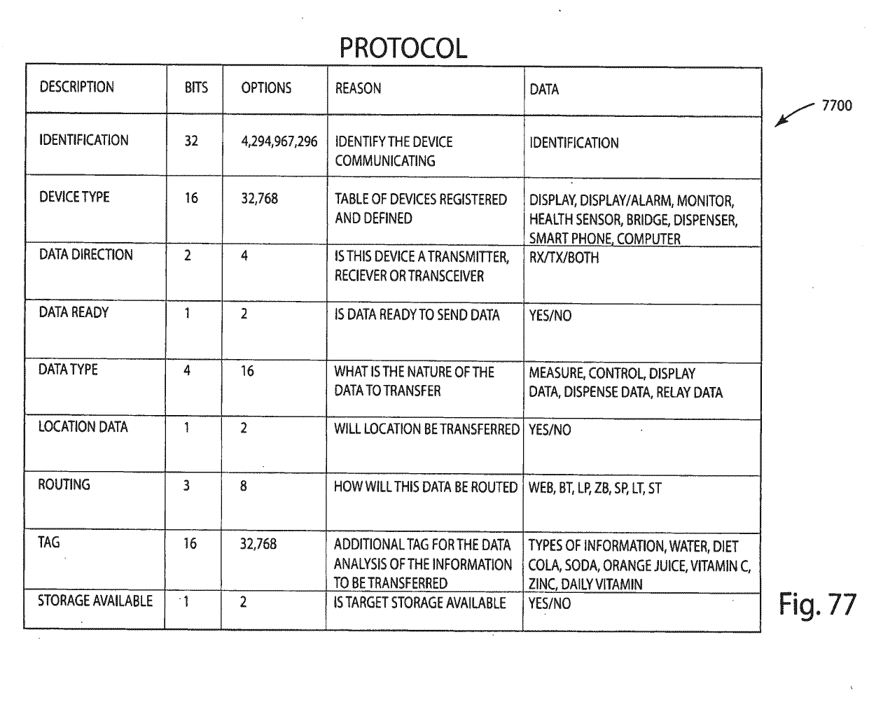

The hub can utilize a configurable and interoperable data communication protocol. An example of such a protocol 7700 is illustrated in FIG. 77. This embodiment can allow devices, monitors, sensors, displays, bridges, applications and other system components to be configured to share and report communications within this network.

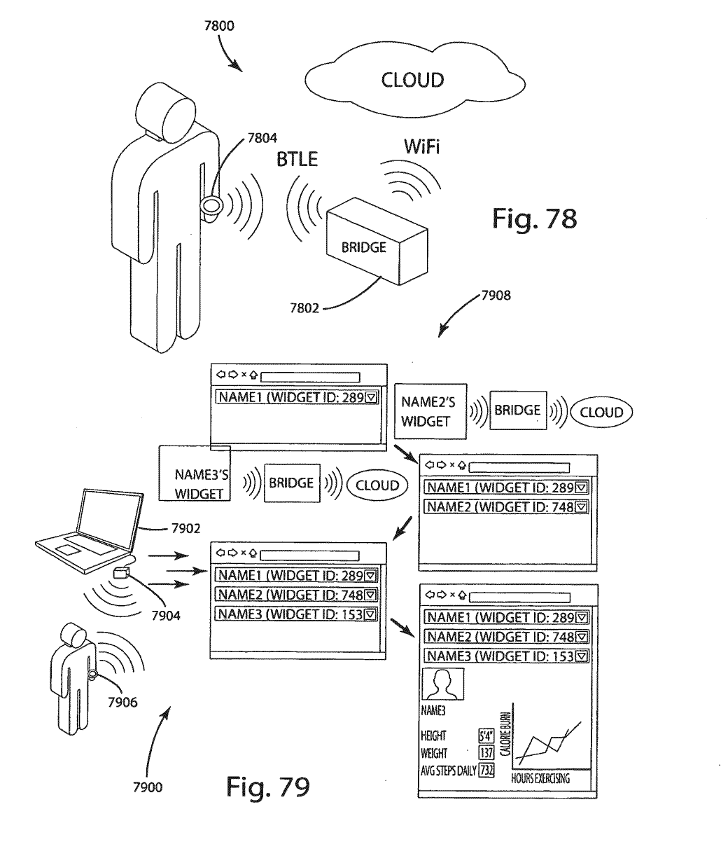

FIG. 78 illustrates a diagram 7800 of one embodiment of a hub 7802 in operation. Specifically, the depicted embodiment illustrates a personal device 7804 communicating through a hub 7802. The hub is illustrated receiving data and relaying collected data to the Internet, cloud, remote computing device or server, or other remote information retention. In this embodiment, the protocol between the personal device (wearable device) and the bridge (hub) is Bluetooth Low Energy (BTLE). The protocol between the bridge (hub) and the Internet is WiFi.

FIG. 79 shows the bridge (hub) 7904 connected directly to a personal computer 7902. In this embodiment, raw or analyzed data from a personal device 7906 can be transmitted to the personal computer 7902 through the hub 7904 where it can be further analyzed. Screenshots 7908 of a user interacting with the components of the behavior modification system are also illustrated in FIG. 79.

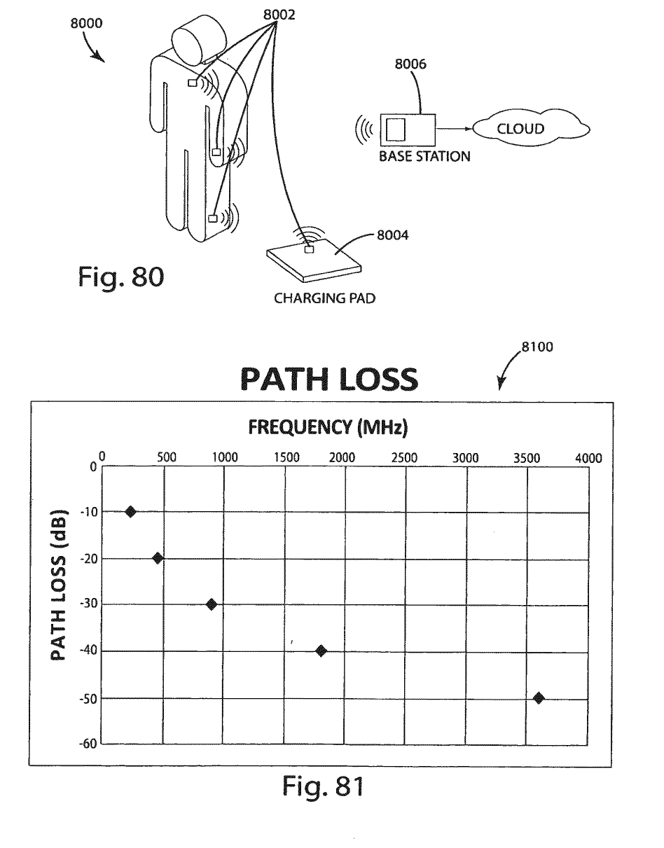

FIG. 80 shows a scene 8000 where a base station (hub) 8006 and wireless charging pad 8004 are interacting. These may be combined to provide a single charging and data syncing device for a personal device 8002 or other components carried by a user.

In one embodiment, the network of components may also include one or more hubs or central components capable of communicating with other components over several different wireless communication methods, such as Bluetooth, ZigBee, Wi-Fi, NFC/RFID, and a number of wired communication methods, such as an internet connection, USB, FireWire, LAN, X10, or other such communication topologies. The hub in this embodiment of the behavior modification system can connect to components, download information from the components, and transfer that information to a central data storage area either on a large memory storage device (such as a hard drive or desktop computer), or can be sent through the internet to a remote storage location or server.

The hub in this embodiment may also be configured to receive component updates, instructions, warnings, or event information that can be sent back to the components so that they can be updated. The hub can send messages through a wired connection either through a local network connection or through an internet connection to control components that the user does not wear or carry, such as a thermostat, television, lighting system, exercise machine, or any other non-mobile or semi-mobile component a user may interact with.

### XII. Radio Frequency Wake-Up Signal

One aspect of the invention is directed to reducing system wide power consumption. In one embodiment, the system components have the ability to enter a low-power standby mode when inactive. In one embodiment, the system components may utilize a wake-up signal to wake-up from standby mode. For example, a wake-up signal may be transmitted by one device, such as a hub described herein, to wake-up another device, such as a personal device described herein. As another example, a wake-up signal may be generated internally by an event. The event may occur within the component (e.g. timer-based event, motion-based event, or gesture-based event).

In one embodiment, the system may utilize an RF wake-up signal. For example, an RF signal may be broadcast at a predetermined frequency to wake-up components that receive the signal. The strength of the broadcast signal and the sensitivity of the receive antenna may be selected to control which devices are activated.

While the devices within this network may maintain a constant radio signal, or may periodically turn on their radio transceivers to listen for a communication method, another possible method is to use an RF interrogation unit that sends a pulse of power at a specified frequency. This pulse of power is strong enough to power a portion of the remote device, causing a trigger on the remote device to sense that it is being interrogated. These devices may use several antennas dedicated either to a communication transceiver or an interrogation transceiver, or they may be combined such that the device configures an antenna as an interrogation antenna when being used to wake-up other devices, or when the device is not using its communication system, that way an interrogation signal from a remote device may be received. Once an interrogation sequence has occurred, the devices may switch control of the antennas to the communication transceivers. Alternatively, a device may use a diplexer to allow both the communication transceivers and interrogation transceivers to use the antenna at the same time. In such an instance, each transceiver would be connected to the diplexer through a narrow band filter to prevent interactions between the two transceivers. An RF switch may be used to prevent damage to the interrogation receiver when the device begins to transmit an interrogation signal. For example, a device may use a SAW filter stabilized Colpitts oscillator and an amplifier to transmit interrogation signals. This transmitting circuit would be connected to an RF switch, which would multiplex the signal from the diplexer to either allow an interrogation signal to be transmitted from the device, or to allow an interrogation signal to be received. When using a common antenna and a diplexer, the carrier frequency for the communication transceiver and the interrogation transceiver could be different to prevent interference from one another. If it is required that they be the same, another RF switch should be used to disconnect the antenna from one transceiver when the other is being used.

The sensitivity of a component receiver to receive a signal sent by a component transmitter can depend on a number of factors. These factors may include distance between the transmitter and receiver, the frequency of the signal, and what the RF wake-up signal travels through to get to the receiver.

Determining the sensitivity for an RF wake-up circuitry on a given component can be determined based on starting beam signal strength, estimated environmental path loss, and estimated free space path loss. That is, designing appropriate minimum measurement accuracy for an RF wake-up circuit on a component within a behavior modification system can depend on the starting beam signal strength, the estimated environmental path loss, and the estimated free space path loss.

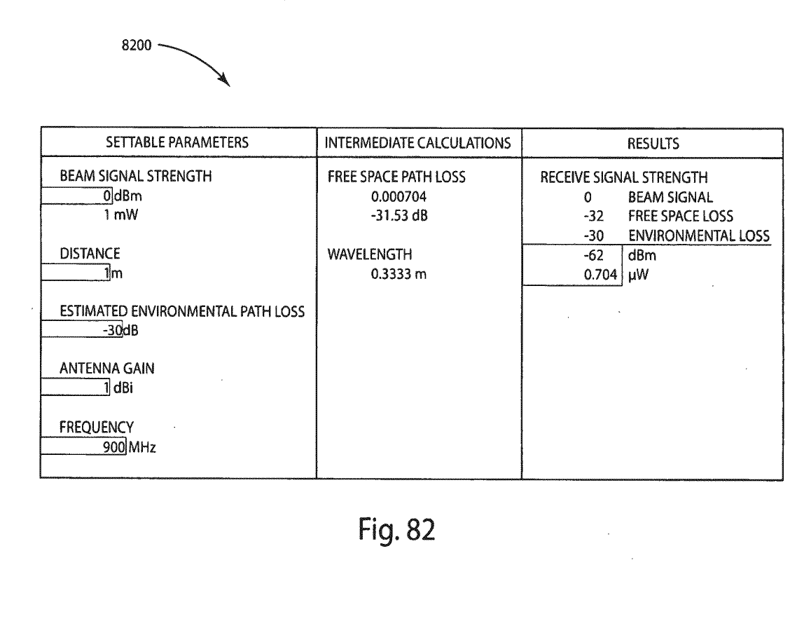

Environmental path losses can be estimated by making approximations for signals in the ultra-high frequency band propagating over the earth's surface. For example, it can be approximated that the path loss increases with roughly 35-40 DB per decade and 10-12 dB per octave. FIG. 81 shows the relative path loss of a signal at various frequencies at a given distance in a graph 8100. For a component with an RF wake-up circuit in the 900 Mhz range, there is an estimated environmental path loss of about −30 dB. FIG. 82 shows one embodiment of a range calculator 8200 for the range of the proximity wake up signal. This path loss can be used in designing a receive circuit for a component to determine the sensitivity of the receive circuit for ensuring that an RF wake-up signal sent from within an expected range is able to wake up the component.

Free space path loss can be estimated by calculating how much strength the signal loses going through a certain distance of air. This can be represented with the equation below,

$$FSPL = {( \frac{4 \cdot π \cdot d}{λ} )}^{2}$$

where d is the distance between the receiver and the transmitter and λ is the signal wavelength. Dividing the speed of light by 900 MHz gives a wavelength of 0.333 m. Assuming the component receiver is typically about one meter away results in a free space path loss of about 0.000704. This estimation can be adjusted if the typical distance between the component receiver and the component transmitter will be different. The free space path loss can be converted to decibels using the following equation.

L_{dB}=10·log(P)

For this example, P is about 0.000704, which results in a free space path loss of about −31.53 dB.

Assuming that beam signal is about 0 dB, the desired sensitivity of a component receiver can be determined. The path loss plus the free space path loss added on to that is −62 dBm. This can be converted to power by using the above equation setting it equal to −62 dBm and solving for P gives 0.704 μW. This means the receiver has to measure with at least this accuracy in order to receive an RF wake-up signal from the transmitter.

A block diagram for one embodiment of a personal device with an RF wake-up system is shown in FIG. 13. In this embodiment, one line goes from the diplexer to the Bluetooth Radio. The diplexer passively splits the 916 MHz and 2.4 GHz signals from one-another so that both radios can use a single antenna and operate at the same time. The RF switch can select between transmitting a wakeup pulse and receiving. The switch can prevent the transmitter from back-feeding the passive detector and damaging it. The 916.5 MHz filter is a narrow band filter to reduce false triggers (i.e. cell phone at 850 MHz is blocked). The passive detector converts the RF signal to a DC voltage, which can be amplified and fed into a comparator. The passive detector includes two zero-bias diodes arranged such that they function as a voltage doubler.

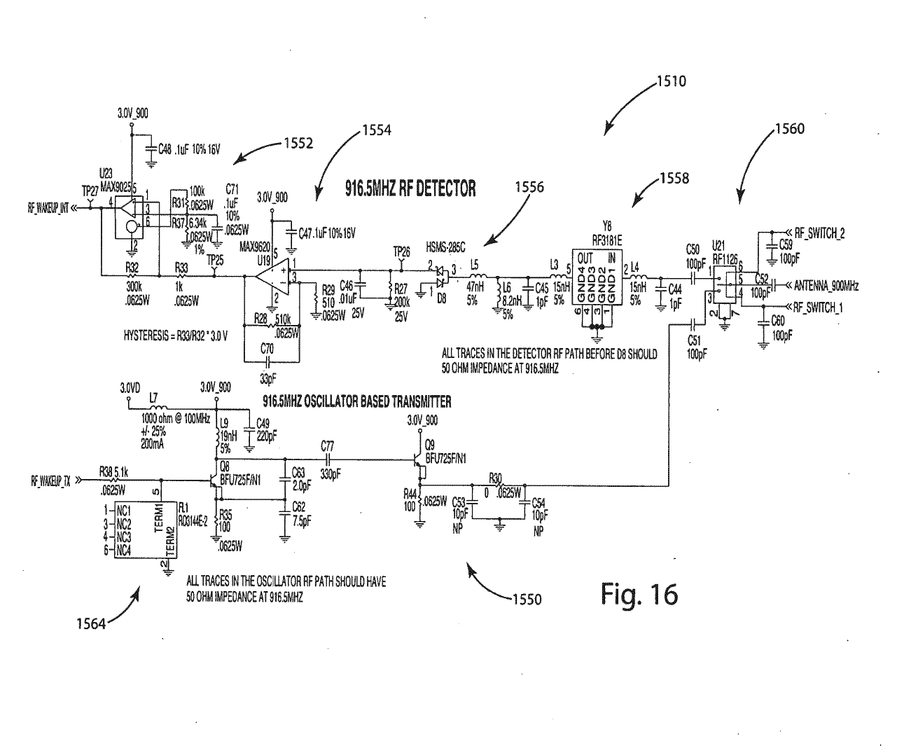

FIG. 16 shows a portion of the schematic for one exemplary embodiment that contains the detector for the RF wake up circuit in a personal device 1510 for proximity detection and very low power Tx/Rx operation only when a valid transceiver is present saving power. The top circuit is the detect and wake up interrupt for interface with other circuits and the bottom circuit is the wake up Tx ping to get other devices to interface. From right to left, the RF wake-up receiver subcircuit (916.5 Mhz RF Detector) is generally arranged as follows: RF Switch 1560->Filter 1558->Receiver diodes 1556->Amplifier 1554->Comparator 1552. The RF wake-up transmitter subcircuit includes a SAW filter stabilized Colpitts oscillator 1564 and an amplifier 1550. The amplifier may be biased based on FCC regulations, for example to meet the FCC limit of 0 dBm. The components shown in these schematics are mere exemplary, in alternative embodiments different components may be used. FIG. 16 shows an alternative construction of the RF wake-up signal transceiver shown in the illustrated embodiment of FIGS. 12A-B.

Using the RF wake-up circuit, it is possible to build a low power receiver that can be run continuously without greatly limiting battery life. In one embodiment, the RF wake-up circuit has a sensitivity of approximately −50 dBm. The RF wake-up circuitry can receive a wake-up circuit at about between 6 and 8 feet.

An additional embodiment of an RF wakeup transceiver is shown in FIG. 12. The illustrated RF wake-up transmitter subcircuit uses a Colpits Oscillator W controlled by a high or low signal which triggers the SAW oscillator X. This SAW oscillator produces a sine wave that triggers the Base of Q1, which amplifies the signal. This signal is then connected to the chip antenna Y through the RF switch V. If the component has been triggered to take a measurement using a remote sensor component, it can use this portion of the wakeup transceiver to transmit a wakeup pulse and wake-up the remote sensor component.

When the device is no longer transmitting, the RF switch can be configured into receive mode, connecting the antenna to the SAW filter U, which receives the 916.5 MHz signal from another device and filters out any ambient noise. After the SAW filter, the signal can be passed to a peak detector T that uses a half wave rectifier and an RC filter. This signal can be amplified by a non-inverting amplifier S, then a comparator R can output a high in the presence of a detected 916.5 MHz signal. This signal may be used to trigger an input on the microcontroller, or may be used to turn on a power supply for another circuit, providing a way for the rest of the device to be in a power down mode while only the RF wakeup transceiver is drawing power.

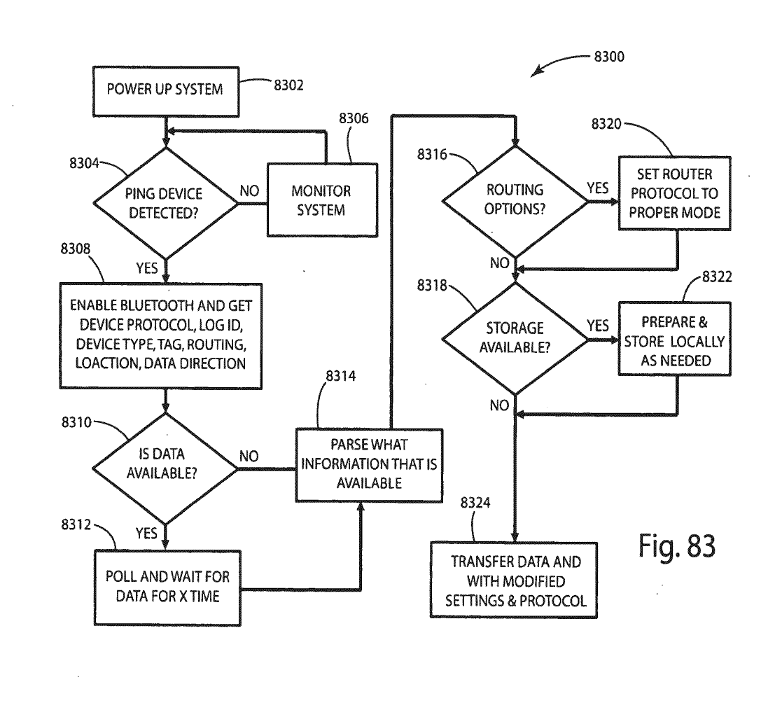

FIG. 83 shows one embodiment of a method for transferring data between components of a behavior modification system. In this embodiment, the algorithm includes the ability for the personal device to route information. For example, the personal device can route information to the Internet or another component or store the information locally as appropriate depending on system resources and availability. In one embodiment, data can be stored and uploaded to an appropriate location at a later point in time, if appropriate. The method illustrated in FIG. 83 may include powering up the system 8302, monitoring 8306 until the ping device is detected 8304. In response, Bluetooth may be enabled and the device protocol, log ID, device type, tag, routing information, location, and data direction may be obtained 8308. The system can determine whether data is available 8310. If data is available, the component can poll and wait for data for a period of time 8312. If no data is available, the component can parse what information is available 8314 and determine routing options 8316. The router protocol may be set to an appropriate mode 8320 and the system can determine if storage is available 8318. If it is, information can be prepared and stored locally as appropriate 8322. Data can then be transferred with modified settings and protocol 8324.

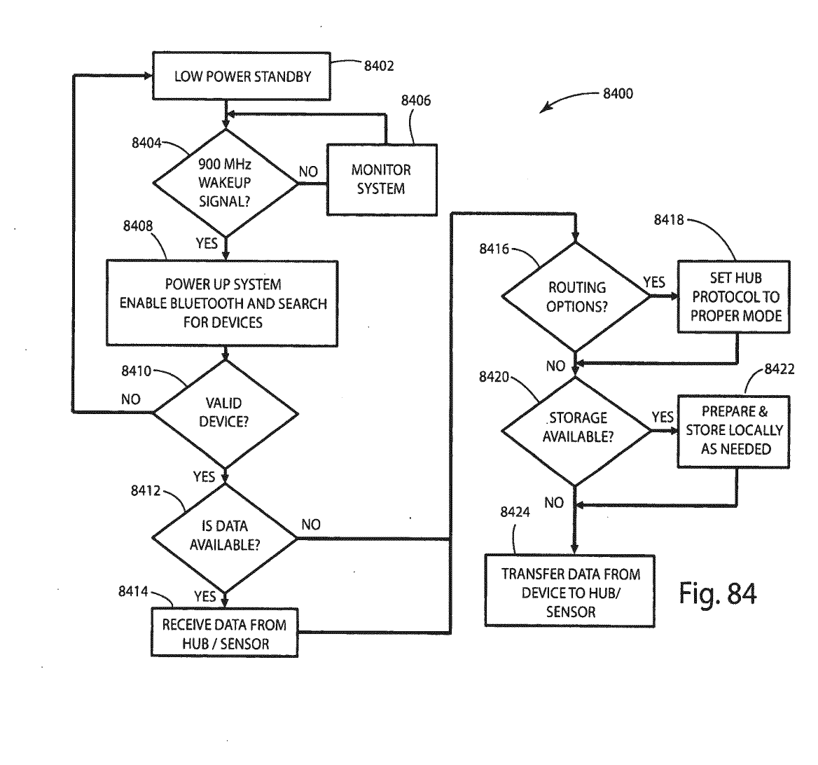

FIG. 84 shows the sequence used to transfer data between the personal device and the hub or between the personal device and a remote sensor component. In one embodiment, the method includes entering a low power standby mode 8402 until a wakeup signal is received 8404. If a wakeup is received, the system can be powered up and Bluetooth can be used to search for devices. If a valid device is located 8410 the component determines whether data is available 8412. If a valid device is not located, then the component can re-enter standby mode 8402. If data is available, the component can receive data from a hub, sensor, or other component. Routing options can be determined 8416. If data is to be routed, the hub protocol can be set to an appropriate mode. If storage is available information can be stored locally as appropriate. Data may be transferred from a component to another component, such as a hub, sensor, or personal device.

### XIII. Specialized Components

As discussed herein, the behavior modification system includes a variety of components that accomplish various behavior modification functions, including gathering, sensing, and routing data and providing behavior modification stimulus to the user. A number of examples of specialized devices that provide one or more the behavior modification functions are discussed herein.

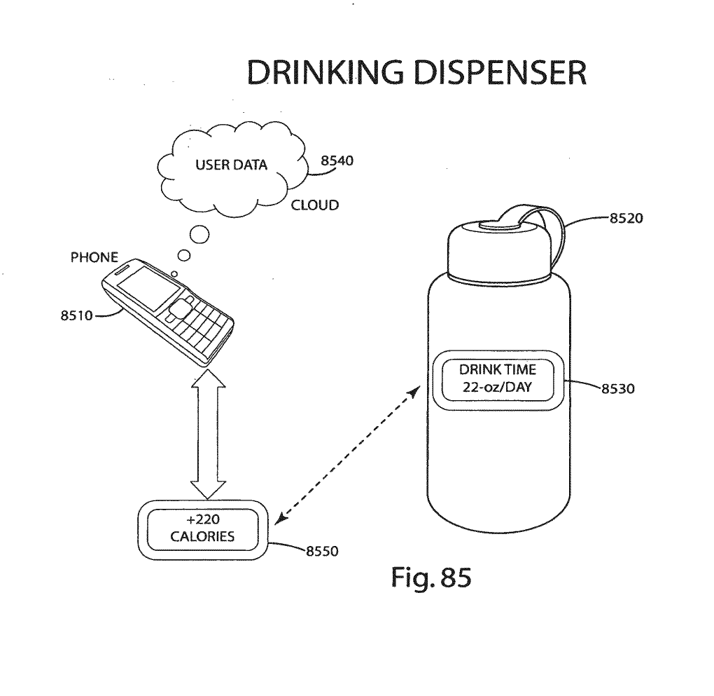

The illustrated embodiment of FIG. 85 shows an example system for tagging the type of fluid and tracking amounts consumed. The system can also notify and alert the user when it may be appropriate to drink fluid. Different drink profiles can be downloaded from an application on a component, such as a phone application.

In the illustrated embodiment of FIG. 85, a system in accordance with an embodiment of the present invention is shown and designated 8540. The system 8500 may include a device 8510, a personal device 8550, a drinking dispenser 8520, and a display 8530. The system 8500 may also store user date in storage 8540 or memory, which may be incorporated on the device 4410 or in a cloud storage system as illustrated. Although described in connection with these components, it should be understood that the system 8500 may be implemented in conjunction with other embodiments described herein and that elements of other embodiments may be substituted for any of the components in the system 8500. For instance, the system 8500 shows an example of the present invention for tagging of a type of fluid and tracking amounts consumed, but may be used for other tagging and tracking purposes.

The drinking dispenser 8520 may be capable of enabling a user to drink fluid, such as water or flavored water. In the illustrated embodiment, the drinking dispenser 8520 is a bottle or container, which may include electronics (not shown) positioned in the cap or around the body of the container. These electronics may monitor one or more of tilt, drinking duration, and volume of fluid within the drinking dispenser 8520. This information or data may be communicated to the personal device 8550 when or after a user has drunk from the drinking dispenser 8520. Alternatively or in addition to communicating this monitored information, such as drinking duration, the electronics may process the monitored information—e.g., to determine the amount of calories consumed—and communicate the processed information to the personal device 8550. The drinking dispenser 8520 may also communicate presence to the personal device 8550, enabling for example the personal device 4450 to expect information from the drinking dispenser 8520.

The drinking dispenser 8520 may include one or more displays 8530 and a selector (not shown) incorporated on the display 8530 or elsewhere on the drinking dispenser 8520. The display 8530 may interface with the electronics of the drinking dispenser 8520, and may provide notifications to the user, or provide information about the fluid in or provided by the drinking dispenser 8520, or a combination thereof. For example, the display 8530 may provide inventory information, a notification to the user about one or more of when or how much to drink, the drink type, the number of fills, and usage. The selector may be in the form of a button that allows selection of fluid type and enables downloading of information, such as new fluid types, from the device 8510.

The position of the electronics, the display 8530, and the selector on the drinking dispenser may vary among configurations. Further, in an alternative embodiment, these components may be incorporated into a cup holder or a cup insulator, separable from the drinking dispenser 8520. In this way, a variety of fluid containers may be used in conjunction with the system 8500. For instance, by including the electronics in a cup holder, a user's favorite coffee mug or drinking bottle may be used while still tagging and tracking the user's drinking consumption.

The personal device 8550 may be similar to one or more personal devices described herein. The personal device 8550 in this embodiment may be capable of wirelessly receiving information from the drinking dispenser 8520, such as presence and fluid information, and wirelessly transmitting recommendations based on health information to the drinking dispenser 8520. The personal device 8550 may include an interface that provides data or information about identification, activity, hydration, biometrics, and device interfaces (e.g., the drinking dispenser 8520 and the device 8510). The personal device 8550 may also wirelessly exchange information with the device 8510, such as user status and diet data. In this way, based on a variety of user data, the personal device 8550 may make a determination about whether to send a recommendation to the drinking dispenser 8520 and ultimately to the user.

The device 8510 may be any type of device capable of communicating with the personal device 8550, but for purposes of disclosure, the device 8510 is shown and described as a mobile phone. It should be understood that the present invention is not limited to a mobile phone and that other devices may be used. Further, in one embodiment, the device 8510 and the personal device 8550 may be integrated together such that the device 8510 includes features and functionality of the personal device 8550.

In the illustrated embodiment of FIG. 86, the device 8610 includes a health application, which may process data received and obtained from one or more of the storage 8640 and the personal device 8650. Using this data, the health application may develop health recommendations. These recommendations may be provided to the user through one or more displays in the system 8600, including, for example, the display 8630 of the drinking dispenser 8620. For example, the health application may notify and alarm a user when to drink. In one embodiment, the health recommendations may be developed by the personal device 8650 instead of or in addition to the health application on the device 8610. The device 8610 may also be capable of providing different drink profiles, depending for example on the user or the fluid type, to the personal device 8650 or the drinking dispenser 8620.

As described, the device 8610 includes wireless communication capabilities. These capabilities may involve a near field communication (NFC) interface in the device 8610, which may enable and facilitate enable payment processing with other devices. The device 8610 may also transmit payment recommendations to one or more of the personal device 8650 and the drinking dispenser 8620 so that, for example, the user can be notified to purchase a fluid type or to pick up an already purchased fluid.

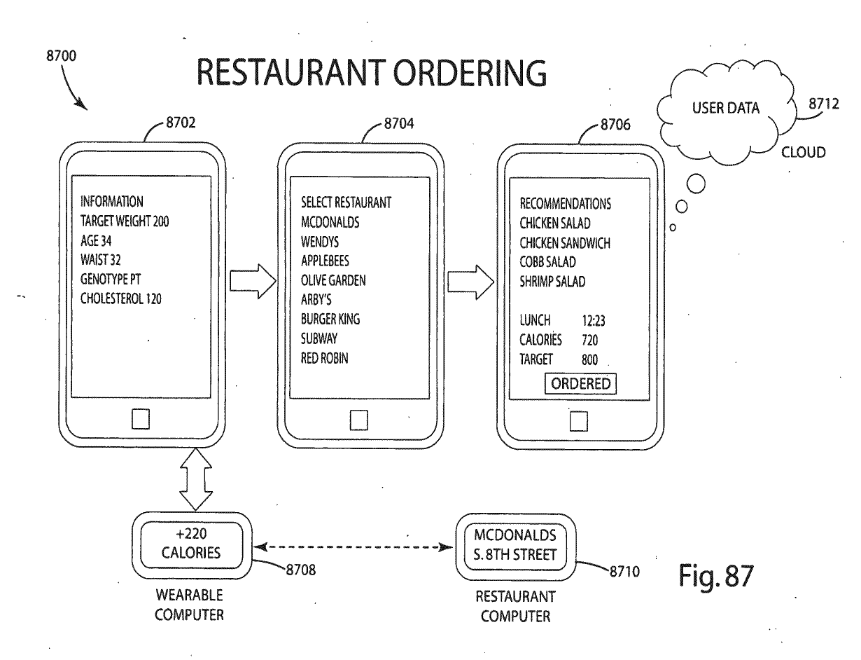

The illustrated embodiment of FIG. 86 shows an example vending machine that can receive requests from the user and makes recommendations based on the request, data about the user, or a combination thereof. For example, the vending machine may be capable of transmitting the type and quantity of food purchase to a mobile phone as well as optionally to a personal device. This mobile phone could be the device that was used to pay for product as well. Similarly, an order for food at a restaurant may be done from an electronic component such as a mobile phone or tablet, such as the system shown in FIG. 87. This order can produce an electronic receipt that can be used by the network to track caloric intake.

In the illustrated embodiment of FIG. 86, a system in accordance with an embodiment of the present invention is shown and designated 8600. The system 8600 may include a device 8610, a personal device 8650, and a vending machine 8630. The system 8600 may also store user date in storage 8640 or memory, which may be incorporated in the device 8610 or in a cloud storage system as illustrated, accessible by the device 8610. Although described in connection with these components, it should be understood that the system 8600 may be implemented in conjunction with other embodiments described herein and that elements of other embodiments may be substituted for any of the components in the system 8600. For instance, the system 8600 shows an example of the present invention with a vending machine that receives requests and information from the user and makes recommendations based on that data.

The system 8600 in the illustrated embodiment of FIG. 86 may be similar to the system 8500 but with several exceptions. The system 8600 may include a vending machine 8630 capable of communicating within the system 8600. The vending machine 8630 may share many of the same features common to conventional vending machines but includes the capability to provide recommendations base on health information.

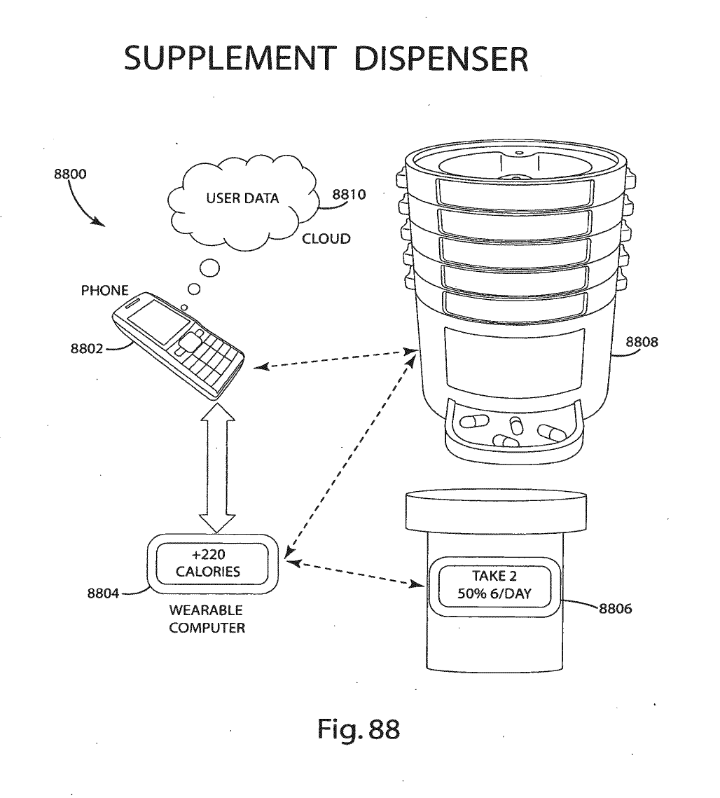

The illustrated embodiment of FIG. 88 shows an example of various interactions 8800 for a dispenser that dispenses supplements or medications that can be used for behavior modification and monitoring. The behavior modification system can interact with a variety of different types of dispensers. For example, a home pill dispenser 8808 and a behavior modification medication bottle 8806 are both dispensers. The dispenser, for instance, may monitor when a medication bottle 8806 is removed to identify when the user has taken his/her medication, as described in other embodiments herein. The dispenser may share many of the same features common to conventional dispenser but includes the capability to interface with the behavior modification system. For example, the dispenser may interact with a personal device to obtain ID, activity, hydration, biometric information or to otherwise interface with the personal device. Further, the personal device or dispenser can communicate with a user's mobile telephone 8802 regarding payment and health recommendations. In one embodiment, the user's data may be stored in a server on the cloud 8810 and may be accessed by any of the components in the behavior modification system directly or indirectly.

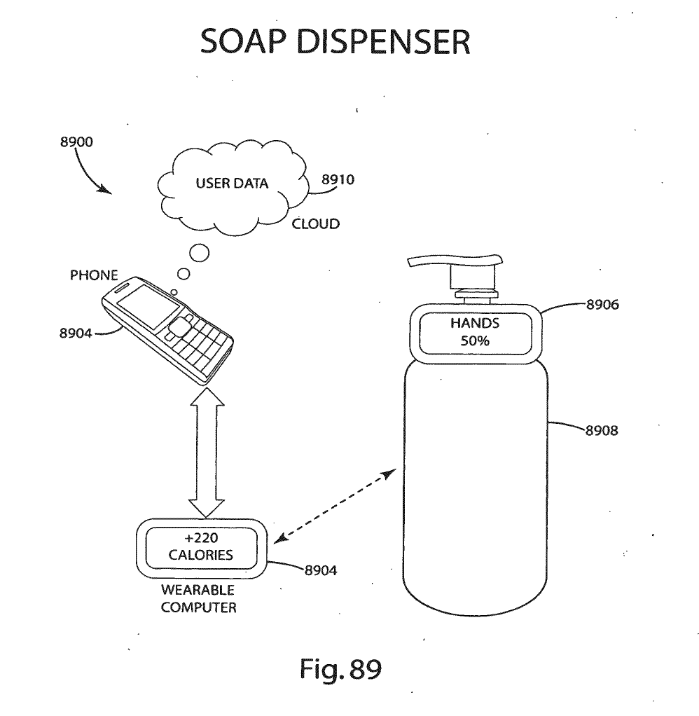

The illustrated embodiment of FIG. 89 shows interactions 8900 with a component 8906 for a behavior modification system associated with a dispenser 8908 for liquid. The component can be integrated with the dispenser or may be separate and work in conjunction with the dispenser. When the product is used, the system can be configured to acknowledge the use and when it is desirable to use the product. For instance, the component or product may beep to notify the user to wash their hands. This system can assist in preventing contamination when someone in the household based on health tags. In one embodiment the component 8906 can interact with a second personal computer 8904, which in turn can interact with a mobile telephone 8902. User data 8910 may be stored on the cloud and accessed by any of the components in the behavior modification system.

The illustrated embodiment of FIG. 87 an example software application on a component, such as a phone, that can utilize GPS data to find a restaurant and recommend choices based on menu and a user's targets modified by present reconciled caloric levels of the user that are communicated by a personal device 8708. The information about the user can be displayed on the mobile phone component 8702—the information may be transferred by the personal device 8708 or be transferred through the behavior modification system from a server on the cloud that stores user data 8712. The restaurant selection can be performed on the component mobile phone 8704, and a list of recommended food items can be provided to the user on the component mobile phone 8706. In some embodiments, the meal can be ordered directly from the mobile telephone. The target calories and actual calories, and time the meal is ordered can be displayed on the mobile phone component. The restraint may have a behavior modification computer that includes the restaurant ID, location ID, and web link data at doorway and at drive through menu to facilitate the interaction described above.

The illustrated embodiment of FIG. 52 shows one embodiment of a behavior modification system that includes a mobile device 5208, a personal device 5214, an input device 5216, a remote display and speaker 5206, a bridge 5210, a light sensor 5212, and another personal device 5202 with a magnet 5204. The illustrated embodiment provides examples of several behavior modification components that can be utilized to interact with users. The depicted embodiment illustrates how a dieting user can interact with the component near an appliance, such a refrigerator configured as a component in the behavior modification system. Another example is using this component to interact with children when they come home from school. Yet another example is to provide reminders to remind a user of appointments as they wake, walk out the door, take out the garbage, do not forget to exercise, homework, brush teeth, daily chores, or any other daily events and activities. The illustrated embodiment also shows that a remote display can be used to provide updated information, recommendations, reminders, warnings, or other pertinent information to the user.

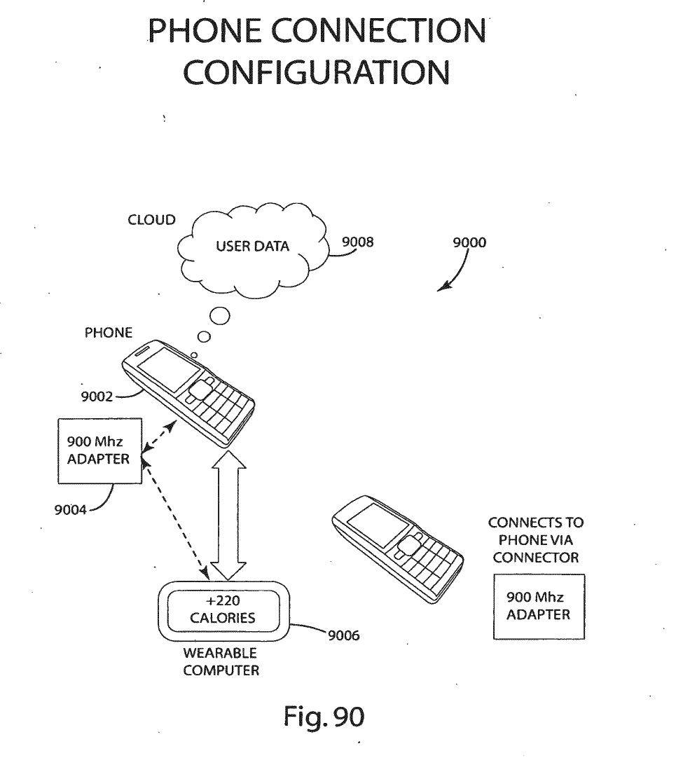

The illustrated embodiment of FIG. 90 shows one embodiment of a component, such as a cellphone 9002, that integrates an approximately 900 MHz transceiver for low power use, as described herein, or as an adapter 9004 to utilize the phone as a bridge or hub to the data storage media. The personal device 9006, adapter 9004, or mobile phone 9002 can interact with each other. The components may access user data 9008 in a cloud server.

The illustrated embodiment of FIG. 33 shows a representation of wireless power to power and read stickers 3320 or transferable tattoos using a personal device 3310 that includes a transmitter coil for wireless charging. The transmitter coil can be used to power and read stickers 3320 or transferrable tattoos. In one embodiment, the personal device is a cell phone 3330.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1-95. (canceled)

96. An automated behavior assistance system comprising:
a personal device configured to collect data representative of at least one of an activity or a body composition of a user; and
a processor configured to selectively analyze said collected data to establish at least one profile based on said collected data, said processor configured to selectively compare said collected data with said established profile, said processor providing an output based on said comparison of said collected data against said established profile.

97. The system of claim 96 wherein said processor is configured to establish at least one normal profile against which said collected data can be compared to assess a user deviation from said normal profile.

98. The system of claim 96 wherein said output is a user recommendation; and wherein said personal device has a display for presenting said user recommendation to the user.

99. The system of claim 96 wherein said processor is further configured to selectively analyze said collected data to identify patterns in said collected data.

100. The system of claim 96 wherein said collected data is further defined as data representative of a gait cycle of the user.

101. The system of claim 100 wherein said personal device includes an accelerometer and said collected data is further defined as accelerometer data.

102. The system of claim 96 wherein said processor is configured to establish an average gait profile, a resting profile and a sitting profile.

103. The system of claim 102 wherein said personal device has an interface allowing the user to input a tag; and wherein said processor is configured to associate said tag with at least one of said profiles.

104. The system of claim 96 wherein said processor is configured to recognize patterns in said collected data and to store a plurality said patterns.

105. The system of claim 104 wherein said processor is configured to associate at least one of said tags with at least one of said patterns, and to store said tags.

106. The system of claim 105 wherein said processor is configured to analyze said collected data to recognize when said collected data corresponds with one of said stored patterns and upon such recognition to provide an output being dependent upon said tag associated with said stored pattern.

107. The system of claim 104 wherein said processor includes an action associated with at least one of said patterns, said processor configured to implement said action upon recognition of said pattern in said collected data.

108. The system of claim 107 wherein said action includes dispensing a consumable.

109. The system of claim 108 further including an automated consumable dispenser, said automated dispenser including a store of supplements, said automated dispenser configured to dispense a consumable in response to a signal from said processor.

110. The system of claim 107 wherein said action includes providing a recommendation to the user.

111. The system of claim 96 wherein said personal device includes a three-axis accelerometer, said personal device including a controller configured to recognize user input in said collected data from said three-axis accelerometer.

112. The system of claim 111 wherein said controller is configured to recognize a plurality of gestures and to associate each of said gestures with a unique user input, whereby the user can provide input to said personal device through movement.

113. A behavior assistance system comprising:
a network-based processing unit; and
a personal device configured to collect data representative of an activity or a body composition of a user, said personal device including a communication system configured to transmit said collected data to said network-based processing unit;
said network-based processing unit configured to analyze said collected data to identify a behavior by recognizing patterns within said collected data, said processor configured to provide an output based on said identified behavior.

114. The system of claim 113 wherein said processing unit includes a plurality of stored profiles representative of different behaviors, said processing unit configured to identify said behaviors by comparing said patterns in said collected data with said stored profiles.

115. The system of claim 114 wherein said personal device includes a user interface to allow a user to input a tag; and
wherein said processing unit is configured to associate a tag with a stored profile.

116. The system of claim 115 wherein said personal device includes an accelerometer and said collected data includes accelerometer data.

117. A gesture input system comprising:
a personal device having an accelerometer and being configured to collect user motion data from said accelerometer;
memory including a plurality of sets of user motion data that respectively define a plurality of gestures each associated with one of a plurality of different user inputs; and
a controller configured to:
analyze collected user motion data to recognize one of said plurality of gestures in said movement data;
identify said user input associated in memory with said recognized gesture; and
implement an action associated with said user input.

118. The gesture input system of claim 117 wherein said accelerometer is a three-axis accelerometer.

119. The gesture input system of claim 117 wherein one or more of said plurality of gestures is associated with an augmentation condition in memory, and said controller is configured to restrict implementing said action unless said augmentation condition associated in memory with said recognized gesture is determined to be present by said gesture input system.

120. The gesture input system of claim 119 wherein said augmentation includes an audible tone, visible display, or mechanical feedback.

121. The gesture input system of claim 119 wherein said augmentation includes a response to a verification request provided to the user.

122. The gesture input system of claim 119 wherein said augmentation includes feedback from a proximity sensor.

123. The gesture input system of claim 119 wherein said augmentation includes a combination of feedback from a microphone and a proximity sensor.

124. The gesture input system of claim 117 wherein in response to said input said personal device initiates at least one of tracking working time, timing and counting number of drinks, and counting the number of bites and time of meal.

125. The gesture input system of claim 117 wherein said action includes tagging a collection of data.

126. The gesture input system of claim 117 wherein said action includes associating a collection of data with a behavior.
